(19) United States
(12) Patent Application Publication
(10) Pub. No.: US 2026/0014404 A1
(43) Pub. Date: Jan. 15, 2026

(54) LONG-TERM FIRE RETARDANT WITH CORROSION INHIBITORS AND METHODS FOR MAKING AND USING SAME

(71) Applicant: Perimeter Solutions, LP, Clayton, MO (US)

(72) Inventors: Joseph McLellan, Rocklin, CA (US); Michael White, Roseville, CA (US)

(73) Assignee: Perimeter Solutions, LP, Clayton, MO (US)

(21) Appl. No.: 19/337,691

(22) Filed: Sep. 23, 2025

Related U.S. Application Data
(63) Continuation of application No. PCT/US2025/034060, filed on Jun. 17, 2025.
(63) Continuation of application No. 18/908,107, filed on Oct. 7, 2024.
(63) Continuation of application No. 18/602,657, filed on Mar. 12, 2024, now Pat. No. 12,109,446.
(63) Continuation of application No. 18/450,892, filed on Aug. 16, 2023, now Pat. No. 12,053,658.
(63) Continuation of application No. 18/061,542, filed on Dec. 5, 2022, now Pat. No. 11,975,231.
(63) Continuation of application No. 18/425,075, filed on Jan. 29, 2024.
(63) Continuation of application No. 18/182,198, filed on Mar. 10, 2023, now Pat. No. 11,883,703.
(63) Continuation of application No. 17/845,569, filed on Jun. 21, 2022, now Pat. No. 11,602,658.
(63) Continuation of application No. 17/458,002, filed on Aug. 26, 2021, now Pat. No. 11,395,934.
(63) Continuation of application No. 18/990,647, filed on Dec. 20, 2024.
(63) Continuation of application No. 18/404,387, filed on Jan. 4, 2024, now Pat. No. 12,214,237.
(63) Continuation of application No. 18/404,027, filed on Jan. 4, 2024, now Pat. No. 12,214,236.
(63) Continuation of application No. 18/299,525, filed on Apr. 12, 2023, now Pat. No. 11,865,392.
(63) Continuation of application No. 18/060,946, filed on Dec. 1, 2022, now Pat. No. 11,865,391.
(63) Continuation of application No. 17/821,060, filed on Aug. 19, 2022, now Pat. No. 11,628,324.
(63) Continuation of application No. 17/552,196, filed on Dec. 15, 2021, now Pat. No. 11,420,084.
(60) Provisional application No. 63/125,693, filed on Dec. 15, 2020.
(60) Provisional application No. 63/125,693, filed on Dec. 15, 2020.
(60) Provisional application No. 63/140,657, filed on Jan. 22, 2021.
(60) Provisional application No. 63/140,657, filed on Jan. 22, 2021.
(60) Provisional application No. 63/325,876, filed on Mar. 31, 2022.
(60) Provisional application No. 63/660,824, filed on Jun. 17, 2024.
(60) Provisional application No. 63/686,448, filed on Aug. 23, 2024.

(51) Int. Cl. A62D 1/00

(52) U.S. Cl. CPC A62D 1/0042

(57) ABSTRACT

A forest fire retardant composition contains a retardant compound that includes a salt. The salt may include a potassium salt, a phosphate salt, a sulfate salt, a calcium salt, a magnesium salt, and/or a halide salt, and combinations thereof. The composition may be in the form of a liquid concentrate dispersion or a final diluted product. The liquid concentrate dispersion may contain multiple phases including a dispersed phase and a dispersion medium. The final diluted product is effective in suppressing, retarding, and controlling forest fires while exhibiting corrosion resistance and low toxicity.

### CROSS-REFERENCE TO RELATED APPLICATIONS

This application claims priority from U.S. Patent Application Ser. No. 63/686,448, filed Aug. 23, 2024; from PCT Application Serial No. PCT/US2025/034060, filed Jun. 17, 2025, claiming priority from U.S. Patent Application Ser. No. 63/660,824, filed Jun. 17, 2024; from U.S. patent application Ser. No. 18/908,107, filed on Oct. 7, 2024, a continuation of U.S. patent application Ser. No. 18/602,657, filed on Mar. 12, 2024, now U.S. Pat. No. 12,109,446, a continuation of U.S. patent application Ser. No. 18/450,892, filed on Aug. 16, 2023, now U.S. Pat. No. 12,053,658, a continuation of U.S. patent application Ser. No. 18/061,542, filed on Dec. 5, 2022, now U.S. Pat. No. 11,975,231, which claimed priority from U.S. Patent Application Ser. No. 63/325,876, filed on Mar. 31, 2022; from U.S. patent application Ser. No. 18/425,075, filed on Jan. 29, 2024, a continuation of U.S. patent application Ser. No. 18/182,198, filed on Mar. 10, 2023, now U.S. Pat. No. 11,883,703, a continuation of U.S. patent application Ser. No. 17/845,569, filed on Jun. 21, 2022, now U.S. Pat. No. 11,602,658, a continuation of U.S. patent application Ser. No. 17/458,002, filed on Aug. 26, 2021, now U.S. Pat. No. 11,395,934, claiming priority from U.S. Patent Application Serial Nos. 63/140,657, filed Jan. 22, 2021 and 63/125,693, filed Dec. 15, 2020; and from U.S. patent application Ser. No. 18/990,647, filed on Dec. 20, 2024, a continuation of U.S. patent application Ser. No. 18/404,387, filed on Jan. 4, 2024, now U.S. Pat. No. 12,214,237, a continuation of Ser. No. 18/404,027, filed on Jan. 4, 2024, now U.S. Pat. No. 12,214,236, a continuation of Ser. No. 18/299,525, filed on Apr. 12, 2023, now U.S. Pat. No. 11,865,392, a continuation of Ser. No. 18/060,946, filed on Dec. 1, 2022, now U.S. Pat. No. 11,865,391, a continuation of U.S. patent application Ser. No. 17/821,060, filed on Aug. 19, 2022, now U.S. Pat. No. 11,628,324, a continuation of U.S. patent application Ser. No. 17/552,196, filed on Dec. 15, 2021, now U.S. Pat. No. 11,420,084, claiming priority from U.S. Patent Application Serial Nos. 63/140,657, filed on Jan. 22, 2021 and 63/125,693, filed on Dec. 15, 2020, all of the foregoing being incorporated herein by reference.

### BACKGROUND

Long-term retardants contain retardant salts that alter the way a forest fire burns, decrease the fire intensity, and slow the advance of the forest fire. Long-term retardants may be available as wet or dry concentrates that are mixed with water thereby improving water's effectiveness and ability to cling to fuels, over a long period of time. Long-term retardants may be colored with iron oxide, fugitive pigments, or remain uncolored.

In the “Ecological Risk Assessment of Wildland Fire-Fighting Chemicals: Long-Term Fire Retardants” (September 2017), hereby incorporated by reference in its entirety, the United States Forest Service (“USFS”) has established a chemical toxicity risk assessment for fire-fighting chemicals currently approved for use by the USFS. The USFS uses a variety of fire-fighting chemicals to aid in the suppression of fire in wildlands. These products can be categorized as long-term retardants, foams, and water enhancers. This chemical toxicity risk assessment of the long-term retardants examines their potential impacts on terrestrial wildlife, plant, and aquatic species.

Further, in Specification 5100-304d (Jan. 7, 2020, amended May 6, 2021), Superseding Specification 5100-304c (June 2007), Superseding Specification 5100-304b (July 1999), Superseding Specification 5100-00304a (February 1986), entitled “Specification for Long Term Retardant, Wildland Fire, Aircraft or Ground Application,” hereby incorporated by reference in its entirety, the United States Department of Agriculture (“USDA”) Forest Service has established the maximum allowable corrosion rates for 2024T3 aluminum, 4130 steel, yellow brass and Az-31-B magnesium. The corrosivity of forest fire retardants, in concentrate, to aluminum, steel, yellow brass and magnesium must not exceed 5.0 milli-inches (“mils”) per year as determined by the “Uniform Corrosion” test set forth in Section 4.3.5.1 of the USDA Forest Service Specifications. The Forest Service Specifications identify the maximum amount of corrosion acceptable when both the retardant concentrate and its diluted solutions are exposed to each metal indicated above at temperatures of 700 Fahrenheit (“F”) and 120° F. in both totally and partially immersed configurations. The maximum allowable corrosivity of aerially applied fire-retardant diluted solutions to aluminum is 2.0 mils per year (“mpy”) and the maximum corrosivity to brass and steel is 2.0 mpy when partially immersed and 5.0 when tested in the partially immersed condition. In the partially immersed configurations, one-half of the coupon is within the solution and one-half is exposed to the vapors in the air space over the solution.

Current long-term retardant liquid concentrates (LCs) are prepared by dissolving the fire retardant salt or salt mixtures in water to a concentration that is near the solubility limit of that salt in water around room temperature (e.g., about 20 degrees Celsius). In other words, current long-term retardant LCs are based on salt solutions.

U.S. Pat. No. 11,679,290 to Robles et al. discloses “liquid fire retardant concentrate compositions containing one or more powdered fire retardants dispersed throughout an aqueous medium” (6:34-36). Robles et al. is limited to an aqueous medium that “consists essentially of water.” (6:36-37). Robles et al. describes how these liquid fire retardant concentrate compositions are prepared by “dissolving the one more fire retardants at the concentrations described herein in water.” (13:17-19). Robles et al. also discloses “using micronized clay complexed with DAP and/or MAP as a corrosion inhibitor” to “increas[e] levels of DAP and/or MAP above and beyond the limits of solubility in the concentrated form.” (9:46-51). As a result of using concentrations of DAP and/or MAP above and beyond the limit of solubility, Robles et al. notes that the disclosed concentrates have “particles suspended throughout, appearing to be undissolved MAP or DAP” and that, “as the concentration of MAP increases in the concentrates, more particles are observed.” (Example 5, Columns 23-24, lines 46-49).

However, LCs based on solutions of salt near, at, or above the solubility limit may lead to various problems in the field. For example, thermal cycling for solutions close to the salt solubility limit may cause undesirable crystal growth. Additionally, the mix ratio of the liquid concentrate may also be limited by solubility of the salt in solution. Furthermore, the viscosity of the liquid concentrate may be difficult to manage with highly soluble salts. For example, a highly soluble salt may require a liquid concentrate viscosity of 3,000 cP or higher so that the resulting final diluted product can have a viscosity of approximately 150 cP. In other cases, the thickener may be inactive in the liquid concentrate due to the high salt concentration resulting in a low viscosity liquid concentrate. These low viscosity liquid concentrates may lead to the components of the liquid concentrate separating from the water present in the liquid concentrate, forming non-homogenous concentrates. Finally, liquid concentrates often have elevated corrosion rates, relative to the diluted ready to use (RTU) products, due to a high salt concentration present in the liquid concentrate.

In contrast to traditional long-term retardant liquid concentrates based on salt solutions and Robles et al.'s liquid concentrates with salt concentrations that exceed the solubility limit (e.g., supersaturated solutions), the present inventors have discovered long-term retardant liquid concentrates based on salt dispersions, also referred to herein as liquid concentrate dispersions, that include one or more components of the liquid concentrate substantially not dissolved in a dispersion medium. Advantageously, these liquid concentrate dispersions can exhibit low corrosion rates and increased mix ratios.

### SUMMARY

The invention relates generally to fire retardant compositions and more particularly to long-term fire retardants suitable for use in direct or indirect attack of forest fires.

In some aspects, the techniques described herein relate to a forest fire retardant liquid concentrate dispersion, including a retardant compound present in the liquid concentrate dispersion in a dispersed phase, a corrosion inhibitor for at least one of iron, brass, aluminum, or magnesium, a thickening agent, and a non-aqueous dispersion medium.

In some aspects, the techniques described herein relate to a liquid concentrate dispersion wherein the corrosion inhibitor is present in the liquid concentrate dispersion in an amount having a weight percent of about 0.025% to about 4.5% relative to the total weight of the liquid concentrate dispersion.

In some aspects, the techniques described herein relate to a liquid concentrate dispersion wherein the thickening agent is present in the liquid concentrate dispersion in an amount having a weight percent of about 0.01% to about 5.5% relative to the total weight of the liquid concentrate dispersion.

In some aspects, the techniques described herein relate to a liquid concentrate dispersion wherein the dispersed phase is less than 25% by weight dissolved in the non-aqueous dispersion medium relative to the total weight of the liquid concentrate dispersion.

In some aspects, the techniques described herein relate to a liquid concentrate dispersion wherein the dispersed phase is less than 20% by weight dissolved in the non-aqueous dispersion medium relative to the total weight of the liquid concentrate dispersion.

In some aspects, the techniques described herein relate to a liquid concentrate dispersion wherein the dispersed phase is less than 10% by weight dissolved in the non-aqueous dispersion medium relative to the total weight of the liquid concentrate dispersion.

In some aspects, the techniques described herein relate to a liquid concentrate dispersion wherein the forest fire retardant liquid concentrate dispersion is in the form of a suspension and/or colloid.

In some aspects, the techniques described herein relate to a liquid concentrate dispersion wherein the non-aqueous dispersion medium includes at least one of ethylene glycol, polyethylene glycol (PEG), a low-molecular-weight grade polyethylene glycol (PEG-400), di(propylene glycol) methyl ether (DPG-ME), tripropylene glycol methyl ether (TPG-ME), hexylene glycol, triethylene glycol (TEG), triethylene glycol methyl ether (TEG-ME), diethylene glycol monoethyl ether (DEG-EE), glycerol, propylene glycol (PG), polypropylene glycol, propylene carbonate, 1,3 propanediol, a polyol, or a glycol ether.

In some aspects, the techniques described herein relate to a liquid concentrate dispersion wherein the retardant compound includes at least one of a potassium salt, a phosphate salt, a sulfate salt, a calcium salt, a magnesium salt, or a halide salt.

In some aspects, the techniques described herein relate to a liquid concentrate dispersion wherein the potassium salt includes at least one of potassium formate (HCO2K), potassium acetate (CH3COOK), potassium acetate hydrate (CH3COOK(H2O)x) where x is about 1 to about 3, potassium propanoate (C3H5KO2), potassium butanoate (C4H7KO2), potassium lactate (KC3H5O3), potassium oxalate (C2K2O4), potassium oxalate monohydrate (C2K2O4(H2O)1), monopotassium malate (C4H5KO5), potassium glutamate (C5H8KNO4), potassium glutamate monohydrate (C5H8KNO4(H2O)1), potassium L-glutamate monohydrate (KOOCCH2CH2CH(NH2)COOH(H2O)1), monopotassium tartrate (C4H5KO6), potassium urate (C5H3KN4O3), dipotassium malate (C4H4K2O5), dipotassium tartrate (C4H4K2O6), monopotassium citrate (KH2C6H5O7), potassium gluconate (C6H11KO7), dipotassium citrate (C6H6K2O7), tripotassium citrate (K3C6H5O7), tripotassium citrate monohydrate (K3C6H5O7(H2O)1), potassium bicarbonate (KHCO3), potassium carbonate (K2CO3), monopotassium phosphate (KH2PO4), potassium ammonium phosphate (K2NH4PO4), dipotassium phosphate (K2HPO4), dipotassium phosphate hydrate (K2HPO4(H2O)x) where x is about 3 to about 6, tripotassium phosphate (K3PO4), tripotassium phosphate hydrate (K3PO4(H2O)x) where x is about 3 to about 9, tetrapotassium pyrophosphate (K4P2O7), potassium bisulfate (KHSO4), potassium ammonium sulfate (H4KNO4S), or potassium sulfate (K2SO4).

In some aspects, the techniques described herein relate to a liquid concentrate dispersion wherein the phosphate salt includes at least one of diammonium phosphate (DAP), diammonium orthophosphate (DAP), monoammonium phosphate (MAP), monoammonium orthophosphate (MAP), ammonium polyphosphate (APP), monosodium phosphate (MSP), disodium phosphate (DSP), disodium phosphate hydrate (Na2HPO4(H2O)x) where x is about 1 to about 12, sodium ammonium phosphate (SAP), sodium ammonium phosphate hydrate (NaPO4HNH4(H2O)x) where x is about 1 to about 4, sodium ammonium phosphate tetrahydrate (NaPO4HNH4(H2O)4), sodium tripolyphosphate (STPP), trisodium phosphate (TSP), monocalcium phosphate (MCP), dicalcium phosphate (DCP), tricalcium phosphate (TCP), octacalcium phosphate (OCP), dicalcium diphosphate, calcium triphosphate, hydroxyapatite, apatite, tetracalcium phosphate (TTCP), monopotassium phosphate (KH2PO4), potassium ammonium phosphate (K2NH4PO4), dipotassium phosphate (K2HPO4), dipotassium phosphate hydrate (K2HPO4(H2O)x where x is about 3 to about 6), tripotassium phosphate (K3PO4), tripotassium phosphate hydrate (K3PO4(H2O)x where x=3, 7, or 9), or tetrapotassium pyrophosphate (K4P2O7).

In some aspects, the techniques described herein relate to a liquid concentrate dispersion wherein the sulfate salt includes at least one of magnesium sulfate, magnesium sulfate hydrate (MgSO4(H2O)x) where x is about 1 to about 11, magnesium sulfate monohydrate, kieserite (MgSO4(H2O)1), hexahydrite (MgSO4(H2O)6), epsomite (MgSO4(H2O)7), potassium sulfate (K2SO4), dipotassium sulfate (K2SO4), leonite (K2Mg(SO4)2(H2O)4), or picromerite (K2Mg(SO4)2(H2O)6).

In some aspects, the techniques described herein relate to a liquid concentrate dispersion wherein the calcium salt includes at least one of calcium carbonate (CaCO3), calcium phosphate (Ca3(PO4)2), huntite (Mg3Ca(CO3)4), calcium oxide (CaO), calcium hydroxide (Ca(OH)2), calcium phosphate hydrate (Ca3(PO4)2(H2O)2), monocalcium phosphate (MCP), dicalcium phosphate (DCP), tricalcium phosphate (TCP), octacalcium phosphate (OCP), dicalcium diphosphate, hydroxyapatite, apatite, or tetracalcium phosphate (TTCP).

In some aspects, the techniques described herein relate to a liquid concentrate dispersion wherein the magnesium salt includes at least one of magnesium chloride anhydrous (MgCl2), magnesium chloride hydrate (MgCl2(H2O)x) where x is about 1 to about 12, magnesium bromide, magnesium carbonate (MgCO3), magnesium phosphate (Mg3(PO4)2), magnesium carbonate hydroxide hydrate (Mg5(CO3)4(OH)2(H2O)4), magnesium phosphate hydrate (Mg3(PO4)2(H2O)8), magnesium oxide (MgO), magnesium hydroxide (Mg(OH)2), or magnesium ammonium phosphate (Mg(PO4HNH4)2).

In some aspects, the techniques described herein relate to a liquid concentrate dispersion wherein the halide salt includes at least one of magnesium chloride anhydrous (MgCl2), magnesium chloride hydrate (MgCl2(H2O)x) where x is about 1 to about 12, magnesium bromide, calcium chloride anhydrous, calcium chloride hydrate (CaCl₂)(H2O)x) where x is about 1 to about 6, or calcium bromide.

In some aspects, the techniques described herein relate to a liquid concentrate dispersion wherein the retardant compound has a particle size of about 1.0 mm to about 3.5 mm.

In some aspects, the techniques described herein relate to a liquid concentrate dispersion wherein the retardant compound has a particle size of about 0.25 mm to about 0.4 mm.

In some aspects, the techniques described herein relate to a liquid concentrate dispersion wherein the retardant compound has a particle size of about 0.17 mm to about 0.25 mm.

In some aspects, the techniques described herein relate to a liquid concentrate dispersion wherein the retardant compound has a particle size of about 0.15 mm or less.

In some aspects, the techniques described herein relate to a liquid concentrate dispersion wherein the corrosion inhibitor includes at least one of an alkyl amine, one or more azoles, disodium molybdate dihydrate, iron pyrophosphate, sodium molybdate, sodium lauryl sulfate, or sodium stearate.

In some aspects, the techniques described herein relate to a liquid concentrate dispersion wherein the thickening agent includes at least one of a polyurethane, a polyvinyl alcohol, a polyvinylpyrrolidone, an acrylic polymer, a gum, a cellulosic, a sulfonate, a saccharide, a clay, an organosilicone, or a protein.

In some aspects, the techniques described herein relate to a liquid concentrate dispersion wherein the thickening agent includes the gum.

In some aspects, the techniques described herein relate to a liquid concentrate dispersion wherein the gum includes a polysaccharide gum.

In some aspects, the techniques described herein relate to a liquid concentrate dispersion wherein the thickening agent comprises a first thickening agent and a second thickening agent.

In some aspects, the techniques described herein relate to a liquid concentrate dispersion wherein the first thickening agent is present in the liquid concentrate dispersion in the dispersed phase and the second thickening agent is dissolved in the dispersion medium.

In some aspects, the techniques described herein relate to a liquid concentrate dispersion wherein the first thickening agent and the second thickening agent are present in the liquid concentrate dispersion in the dispersed phase.

In some aspects, the techniques described herein relate to a liquid concentrate dispersion wherein the first thickening agent includes a first polysaccharide gum.

In some aspects, the techniques described herein relate to a liquid concentrate dispersion wherein the second thickening agent includes at least one of a second polysaccharide gum, a clay, or silica.

In some aspects, the techniques described herein relate to a liquid concentrate dispersion further including a colorant, present in the concentrate in an amount having a weight percent of about 0.04% to about 6.0% relative to the total weight of the liquid concentrate dispersion.

In some aspects, the techniques described herein relate to a liquid concentrate dispersion wherein the colorant includes at least one of at least one a red dye, an orange dye, a purple dye, a pink dye, Iron Oxide, Iron Oxide Black, or a fluorescent pigment.

In some aspects, the techniques described herein relate to a liquid concentrate dispersion further including at least one of a spoilage inhibitor, an anti-caking agent, a flow conditioner, an anti-foaming agent, a foaming agent, a stability additive, a biocide, a second thickening agent, a surfactant, an adjuvant, a second corrosion inhibitor, an opacifier, a second colorant, a liquid carrier, or a deduster.

In some aspects, the techniques described herein relate to a final diluted forest fire retardant comprising a retardant compound present in a liquid concentrate dispersion in a dispersed phase, a corrosion inhibitor for at least one of iron, brass, aluminum, or magnesium, a thickening agent, a non-aqueous dispersion medium, and an amount of water, wherein the amount of the retardant compound is in a weight percent of about 4% to about 30% relative to the total weight of the final diluted forest fire retardant.

In some aspects, the techniques described herein relate to a final diluted forest fire retardant wherein the final diluted forest fire retardant is a long-term fire retardant, the long-term fire retardant has a viscosity between 150 cP and 1500 cP, and the long-term fire retardant does not exceed a corrosion rate of 2.0 mils-per-year for aluminum, 5.0 mils-per-year for iron, and 5.0 mils-per-year for brass.

In some aspects, the techniques described herein relate to a final diluted forest fire retardant wherein the long-term fire retardant does not exceed a corrosion rate of 4.0 mils-per-year for magnesium.

In some aspects, the techniques described herein relate to a final diluted forest fire retardant wherein the viscosity is between 150 cP and 400 cP.

In some aspects, the techniques described herein relate to a final diluted forest fire retardant wherein the viscosity is between 401 cP and 800 cP.

In some aspects, the techniques described herein relate to a final diluted forest fire retardant wherein the viscosity is between 801 cP and 1500 cP.

### BRIEF DESCRIPTIONS OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

FIG. 1 is a flow chart diagram showing the process of making a forest fire retardant composition from a liquid concentrate dispersion.

FIG. 2 is a schematic showing a liquid concentrate dispersion including a dispersed phase and a dispersion medium.

### DETAILED DESCRIPTION

### In General

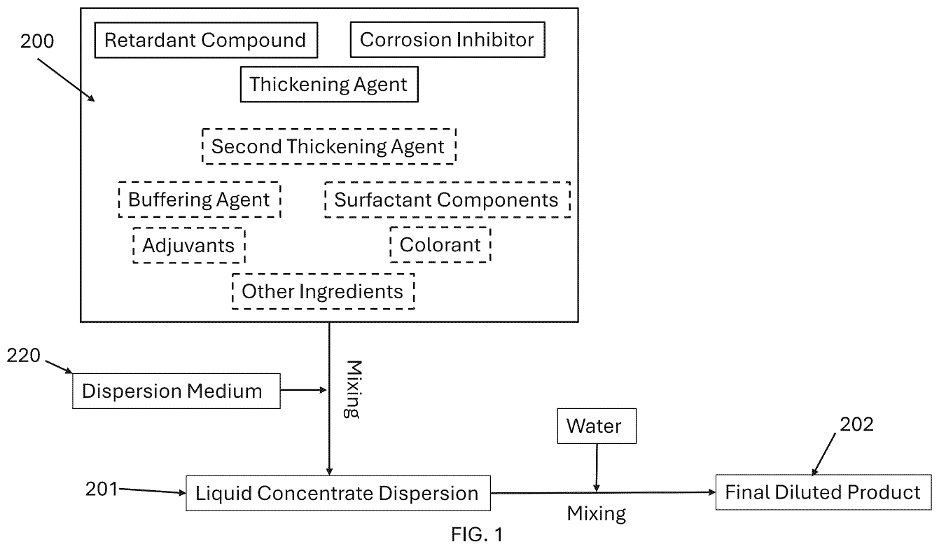

Referring to FIG. 1, a forest fire retardant composition 200 can be provided in various liquid forms. The composition 200 can be provided as a liquid concentrate dispersion 201. The composition 200 can also be provided as a final diluted product 202 in a form suitable to fight forest fires via aerial- or ground-based application. The final diluted product 202 is formed by diluting the liquid concentrate dispersion 201 with water in one or more diluting steps.

### Components of the Composition 200

The forest fire retardant composition 200 include one or more retardant compounds. The retardant compounds are preferably inorganic compounds. Instead of (or in addition to) inorganic compounds, the retardant compounds may be an organic compound. Table 1 below illustrates exemplary inorganic compounds, any one or more of which may be used, alone or in combination, as a retardant compound in the composition 200.

TABLE 1
Exemplary Retardant Compounds

| | | Other | | |
|---|---|---|---|---|
| | | inorganic | Organic | Potassium |
| Halide Salts | Non-Halide Salts | retardants | retardants | Retardants |
| MgCl₂ | MgCO₃ | MgO | C₂H₇NO₂ | KCl |
| MgCl₂(H₂O)ₓ where | Mg₃(PO₄)₂ | CaO | C₆H₁₁NO₇ | HCO₂K |
| x is 1, 2, 4, 6, 8, or | | | | |
| 12 | | | | |
| CaCl₂ | Mg₅(CO₃)₄(OH)₂(H₂O)₄ | Na₂O | | CH₃COOK(H₂O)x |
| CaCl₂(H₂O)ₓ where | Mg₃(PO₄)₂(H₂O)₈ | Li₂O | | where x = 1 or 3 |
| x is 1, 2, 4, or 6 | | | | |
| MgBr₂ | CaCO₃ | BaO | | KHCO₃ |
| CaBr₂ | Ca₃(PO₄)₂ | Mg(OH)₂ | | C₃H₅KO₂ |
| NH₄Cl | Mg₃Ca(CO₃)₄ | Ca(OH)₂ | | C₄H₇KO₂ |
| | Ca₃(PO₄)₂(H₂O)₂ | NaOH | | KC₃H₅O₃ |
| | DAP | LiOH | | KHSO₄ |
| | MAP | Ba(OH)₂ | | K₂CO₃ |
| | APP | KOH | | K₂NH₄PO₄ |
| | (NH₄)₂SO₄ | P₂O₅ | | H₄KNO₄S |
| | K₂SO₄ | | | C₂K₂O₄ |
| | MgSO₄ | | | C₂K₂O₄(H₂O)x |
| | | | | where x = 1 |
| | MgSO₄(H₂O)ₓ where x is | | | C₄H₅KO₅ |
| | 1, 2, 3, 4, 5, 6, 7, 9, 10 or | | | |
| | 11 | | | |
| | K₂Mg(SO₄)₂(H₂O)ₓ where | | | C₅H₈KNO₄ |
| | x is 4 or 6 | | | |
| | Na₂SO₄ | | | C₅H₈KNO₄(H₂O)x |
| | | | | where x = 1 |
| | Na₂SO₄(H₂O)ₓ where x is 7 | | | C₄H₅KO₆ |
| | or 10 | | | |
| | MgCO₃(H₂O)ₓ where x is | | | KOOCCH₂CH₂CH(NH₂) |
| | 2, 3, or 5 | | | COOH(H₂O)x |
| | | | | where x = 1 |
| | Mg(PO₄HNH₄)₂ | | | C₅H₃KN₄O₃ |
| | NaPO₄HNH₄ | | | C₄H₄K₂O₅ |
| | NaPO₄HNH₄(H₂O)ₓ, where | | | C₄H₄K₂O₆ |
| | x = 1, 2, 3, or 4 | | | |
| | Na₂HPO₄ | | | KH₂C₆H₅O₇ |
| | Na₂HPO₄(H₂O)ₓ, where x = | | | C₆H₁₁KO₇ |
| | 2, 7, 8, or 12 | | | |
| | NaH₂PO₄ | | | C₆H₆K₂O₇ |
| | NaH₂PO₄(H₂O)ₓ, where x = | | | K₃C₆H₅O₇ |
| | 1 or 2 | | | |
| | Na₃PO₄ | | | K₃C₆H₅O₇(H₂O)x |
| | | | | where x = 1 |
| | Na₅P₃O₁₀ | | | HOC(COOK)(CH₂COOK)₂ |
| | | | | (H₂O)x where x = 1 |
| | Na₅P₃O₁₀(H₂O)₆ | | | K₄P₂O₇ |
| | Na₂CO₃ | | | K₂SO₄ |
| | NaHCO₃ | | | KH₂PO₄ |
| | Ca(H₂PO₄)₂ | | | K₂HPO₄ |
| | Ca(H₂PO₄)₂(H₂O)ₓ, where | | | K₂HPO₄(H₂O)x, |
| | x = 1 | | | where x = 3 or 6 |
| | CaHPO₄ | | | K₃PO₄ |
| | CaHPO₄(H₂O)ₓ, where x = | | | K₃PO₄(H₂O)x, |
| | 1 or 2 | | | where x = 3, 7, or 9 |
| | Ca₃(PO₄)₂ | | | |
| | Ca₈H₂(PO₄)₆•5H₂O | | | |
| | Ca₂P₂O₇ | | | |
| | Ca₂P₂O₇(H₂O)ₓ, where x = | | | |
| | 2 or 4 | | | |
| | Ca₅(P₃O₁₀)₂ | | | |
| | Ca₅(PO₄)₃(OH) | | | |
| | Ca₁₀(PO₄)₆(OH, F, Cl, Br)₂ | | | |
| | Ca₄(PO₄)₂•O | | | |
| | KH₂PO₄ | | | |
| | K₂HPO₄ | | | |
| | K₂HPO₄(H₂O)ₓ, where x = | | | |
| | 3 or 6 | | | |
| | K₃PO₄ | | | |
| | K₃PO₄(H₂O)ₓ, where x = 3, | | | |
| | 7, or 9 | | | |

The retardant compound may be a salt. Preferably the salt is one or more of the salts listed in Table 1. For example, the salt may be a potassium salt, a phosphate salt, a sulfate salt, a calcium salt, a magnesium salt, and/or a halide salt, and combinations thereof. The salt may be any of the retardant compounds disclosed in U.S. non-provisional application Ser. No. 16/894,231 filed Jun. 5, 2020; Ser. No. 16/894,214 filed Jun. 5, 2020; Ser. No. 17/031,024 filed Sep. 24, 2020; Ser. No. 17/214,266 filed Mar. 26, 2021; Ser. No. 17/458,002 filed Aug. 26, 2021; Ser. No. 17/552,196 filed Dec. 15, 2021; and/or Ser. No. 18/061,542 filed on Dec. 5, 2022, which are hereby incorporated by reference in their entirety.

The potassium salt may be a potassium salt of an organic acid. The organic acid may include formic acid, acetic acid, propanoic acid, butanoic acid, lactic acid, oxalic acid, malic acid, gluconic acid, tartaric acid, uric acid, malic acid, or citric acid. The potassium salt of an organic acid in the forest fire retardant composition 200 may include one or more of the following: potassium formate (HCO₂K), potassium acetate (CH₃COOK), potassium acetate hydrate (CH₃COOK(H₂O)ₓ, where x is about 1 to about 3), potassium propanoate (C₃H₅KO₂), potassium butanoate (C₄H₇KO₂), potassium lactate (KC₃H₅O₃), potassium oxalate (C₂K₂O₄), potassium oxalate monohydrate (C₂K₂O₄(H₂O)₁), monopotassium malate (C₄H₅KO₅), potassium glutamate (C₅H₅KNO₄), potassium glutamate monohydrate (C₅H₅KNO₄(H₂O)₁), potassium L-glutamate monohydrate (KOOCCH₂CH₂CH(NH₂)COOH(H₂O)₁), monopotassium tartrate (C₄H₅KO₆), potassium urate (C₅H₃KN₄O₃), dipotassium malate (C₄H₄K₂O₅), dipotassium tartrate (C₄H₄K₂O₆), monopotassium citrate (KH₂C₆H₅O₇), potassium gluconate (C₆H₁₁KO₇), dipotassium citrate (C₆H₆K₂O₇), tripotassium citrate (K₃C₆H₅O₇), tripotassium citrate monohydrate (K₃C₆H₅O₇(H₂O)₁), and mixtures thereof. The potassium acetate can be anhydrous, substantially free of any hydrate. Alternatively, or in combination with the anhydrous potassium acetate, the potassium acetate can be a hydrate, substantially free of any anhydrous. The hydrate may have the formula CH₃COOK(H₂O)ₓ, where x is about 1 to about 3. For example, x may be equal to at least one of 1 or 3. The potassium acetate may contain a mixture of multiple different hydrates CH₃COOK(H₂O)_{y}, such that when measured, y constitutes an average weighted number of hydrates in the mixture, and thus y is not necessarily a whole number. For example, the average weighted value of y may be about 1.0 to about 3.0, preferably about 1.1 to about 2.9, more preferably about 1.2 to about 2.8, and more preferably about 1.5 to about 2.5. The potassium acetate anhydrous and the potassium acetate hydrate may be present in the forest fire retardant composition 200 in a weight ratio (anhydrous:hydrate) from about 0%:100% to about 100%:0%, including about 5%:95%, 10%:90%, 15%:85%, 20%:80%, 25%:75%, 30%:70%, 35%:65%, 40%:60%, 45%:55%, 50%:50%, 55%:45%, 60%:40%, 65%:35%, 70%:30%, 75%:25%, 80%:20%, 85%:15%, 90%:10%, 95%:5%, and any range between any two such ratios.

Instead of (or in addition to) potassium salts of an organic acid, the potassium salt may be a potassium salt of an inorganic acid. The inorganic acid may include sulfuric acid, phosphoric acid, carbonic acid, or hydrochloric acid. The potassium salt of an inorganic acid in the forest fire retardant composition 200 may include one or more of the following: potassium bicarbonate (KHCO₃), potassium carbonate (K₂CO₃), monopotassium phosphate (MKP) (KH₂PO₄), potassium ammonium phosphate (K₂NH₄PO₄), dipotassium phosphate (DKP) (K₂HPO₄), dipotassium phosphate hydrate (K₂HPO₄(H₂O)ₓ, where x is about 3 to about 6), tripotassium phosphate (K₃PO₄), tripotassium phosphate hydrate (K₃PO₄(H₂O)ₓ, where x=3, 7, or 9), tetrapotassium pyrophosphate (K₄P₂O₇), potassium bisulfate (KHSO₄), potassium ammonium sulfate (H₄KNO₄S), potassium sulfate (K₂SO₄), and mixtures thereof. The dipotassium phosphate can be anhydrous, substantially free of any hydrate. Alternatively, or in combination with the anhydrous dipotassium phosphate, the dipotassium phosphate can be a hydrate, substantially free of any anhydrous. The hydrate may have the formula K₂HPO₄(H₂O)ₓ, where x is about 3 to about 6. For example, x may be equal to at least one of 3 or 6. The dipotassium phosphate may contain a mixture of multiple different hydrates K₂HPO₄(H₂O)y, such that when measured, y constitutes an average weighted number of hydrates in the mixture, and thus y is not necessarily a whole number. For example, the average weighted value of y may be about 3.0 to about 6.0, preferably about 3.2 to about 5.8, more preferably about 3.5 to about 5.5, and more preferably about 4.0 to about 5.0. The dipotassium phosphate anhydrous and the dipotassium phosphate hydrate may be present in the forest fire retardant composition 200 in a weight ratio (anhydrous:hydrate) from about 0%:100% to about 100%:0%, including about 5%:95%, 10%:90%, 15%:85%, 20%:80%, 25%:75%, 30%:70%, 35%:65%, 40%:60%, 45%:55%, 50%:50%, 55%:45%, 60%:40%, 65%:35%, 70%:30%, 75%:25%, 80%:20%, 85%:15%, 90%:10%, 95%:5%, and any range between any two such ratios. The tripotassium phosphate can be anhydrous, substantially free of any hydrate. Alternatively, or in combination with the anhydrous tripotassium phosphate, the tripotassium phosphate can be a hydrate, substantially free of any anhydrous. The hydrate may have the formula K₃PO₄(H₂O)ₓ, where x is about 3 to about 9). For example, x may be equal to at least one of 3, 7, or 9. The tripotassium phosphate may contain a mixture of multiple different hydrates K₃PO₄(H₂O)_{y}, such that when measured, y constitutes an average weighted number of hydrates in the mixture, and thus y is not necessarily a whole number. For example, the average weighted value of y may be about 3.0 to about 9.0, preferably about 3.5 to about 8.5, more preferably about 4.0 to about 8.0, and more preferably about 4.5 to about 7.5. The tripotassium phosphate anhydrous and the tripotassium phosphate hydrate may be present in the forest fire retardant composition 200 in a weight ratio (anhydrous:hydrate) from about 0%:100% to about 100%:0%, including about 5%:95%, 10%:90%, 15%:85%, 20%:80%, 25%:75%, 30%:70%, 35%:65%, 40%:60%, 45%:55%, 50%:50%, 55%:45%, 60%:40%, 65%:35%, 70%:30%, 75%:25%, 80%:20%, 85%:15%, 90%:10%, 95%:5%, and any range between any two such ratios.

The halide salt may include a magnesium halide salt or a calcium halide salt. The magnesium halide salt may include magnesium chloride. The magnesium chloride can be anhydrous, substantially free of any hydrate. Alternatively, or in combination with the anhydrous magnesium chloride, the magnesium chloride can be a hydrate, substantially free of any anhydrous. The hydrate may have the formula MgCl₂(H₂O)ₓ, where x is about 1 to about 12. For example, x may be equal to at least one of 1, 2, 4, 6, 8, or 12. The magnesium chloride may contain a mixture of multiple different hydrates MgCl₂(H₂O)_{y}, such that when measured, y constitutes an average number of hydrates in the mixture, and thus y is not necessarily a whole number. For example, y may be about 1.0 to about 12.0, preferably about 1.5 to about 10.5, more preferably about 2.5 to about 9.5, and more preferably about 3.5 to about 8.5. The magnesium halide salt may also include one or more different phases, including but not limited to, Bischofite (MgCl₂(H₂O)₆) and/or magnesium chloride anhydrous (MgCl₂). For example, the potassium salt and magnesium halide salt may include potassium acetate and magnesium chloride anhydrous (MgCl₂). A mixture of potassium acetate and magnesium chloride anhydrous in the forest fire retardant composition 200 may have a weight ratio of the total amount of salt (potassium acetate:magnesium chloride) from about 0%:100% to about 100%:0%, preferably about 0.5%:99.5% to about 99.5%:0.5%, more preferably about 2%:98% to about 98%:2%, for example about 5%:95% to about 95%:5%.

Instead of (or in addition to) chlorine, the magnesium halide salt may include bromine as the halogen which forms a magnesium bromide salt. The bromine may be used alone in the magnesium halide salt; alternatively, the bromine may be used in combination with chlorine, thereby forming a mixture of magnesium bromide and magnesium chloride salts. The bromine salt, when used as a bromine flame retardant, has a mechanism that is similar to chlorine and may be used as a long-term fire retardant alone or in combination with chlorine. Halogens or other compounds that liberate stable radicals in the thermal environment of the flame front also operate with a mechanism that is similar to chlorine and may be used as a long-term fire retardant.

Instead of (or in addition to) magnesium chloride, the halide salt may be calcium chloride. The calcium chloride can be anhydrous, substantially free of any hydrate. Alternatively, or in addition to the anhydrous calcium chloride, the calcium chloride can be a hydrate, substantially free of any anhydrous. The hydrate may have the formula CaCl₂(H₂O)ₓ, where x is about 1 to about 6. For example, x may be equal to at least one of 1, 2, 4, or 6. The calcium chloride may contain a mixture of multiple different hydrates CaCl₂(H₂O)_{y}, such that when measured, y constitutes an average number of hydrates in the mixture, and thus y is not necessarily a whole number. For example, x may be about 1.0 to about 6.0, preferably about 1.5 to about 6.0, more preferably about 2.5 to about 9.5, and more preferably about 3.5 to about 8.5. Preferably, the calcium chloride is present in the composition 200 in a combination of both calcium chloride anhydrous and calcium chloride hydrate. The calcium chloride forest fire retardant composition may be used for a liquid concentrate. The calcium halide salt in the forest fire retardant composition 200 may include bromine as the halogen which forms a calcium bromide salt. The bromine may be used alone in the calcium halide salt; alternatively, the bromine may be used in combination with chlorine, thereby forming a mixture of calcium bromide and calcium chloride salts. The calcium halide salt in the forest fire retardant composition 200 may include bromine as the halogen which forms a calcium bromide salt. The bromine may be used alone in the calcium salt; alternatively, the bromine may be used in combination with chlorine, thereby forming a mixture of calcium bromide and calcium chloride salts.

The calcium and/or magnesium salt may include at least one of magnesium non-halide salt, calcium non-halide salt, magnesium calcium non-halide salt, or a combination thereof. The anion in the salt may include at least one of carbonate, sulfate, or phosphate. The salt may include magnesium non-halide salt, which may be anhydrous magnesium non-halide salt or magnesium non-halide salt hydrate. The magnesium non-halide salt may include at least one of magnesium carbonate (MgCO₃), magnesium phosphate (Mg₃(PO₄)₂), magnesium carbonate hydroxide hydrate (Mg₅(CO₃)₄(OH)₂(H₂O)₄), magnesium phosphate hydrate (Mg₃(PO₄)₂(H₂O)₈), magnesium oxide (MgO), magnesium hydroxide (Mg(OH)₂), or magnesium ammonium phosphate (Mg(PO₄HNH₄)₂). As an alternative to using a magnesium non-halide salt, or in addition to using a magnesium non-halide salt, the non-halide salt may further include calcium non-halide salt, which may be anhydrous calcium non-halide salt or calcium non-halide salt hydrate. The calcium non-halide salt may include at least one of calcium carbonate (CaCO₃), calcium phosphate (Ca₃(PO₄)₂), huntite (Mg₃Ca(CO₃)₄), calcium oxide (CaO), calcium hydroxide (Ca(OH)₂), or calcium phosphate hydrate (Ca₃(PO₄)₂(H₂O)₂).

Instead of (or in addition to), a magnesium non-halide salt, a calcium non-halide salt, or magnesium calcium non-halide salt, the calcium and/or magnesium salt may include the magnesium halide salts and/or the calcium halide salts disclosed above.

The phosphate salt may include ammonium salts of ortho, pyro, tripoly, or tetrapoly phosphoric acid. The ammonium salts of ortho, pyro, tripoly, or tetrapoly phosphoric acid in the forest fire retardant composition 200 may include one or more of the following: ammonium orthophosphates, ammonium pyrophosphates, ammonium polyphosphates having an average chain length of less than 20 phosphorus atoms. For example, the phosphate salt may include at least one of diammonium phosphate (DAP), diammonium orthophosphate (DAP), monoammonium phosphate (MAP), monoammonium orthophosphate (MAP), ammonium polyphosphate (APP), and mixtures thereof. A mixture of ammonium phosphates in the forest fire retardant composition 200 may include MAP containing from about 10% to about 12% ammoniacal nitrogen by weight and from about 40% to about 61% phosphorus pentoxide by weight, and DAP containing from about 16% to about 21% ammoniacal nitrogen by weight and from about 40% to about 54% phosphorus pentoxide by weight. A mixture of MAP and DAP in the forest fire retardant composition 200 may have a weight ratio of the total ammonium phosphate (MAP:DAP) from about 0%:100% to about 100%:0%, including about 5%:95%, 10%:90%, 15%:85%, 20%:80%, 25%:75%, 30%:70%, 35%:65%, 40%:60%, 45%:55%, 50%:50%, 55%:45%, 60%:40%, 65%:35%, 70%:30%, 75%:25%, 80%:20%, 85%:15%, 90%:10%, 95%:5%.

The potassium salt may also be used in combination with ammonium salts of ortho, pyro, tripoly, or tetrapoly phosphoric acid. A mixture of potassium salt(s) and ammonium salt(s) in the fire retardant composition 200 may have a weight ratio of the total amount of salt (potassium salt:ammonium salt) from about 0%:100% to about 100%:0%, including about 5%:95%, 10%:90%, 15%:85%, 20%:80%, 25%:75%, 30%:70%, 35%:65%, 40%:60%, 45%:55%, 50%:50%, 55%:45%, 60%:40%, 65%:35%, 70%:30%, 75%:25%, 80%:20%, 85%:15%, 90%:10%, 95%:5%, and any range between any two such ratios. For example, a mixture of tripotassium citrate and MAP in the forest fire retardant composition 200 may have a weight ratio of the total amount of salt (tripotassium citrate:MAP) from about 0%:100% to about 100%:0%, preferably about 0.5%:99.5% to about 99.5%:0.5%, more preferably about 2%:98% to about 98%:2%, for example about 5%:95% to about 95%:5%. For example, a mixture of DKP, MAP, and DAP in the forest fire retardant composition 200 may have a weight ratio of the total amount of salt (DKP:MAP:DAP) from about 100%:0%:0% to about 0%:100%:0% to about 0%:0%:100%, including about 95%:5%:0%, 90%:10%:0%, 80%:20%:0%, 70%:30%:0%, 60%:40%:0%, 50%:50%:0%, about 40%:60%:0%, 30%:70%:0%, 20%:80%:0%, 10%:90%:0%, 95%:0%:5%, 90%:0%:10%, about 80%:0%:20%, 70%:0%:30%, 60%:0%:40%, 50%:0%:50%, 40%:0%:60%, 30%:0%:70%, 20%:0%:80%, 10%:0%:90%, 95%:2.5%:2.5%, 90%:5%:5%, 80%:10%:10%, 70%:15%:15%, 60%:20%:20%, 50%:25%:25%, 40%:30%:30%, 30%:35%:35%, 20%:40%:40%, 10%:45%:45%, 0%:50%:50% and any range between any three such ratios.

Instead of (or in addition to) ammonium salts of ortho, pyro, tripoly, or tetrapoly phosphoric acid, the phosphate salt may include a sodium phosphate salt. The sodium phosphate salt may include sodium salts of mono-, di-, tri-, tetra, and polyphosphates. The sodium phosphate salt in the forest fire retardant composition 200 may include one or more of the following: monosodium phosphate (MSP), disodium phosphate (DSP), disodium phosphate hydrate, sodium ammonium phosphate (SAP), sodium ammonium phosphate hydrate (SAP-H), sodium tripolyphosphate (STPP), trisodium phosphate (TSP), and mixtures thereof. The disodium phosphate can be anhydrous, substantially free of any hydrate. Alternatively, or in combination with the anhydrous disodium phosphate, the disodium phosphate can be a hydrate, substantially free of any anhydrous. The hydrate may have the formula Na₂HPO₄(H₂O)ₓ, where x is about 1 to about 12. For example, x may be equal to at least one of 2, 7, 8, or 12. The disodium phosphate may contain a mixture of multiple different hydrates Na₂HPO₄(H₂O)_{y}, such that when measured, y constitutes an average weighted number of hydrates in the mixture, and thus y is not necessarily a whole number. For example, the average weighted value of y may be about 2.0 to about 12.0, preferably about 1.5 to about 11.5, more preferably about 2.5 to about 10.5, and more preferably about 3.5 to about 9.5. The sodium ammonium phosphate can be anhydrous, substantially free of any hydrate. Alternatively, or in combination with the anhydrous sodium ammonium phosphate, the sodium ammonium phosphate can be a hydrate. The hydrate may have the formula NaPO₄HNH₄(H₂O)ₓ, where x is about 1 to about 4. For example, x may be equal to at least one of 1, 2, 3, or 4. The disodium phosphate may also contain a mixture of multiple different hydrates NaPO₄HNH₄(H₂O)_{y}, such that when measured, y constitutes an average weighted number of hydrates in the mixture, and thus y is not necessarily a whole number. For example, the average weighted value of y may be about 1.0 to about 4.0, preferably about 1.2 to about 3.9, more preferably about 1.4 to about 3.8, and more preferably about 1.6 to about 3.6. The sodium ammonium phosphate hydrate is preferably sodium ammonium phosphate tetrahydrate (SAP-TH) having the formula NaPO₄HNH₄(H₂O)₄. The potassium salt may also be used in combination with the sodium phosphate salt.

Instead of (or in addition to) ammonium salts of ortho, pyro, tripoly, or tetrapoly phosphoric acid and/or sodium phosphate salt(s), the phosphate salt may be a calcium phosphate salt. The calcium phosphate salt may include calcium salts of orthophosphates, di- and monohydrogen phosphates, and/or di- and polyphosphates. The calcium phosphate salt in the forest fire retardant composition 200 may include one or more of the following: monocalcium phosphate (MCP), dicalcium phosphate (DCP), tricalcium phosphate (TCP), octacalcium phosphate (OCP), dicalcium diphosphate, calcium triphosphate, hydroxyapatite, Apatite, or tetracalcium phosphate (TTCP). The potassium salt may also be used in combination with the calcium phosphate salt.

The sulfate salt may include magnesium sulfate. The magnesium sulfate can be anhydrous, substantially free of any hydrate. Alternatively, or in combination with the anhydrous magnesium sulfate, the magnesium sulfate can be a hydrate, substantially free of any anhydrous. The hydrate may have the formula MgSO₄(H₂O)ₓ, where x is about 1 to about 11. For example, x may be equal to at least one of 1, 2, 3, 4, 5, 6, 7, 9, 10 or 11. The magnesium sulfate may contain a mixture of multiple different hydrates MgSO₄(H₂O)_{y}, such that when measured, y constitutes an average weighted number of hydrates in the mixture, and thus y is not necessarily a whole number. For example, the average weighted value of y may be about 1.0 to about 11.0, preferably about 1.5 to about 10.5, more preferably about 2.5 to about 9.5, and more preferably about 3.5 to about 8.5. The magnesium sulfate hydrate is preferably magnesium sulfate monohydrate having the formula MgSO₄(H₂O)₁. The magnesium sulfate may also include one or more different phases, including but not limited to, Kieserite (MgSO₄(H₂O)₁), Hexahydrite (MgSO₄(H₂O)₆), and/or Epsomite (MgSO₄(H₂O)₇). The sulfate salt may also include potassium sulfate (K₂SO₄), leonite (K₂Mg(SO₄)₂(H₂O)₄), or picromerite (K₂Mg(SO₄)₂(H₂O)₆). Alternatively, the magnesium sulfate can be extracted from brine or sea water and may also contain small amounts of other salts and impurities. The magnesium sulfate may exist in a byproduct salt mixture with other salts that result from the extraction of magnesium chloride from brine or sea water. The salts in the byproduct salt mixture may include, but are not limited to, magnesium sulfate (MgSO₄), magnesium sulfate hydrate MgSO₄(H₂O)ₓ where x is about 1 to about 11, potassium sulfate (K₂SO₄), leonite (K₂Mg(SO₄)₂(H₂O)₄), or picromerite (K₂Mg(SO₄)₂(H₂O)₆), magnesium chloride anhydrous (MgCl₂), magnesium sulfate hydrate (MgSO₄(H₂O)ₓ) where x is 1, 2, 3, 4, 5, 6, 7, 9, 10 or 11, sodium chloride (NaCl). The salts in the byproduct salt mixture may be in one or more phases, including but not limited to, kieserite (MgSO₄(H₂O)₁), dipotassium Sulfate (VI) (K₂SO₄), bischofite (MgCl₂(H₂O)₆), magnesium chloride anhydrous (MgCl₂), hexahydrite (MgSO₄(H₂O)₆), and/or Epsomite (MgSO₄(H₂O)₇).

The one or more salt(s) of Table 1 may be anhydrous, substantially free of any hydrate. Alternatively, or in combination with any anhydrous salt, the salt may be a hydrate. The hydrate salt may be a mixture of multiple different hydrates. The anhydrous salt and the hydrate salt may be present in the forest fire retardant composition 200 in a weight ratio (anhydrous:hydrate) from about 0%:100% to about 100%:0%, including about 5%:95%, 10%:90%, 15%:85%, 20%:80%, 25%:75%, 30%:70%, 35%:65%, 40%:60%, 45%:55%, 50%:50%, 55%:45%, 60%:40%, 65%:35%, 70%:30%, 75%:25%, 80%:20%, 85%:15%, 90%:10%, 95%:5%, and any range between any two such ratios.

In one embodiment, the salt of the forest fire retardant composition 200 may include at least two salts. The first salt may include any of the retardant compounds listed in Table 1. The second salt may include any different retardant compound listed in Table 1. In the forest fire retardant composition 200, the weight percent of first salt (including both anhydrous and hydrate):second salt (including both anhydrous and hydrate) may be about 0%:100% to about 100%:0%, including about 5%:95%, 10%:90%, 15%:85%, 20%:80%, 25%:75%, 30%:70%, 35%:65%, 40%:60%, 45%:55%, 50%:50%, 55%:45%, 60%:40%, 65%:35%, 70%:30%, 75%:25%, 80%:20%, 85%:15%, 90%:10%, 95%:5%, and any range between any two such ratios.

In another embodiment, the salt of the forest fire retardant composition 200 may include at least three salts. The first salt may include any of the retardant compounds listed in Table 1. The second salt may include any different retardant compound listed in Table 1. The third salt may include another different retardant compound listed in Table 1. In the forest fire retardant composition 200, the weight percent of first salt (including both anhydrous and hydrate):second salt (including both anhydrous and hydrate):third salt (including both anhydrous and hydrate) may be about 100%:0%:0% to about 0%:100%:0% to about 0%:0%:100%, including about 95%:5%:0%, 90%:10%:0%, 80%:20%:0%, 70%:30%:0%, 60%:40%:0%, 50%:50%:0%, about 40%:60%:0%, 30%:70%:0%, 20%:80%:0%, 10%:90%:0%, 95%:0%:5%, 90%:0%:10%, about 80%:0%:20%, 70%:0%:30%, 60%:0%:40%, 50%:0%:50%, 40%:0%:60%, 30%:0%:70%, 20%:0%:80%, 10%:0%:90%, 95%:2.5%:2.5%, 90%:5%:5%, 80%:10%:10%, 70%:15%:15%, 60%:20%:20%, 50%:25%:25%, 40%:30%:30%, 30%:35%:35%, 20%:40%:40%, 10%:45%:45%, 0%:50%:50% and any range between any three such ratios.

In one embodiment, the forest fire retardant composition 200 may contain a mixture of phosphates including one or more of the phosphates listed in Table 1. In certain embodiments, the mixture of phosphates has a molar ratio of ammoniacal nitrogen to phosphorus (N/P molar ratio) of about 0.4 to about 2.0, preferably about 0.6 to about 1.8, more preferably about 0.8 to about 1.9. For example, the N/P molar ratio is less than about 1.1, or is about 1. For example, the N/P molar ratio may be below 1.09, below 1.08, below 1.07, below 1.06, below 1.05, below 1.04, below 1.03, below 1.02, below 1.01, or below 1.00. In another embodiment, the N/P molar ratio is greater than about 1.1, for example about 1.1, about 1.2, about 1.3, about 1.4, about 1.5, about 1.6, about 1.7, about 1.8, about 1.9. In yet another embodiment, the N/P molar ratio is greater than about 1.9 to about 3.0, preferably about 2.0 to about 2.9, more preferably about 2.1 to about 2.7. For example, the N/P molar ratio may be above 1.95, above 1.96, above 1.97, above 1.98, above 1.99, or above 2.0. As used herein, “ammoniacal nitrogen,” or “phosphorus,” respectively, when referring to the nitrogen to phosphorus molar ratio (N/P molar ratio) refers to any ammoniacal nitrogen (NH₄⁺) or phosphorus present in the formulation from any of the sources listed in Table 1. For example, the N/P ratio would not include any nitrogen or phosphorus from a dye not listed in Table 1.

In the liquid concentrate dispersion 201, the weight percent of the retardant compound relative to the total weight of the liquid concentrate dispersion 201 is about 10% to about 90%, preferably about 15% to about 85%, more preferably about 20% to about 80%, and particularly about 22% to about 78%.

In the final diluted product 202, the weight percent of the retardant compound relative to the total weight of the final diluted product 202 is about 4% to about 30%, preferably about 5% to about 25%, more preferably about 6% to about 20%, and particularly about 7% to about 18%.

The forest fire retardant composition 200 may further include a corrosion inhibitor. The corrosion inhibitor may include an inhibitor for brass, iron, aluminum, steel, copper, and/or magnesium. The corrosion inhibitor may also include an inhibitor for any of the compounds listed in Table 1. The corrosion inhibitor for magnesium may include any corrosion inhibitors disclosed in Lamaka, S. V., et al. “Comprehensive screening of Mg corrosion inhibitors.” Corrosion Science 128 (2017), hereby incorporated by reference in its entirety. The corrosion inhibitor may include an alkyl (such as an alkyl amine) and/or one or more azoles. The corrosion inhibitor may include COBRATEC 928, Denatonium benzoate, benzoic acid, diammonium phosphate, monoammonium phosphate, Wintrol SB 25Na, or a combination of the above. The corrosion inhibitor may include one or more azoles. The corrosion inhibitor may be a Wintrol® Super Azole Mix (Wintrol® SAM-H90 from Wincom, Inc). The Wintrol® SAM-H90 is designed for aqueous application. Wintrol® SAM-H90 provides corrosion resistance in highly corrosive environments caused by halogens, such chloride. Optionally, Wintrol® SAM-H38Na may be used as the corrosion inhibitor, alone or in combination with Wintrol® SAM-H90. The corrosion inhibitor may include but is not limited to, sodium selenite, sodium stearate, sodium lauryl sulfate, stearic acid, sodium benzoate, sodium fluoride, sodium phosphate, monosodium phosphate (MSP), disodium phosphate (DSP), disodium phosphate hydrate(s) (Na₂HPO₄(H₂O)ₓ, where x is about 1 to about 12), trisodium phosphate (TSP), monopotassium phosphate (MKP), dipotassium phosphate (DKP), dipotassium phosphate hydrate(s) (K₂HPO₄(H₂O)ₓ, where x is about 3 to about 6), tripotassium phosphate, tripotassium phosphate hydrate(s) (K₃PO₄(H₂O)ₓ, where x is about 3 to about 9), monoammonium phosphate (MAP), diammonium phosphate (DAP), triammonium phosphate, triammonium phosphate hydrate(s), iron pyrophosphate, sodium fumarate dibasic, sodium fumarate, magnesium phosphate, benzotriazole derivatives, sodium salts of benzotriazole and derivatives, aqueous mixtures of benzotriazole and derivatives, benzotriazole-5-carboxcylic acid, benzotriazole, butyl benzotriazole, sodium butyl benzotriazole, tolytriazole derivatives, sodium salts of tolytriazole and derivatives, aqueous mixtures of tolytriazole and derivatives, tetrathydro tolytriazole, tolytriazole, hydrogenated tolyltriazole and mixtures thereof, sodium tolytriazole, sodium tolytriazole (50% solution), 3-hydroxyphenyl-4-phenyl-5-mercapto-1,2,4-triazole (HPMT), 3-aminophenyl-4-phenyl-5-mercapto-1,2,4-triazole (APMT), 3,4-diphenyl-5-mercapto-1,2,4-triazole (DPMT), 3-cinnamyl-4-phenyl-5-mercapto-1,2,4-triazole (CPMT), 1,8-napthalaldehydic acid, octadecylphosphonic acid, sodium dodecyl sulfonate (SDBS), Wintrol® BBT-25Na, Wintrol® BBT, Wintrol® THT-T, Wintrol® THT-35PG, Wintrol® THT-50K, Wintrol® SAM-H90, Wintrol SB 25Na, Wintrol® SAM-H38Na, Wintrol® SAM-H40(OS), Wintrol® SAM-B90, berberine, pyrrolidine benzylic, catechin, lysergic acid, carmine, fast green, aniline, vanillin, triethanolamine, low freeze grade triethanolamine (85% TEA and 15% water), N,N,N′,N′-Tetrakis(2-hydroxyethyl)ethylenediamine, tris(hydroxymethyl)aminomethane (TRIS), Tris(hydroxymethyl)aminomethane hydrochloride (TRIS-HCl), p-chloroaniline, p-nitroaniline, p-methoxyaniline, p-methylaniline, p-cumate Na, sodium silicate, sodium molybdate, sodium molybdate dihydrate, disodium molbdate, disodium molybdate dihydrate, a biopolymer (such as rhamsan gum, xanthan gum, diutan gum, guar gum, or welan gum), sodium silicofluoride (SSF), and dimercaptothiadiazole (DMTD), or a combination of the above.

In the liquid concentrate dispersion 201, the weight percent of the corrosion inhibitor(s) (including any water in the corrosion inhibitor(s)) relative to the total weight of the liquid concentrate dispersion 201 is about 0.0125% to about 5.0%, preferably about 0.025% to about 4.5%, more preferably about 0.05% to about 4.0%, and particularly about 0.075% to about 3.5%.

In the final diluted product 202, the weight percent of the corrosion inhibitor(s) (including any water in the corrosion inhibitor(s)) relative to the total weight of the final diluted product 202 is about 0.01% to about 4.0%, preferably about 0.015% to about 3.5%, more preferably about 0.02% to about 3.0%, and particularly about 0.025% to about 2.5%.

To control the viscosity of the composition 200, the composition 200 may also include at least one thickening agent. The thickening agent may be a polyurethane, a polyvinyl alcohol, a polyvinylpyrrolidone, an acrylic polymer, a gum, a cellulosic, a sulfonate, a saccharide, a clay, an organosilicone, or a protein, including but not limited to latex, styrene, butadiene, polyvinyl alcohol, attapulgite, bentonite, montmorillonite, algin, collagen, casein, albumin, castor oil, cornstarch, arrowroot, yuca starch, carrageenan, pullulan, konjac, alginate, gelatin, agar, pectin, carrageenan, chitosan, xanthan gum, food grade xanthan gum, technical grade xanthan gum, salt tolerant xanthan gum, normal grind xanthan gum, fine grind xanthan gum, technical-grade fine-grind salt-tolerant xanthan gum, guar gum, rhamsan gum, diutan gum, welan gum, cellulose gum, acacia guar gum, locust bean gum, acacia gum, gum tragacanth, glucomannan polysaccharide gum, alginic acid, sodium alginate, potassium alginate, ammonium alginate, calcium alginate, carboxymethyl cellulose (CMC), methyl cellulose, hydroxyethyl cellulose (HEC), hydroxymethyl cellulose (HMC), hydroxypropyl methylcellulose (HPMC), ethylhydroxymethyl cellulose, hypromellose (INN), cetyl alcohol, cetearyl alcohol, polyethylene glycol (PEG), monoethylene glycol, acrylic microgel, acrylic amide wax, a clay, a surface functionalized clay (e.g., a polar dispersible clay, a non-polar dispersible clay, and/or an aqueous clay), a phyllosilicate, an organically modified phyllosilicate, a crystalline silica clay (i.e., Opigel-WX from BYK), or a sepiolite clay (i.e., Pangel S9 from Tolsa group). A combination of thickeners may provide a similar viscosity profile of the composition 200 with a varying weight percent of the thickening agent(s). For example, two or more of the above viscosity modifiers may be combined to provide a low viscosity (e.g., 150-400 cP), or a medium viscosity (e.g., 401-800 cP), or a high viscosity (e.g., 801-1500 cP).

In the liquid concentrate dispersion 201, the weight percent of the thickening agent(s) relative to the total weight of the liquid concentrate dispersion 201 is about 0.005% to about 6.0%, preferably about 0.01% to about 5.5%, more preferably about 0.05% to about 5.0%, and particularly about 0.1% to about 4.5%.

In the final diluted product 202, the weight percent of the thickening agent(s) relative to the total weight of the final diluted product 202 is about 0.005% to about 6.0%, preferably about 0.01% to about 5.5%, more preferably about 0.05% to about 5.0%, and particularly about 0.1% to about 4.5%.

In one embodiment, the forest fire retardant composition 200 includes a first thickening agent. The first thickening agent may be a polyurethane, a polyvinyl alcohol, a polyvinylpyrrolidone, an acrylic polymer, a gum, a cellulosic, a sulfonate, a saccharide, a clay, an organosilicone, or a protein, including any of the thickening agent(s) disclosed above. The weight percent of the first thickening agent, relative to the total weight of the liquid concentrate dispersion 201 is about 0.005% to about 6.0%, preferably about 0.01% to about 5.5%, more preferably about 0.05% to about 5.0%, and particularly about 0.1% to about 4.5%. In the final diluted product 202, the weight percent of the first thickening agent relative to the total weight of the final diluted product 202 is about 0.005% to about 6.0%, preferably about 0.01% to about 5.5%, more preferably about 0.05% to about 5.0%, and particularly about 0.1% to about 4.5%.

In one embodiment, the first thickening agent may be a first polysaccharide gum. The weight percent of the polysaccharide gum, relative to the total weight of the liquid concentrate dispersion 201 is about 0.005% to about 6.0%, preferably about 0.01% to about 5.5%, more preferably about 0.05% to about 5.0%, and particularly about 0.1% to about 4.5%. In the final diluted product 202, the weight percent of the polysaccharide gum relative to the total weight of the final diluted product 202 is about 0.005% to about 6.0%, preferably about 0.01% to about 5.5%, more preferably about 0.05% to about 5.0%, and particularly about 0.1% to about 4.5%.

In another embodiment, the forest fire retardant composition 200 includes both the first thickening agent (discussed above) and a second thickening agent. The second thickening agent may be a polyurethane, a polyvinyl alcohol, a polyvinylpyrrolidone, an acrylic polymer, a gum, a cellulosic, a sulfonate, a saccharide, a clay, an organosilicone, or a protein, including any of the thickening agent(s) disclosed above. In one embodiment, the second thickening agent may be silica, clay, or a polysaccharide gum. The weight percent of the second thickening agent relative to the total weight of the liquid concentrate dispersion 201 is about 0.005% to about 6.0%, preferably about 0.01% to about 5.5%, more preferably about 0.05% to about 5.0%, and particularly about 0.1% to about 4.5%. In the final diluted product 202, the weight percent of the second thickening agent relative to the total weight of the final diluted product 202 is about 0.005% to about 6.0%, preferably about 0.01% to about 5.5%, more preferably about 0.05% to about 5.0%, and particularly about 0.1% to about 4.5%.

In one embodiment, the second thickening agent may be a second polysaccharide gum. The weight percent of the second polysaccharide gum relative to the total weight of the liquid concentrate dispersion 201 is about 0.005% to about 6.0%, preferably about 0.01% to about 5.5%, more preferably about 0.05% to about 5.0%, and particularly about 0.1% to about 4.5%. In the final diluted product 202, the weight percent of the second polysaccharide gum relative to the total weight of the final diluted product 202 is about 0.005% to about 6.0%, preferably about 0.01% to about 5.5%, more preferably about 0.05% to about 5.0%, and particularly about 0.1% to about 4.5%.

To control the pH of the composition 200, the composition 200 may also include buffering agents such as organic amines including but not limited to triethanolamine (C₆H₁₅NO₃), low freeze grade triethanolamine (85% TEA and 15% water), diethanolamine, monoethanolamine, tris(hydroxymethyl)aminomethane, N,N,N′,N′-Tetrakis(2-hydroxyethyl)ethylenediamine, tris(hydroxymethyl)aminomethane (TRIS), Tris(hydroxymethyl)aminomethane hydrochloride (TRIS-HCl), ethylenediamine tetraacetic acid, ethylene diamine, piperidine, pyrrolidine, DABCO, N-methyl pyrrolidine, N-methylpyrrolidone, quinuclidine, diisoropryopylamine, diisopropylmethylamine, methyl piperidine, N-[tris(hydroxymethyl)methyl]glycine, 3-dimethylamino-1-propanol, or 3-(diethylamino)-1,2, propanediol. The buffering agent may include one or more of the phosphate, potassium, sodium, and/or ammonium salts disclosed in Table 1. For example, the buffering agent may include salts of potassium, sodium, ammonium, phosphate, or citric acid disclosed herein, including but not limited to, monosodium phosphate (MSP), disodium phosphate (DSP), disodium phosphate hydrate(s), trisodium phosphate (TSP), monopotassium phosphate (MKP), dipotassium phosphate (DKP), dipotassium phosphate hydrate(s), tripotassium phosphate, tripotassium phosphate hydrate(s), monoammonium phosphate (MAP), diammonium phosphate (DAP), triammonium phosphate, triammonium phosphate hydrate(s) ((NH₄)₃PO₄(H₂O)ₓ where x is about 3), sodium ammonium phosphate (SAP), sodium ammonium phosphate hydrate (SAP-H), monopotassium citrate (KH₂C₆H₅O₇), potassium gluconate (C₆H₁₁KO₇), dipotassium citrate (C₆H₆K₂O₇), tripotassium citrate (K₃C₆H₅O₇), or tripotassium citrate monohydrate (K₃C₆H₅O₇(H₂O)₁). The buffering agent may also be a strong acid, a weak acid, a strong base, or a weak base.

In the liquid concentrate dispersion 201, the weight percent of the buffering agent(s) relative to the total weight of the liquid concentrate dispersion 201 is about is about 0.025% to about 45%, preferably about 0.05% to about 40%, more preferably about 0.075% to about 35%, and particularly about 0.1% to about 30%.

In the final diluted product 202, the weight percent of the buffering agent(s) relative to the total weight of the final diluted product 202 is about 0.025% to about 20%, preferably about 0.05% to about 18%, more preferably about 0.075% to about 16%, and particularly about 0.1% to about 14%.

The strong acid and/or weak acid may include but is not limited to monosodium phosphate (MSP), sodium bicarbonate, sodium bisulfate, monosodium dihydrogen orthophosphate, disodium hydrogen phosphate, potassium bisulfite, ammonium chloride, ammonium sulfate, sulfurous acid, sulfuric acid, hyposulfurous acid, persulfuric acid, pyrosulfuric acid, disulfurous acid, dithionous acid, tetrathionic acid, thiosulfurous acid, hydrosulfuric acid, peroxydisulfuric acid, perchloric acid, hydrochloric acid, hypochlorous acid, chlorous acid, chloric acid, hyponitrous acid, nitrous acid, nitric acid, pernitric acid, carbonous acid, carbonic acid, hypocarbonous acid, percarbonic acid, oxalic acid, acetic acid, pyrophosphoric acid, hydrophosphoric acid, hydrobromic acid, bromous acid, bromic acid, hypobromous acid, hypoiodous acid, iodous acid, iodic acid, periodic acid, hydroiodic acid, hydroselenic acid, selenic acid, selenous acid, hydronitric acid, boric acid, molybdic acid, perxenic acid, silicofluoric acid, telluric acid, tellurous acid, tungstic acid, xenic acid, citric acid, formic acid, pyroantimonic acid, antimonic acid, antimonous acid, silicic acid, titanic acid, arsenic acid, pertechnetic acid, hydroarsenic acid, tetraboric acid, metastannic acid, hypooxalous acid, silicous acid, uranic acid, diuranic acid, malonic acid, tartartic acid, glutamic acid, phthalic acid, azelaic acid, barbituric acid, benzilic acid, cinnamic acid, fumaric acid, glutaric acid, gluconic acid, hexanoic acid, lactic acid, malic acid, oleic acid, folic acid, propiolic acid, propionic acid, rosolic acid, stearic acid, tannic acid, trifluoroacetic acid, uric acid, ascorbic acid, gallic acid, acetylsalicylic acid, acetic acid, or an acidic organic amine.

In the liquid concentrate dispersion 201, the weight percent of the strong acid and/or weak acid relative to the total weight of the liquid concentrate dispersion 201 is about is about 0.001% to about 30%, preferably about 0.002% to about 25%, more preferably about 0.004% to about 20%, and particularly about 0.008% to about 15%.

In the final diluted product 202, the weight percent of the strong acid and/or weak acid relative to the total weight of the final diluted product 202 is about 0.001% to about 30%, preferably about 0.002% to about 25%, more preferably about 0.004% to about 20%, and particularly about 0.008% to about 15%.

The strong base and/or weak base may include but is not limited to disodium phosphate (DSP), diammonium phosphate (DAP), disodium phosphate hydrate, dipotassium phosphate, sodium tripolyphosphate, trisodium phosphate, sodium carbonate, sodium bicarbonate, potassium carbonate, potassium bicarbonate, ammonium carbonate, ammonium bicarbonate, calcium carbonate, sodium acetate, trisodium citrate, trisodium phosphate, tripotassium phosphate, diammonium citrate, sodium borate, sodium N-Cyclohexyl-2-aminoethanesulfonate, sodium 4-(2-hydroxyethyl)-1-piperazineethanesulfonate, sodium N-(2-Acetamido)-2-aminoethanesulfonate, sodium N-cyclohexyl-3-aminopropanesulfonate, sodium 3-(N-morpholino)propanesulfonate, sodium 3-[4-(2-Hydroxyethyl)piperazin-1-yl]propane-1-sulfonate, sodium sulfide, zinc chloride hydroxide, magnesium oxychloride, aluminum hydroxide, bismuth oxychloride, beryllium hydroxide, boron hydroxide, calcium hydroxide, cesium hydroxide, cobalt(III) hydroxide, copper(II) hydroxide, gallium(III) hydroxide, gold(III) hydroxide, indium(II) hydroxide, iridium(III) hydroxide, iron(III) hydroxide, lithium hydroxide, molybdenum hydroxide, nickel oxo-hydroxide, nickel(III) hydroxide, osmium(IV) hydroxide, silver hydroxide, strontium hydroxide, technetium(II) hydroxide, thorium hydroxide, tin(IV) hydroxide, titanium(III) hydroxide, tungsten(II) hydroxide, yttrium hydroxide, zirconium hydroxide, ammonium hydroxide, barium hydroxide, bismuth(III) hydroxide, cerium(III) hydroxide, chromium(II) hydroxide, cobalt(II) hydroxide, copper(I) hydroxide, gallium(II) hydroxide, gold(I) hydroxide, indium(I) hydroxide, indium(III) hydroxide, iron(II) hydroxide, lanthanum hydroxide, magnesium hydroxide, neodymium hydroxide, nickel(II) hydroxide, niobium hydroxide, palladium(II) hydroxide, potassium hydroxide, sodium hydroxide, tantalum(V) hydroxide, tetramethylammonium hydroxide, thallium(III) hydroxide, tin(II) hydroxide, titanium(II) hydroxide, titanium(IV) hydroxide, uranyl hydroxide, vanadium(III) hydroxide, ytterbium hydroxide, zinc hydroxide, or a basic organic amine.

In the liquid concentrate dispersion 201, the weight percent of the strong base and/or weak base relative to the total weight of the liquid concentrate dispersion 201 is about 0.01% to about 45%, preferably about 0.02% to about 40%, more preferably about 0.03% to about 35%, and particularly about 0.04% to about 30%.

In the final diluted product 202, the weight percent of the strong base and/or weak base relative to the total weight of the final diluted product 202 is about 0.01% to about 45%, preferably about 0.02% to about 40%, more preferably about 0.03% to about 35%, and particularly about 0.04% to about 30%.

In one embodiment, the forest fire retardant composition 200 has a pH of about 4.0 to about 13.0, preferably about 4.3 to about 12.5, more preferably about 4.5 to about 12.0, and more preferably about 5.0 to about 11.5. For example, the pH of the forest fire retardant composition 200 may be about 5.0, about 5.1, about 5.2, about 5.3, about 5.4, about 5.5, about 5.6, about 5.7, about 5.8, about 5.9, about 6.0, about 6.1, about 6.2, about 6.3, about 6.4, about 6.5, about 6.6, about 6.7, about 6.8, about 6.9, about 7.0, about 7.1, about 7.2, about 7.3, about 7.4, about 7.5, about 7.6, about 7.7, about 7.8, about 7.9, about 8.0, about 8.1, about 8.2, about 8.3, about 8.4, about 8.5, about 8.6, about 8.7, about 8.8, about 8.9, about 9.0, about 9.1, about 9.2, about 9.3, about 9.4, about 9.5, about 9.6, about 9.7, about 9.8, about 9.9, about 10.0, about 10.1, about 10.2, about 10.3, about 10.4, about 10.5, about 10.6, about 10.7, about 10.8, about 10.9, about 11.0, about 11.1, about 11.2, about 11.3, about 11.4, about 11.5, or any value in between 5.0 and 11.5.

The composition 200 may also include surfactant components including but not limited to a sodium dodecyl sulfate (SDS), sodium lauryl sulfate (SLS), sodium 4-dodecylbenzenesulfonate (SDBS), modified silicones and emulsions thereof such as, a food grade foam control agent from Ivanhoe Industries Inc. including but not limited to a hydrophobic dispersion in oil (e.g., XFO-880, XFO-884, XFO-893, XFO-270, XFO-280, XFO-399, XFO-501AV, XFO-515B, XFO-809), a 10% active silicone emulsion (e.g., XFO-10S, XFO-220), a 30% active silicone emulsion (e.g., XFO-30S, XFO-225), a 100% active silicone compound (e.g., XFO-100S), a non-ionic surfactant (e.g., XFO-313, I-FLO 3K, I-FLO 6K), a non-ionic surfactant in oil (e.g., XFO-FG2), or a polyol blend (e.g., XFO-635D, XFO-645D, XFO-FD92), a food-grade, silicone emulsion from Dow Chemical (e.g., XIAMETER ACP-1920, XIAMETER AFE-1510, XIAMETER AFE-0010, XIAMETER AFE-1520, XIAMETER AFE-1530, XIAMETER AFE-0300, XIAMETER AFE-0100, XIAMETER ACP-1500), a food-grade, non-silicone defoamer, poloxamers, polyoxyethylene block copolymer surfactant (e.g., Pluronic® L101), fatty alcohols, zwitterionic surfactants, polyglycerol esters, sorbitan esters, lecithins, alkylammonium salts, alkyl phenol ethoxylates, or a combination of the above to reduce surface tension and increase the spreading and wetting properties of the forest fire retardant composition 200.

In the liquid concentrate dispersion 201, the weight percent of the surfactant(s) relative to the total weight of the liquid concentrate dispersion 201 is about 0.0025% to about 4.0%, preferably about 0.002% to about 3.5%, more preferably about 0.005% to about 3.0%, and particularly about 0.008% to about 2.5%.

In the final diluted product 202, the weight percent of the surfactant(s) relative to the total weight of the final diluted product 202 is about 0.006% to about 4.0%, preferably about 0.008% to about 3.5%, more preferably about 0.01% to about 3.0%, and particularly about 0.015% to about 2.5%.

The composition 200 may also include adjuvants including but not limited to triethanolamine, propylene glycol, propylene carbonate, RJ-7033, RJ-7077, Silwet HS-312, Silwet HS-604, Silwet 625, Silwet 641, Silwet PD, XFO-10S FG Silicone, XFO-30S FG, KFO 200, poloxamers (i.e. nonionic triblock copolymers composed of a central hydrophobic chain of polyoxypropylene (poly(propylene oxide)) flanked by two hydrophilic chains of polyoxyethylene (poly(ethylene oxide))), P104, PE 3100, PE6800, polyethylene glycol, or polypropylene glycol, or a combination of the above.

In the liquid concentrate dispersion 201, the weight percent of the adjuvant(s) relative to the total weight of the liquid concentrate dispersion 201 is about 0.0025% to about 4.0%, preferably about 0.002% to about 3.5%, more preferably about 0.005% to about 3.0%, and particularly about 0.008% to about 2.5%.

In the final diluted product 202, the weight percent of the adjuvant(s) relative to the total weight of the final diluted product 202 is about 0.006% to about 4.0%, preferably about 0.008% to about 3.5%, more preferably about 0.01% to about 3.0%, and particularly about 0.015% to about 2.5%.

The composition 200 may be uncolored (i.e., clear, natural colored, or free of colorants), or it may be colored using a colorant. The colorant may be a fugitive colorant, a non-fugitive colorant, or a combination of the two. The composition 200 has a first hue which is a color, i.e., either colorless or a color which blends with the normal vegetation and/or ground in the drop zone. This first hue may be grey or white or a combination of the two. The colorant initially colors the composition 200 to a second hue which contrasts with the hue of the ground vegetation. The colorant may be a fugitive component such as a dye or a dye which is dispersed in a matrix (i.e., a pigment), which fades over time and under ambient field conditions to a colorless or less highly colored hue. The colorant may be a mixture of an organic pigment (e.g., a fluorescent pigment) and inorganic pigment (e.g., iron oxide, titania, and/or titanium dioxide). Preferably the colorant is one that is compatible with the fire retardant salts described herein. The fugitive colorant may fade over time with exposure to sunlight. The fugitive colorant may also be a fast fade fugitive colorant that is designed to last a few hours to a few weeks, for example.

Several fugitive component dyes and pigments can be used as a colorant. The colorant may be a dye(s) and/or a pigment(s). For example, many water-soluble dyes fade rapidly and there are so-called fluorescent pigments (fluorescent dyes encapsulated in a resin integument or dispersed in a thermoplastic as an emulsion) which are suspended in forest fire retardant compositions and which also fade rapidly to provide a fugitive effect. The colorant may be an agricultural, pesticide, or food-grade dye or combinations of such dyes that are red, pink, claret, and/or cerise. Examples of fugitive dyes and pigments include, but are not limited to, C.I. Basic Red I dye, 6BL dye, Basic Violet II dye, C.I. Basic Violet 11:1 (tetrachlorozincate), C.I. Basic Red 1:1, Basic Yellow 40, acid fuchsin, basic fuchsin, new fuchsin, acid red 1, acid red 4, acid red 8, acid red 18, acid red 27, acid red 37, acid red 88, acid red 97, acid red 114, acid red 151, acid red 183, acid red 183, fast red violet 1B base, solvent red, Rhodamine B, Rhodamine 6G, Rhodamine 123, Rhodamine 110 chloride, erythrosine B, Basacryl red, Phloxine B, rose Bengal, direct red 80, direct red 80, Sudan red 7B, Congo red, neutral red, Fluorescent Red Mega 480, Fluorescent red 610, Fluorescent red 630, Fluorescent Red Mega 520, Pylaklor Red S-361, Pylaklor Scarlet LX-6364A Pylam Bright Red LX-1895 Pylam Coral LX-1801, FD&C Red #3, FD&C Red #4, FD&C Red #40, FD&C Red #4 Lake, D&C Red #33, D&C Red #33 Lake, and encapsulated-dye pigments which are available commercially, e.g., the “AX” series pigments, supplied by Day-Glo Color Corp., Cleveland, Ohio. The dye may be Liquitint 564 (λ=564 nm) or Liquitint Agro Pink 564 (λ=564 nm) from Milliken & Company (Spartanburg, SC). The colorant may also be an organic pigment such as a fluorescent pigment. The fluorescent pigment may be Day-Glo Aurora pink or another pink, red, orange, or crimson (or a combination of the four) fluorescent pigment dispersion. The fluorescent pigment may be UV sensitive and/or be substantially free of formaldehyde and/or have a Lab color spacing of “L” in a range from about 34 to about 89, “a” in a range from about 18 to about 83, and “b” in a range from about −61 to about 56, based on the International Commission of Illumination LAB color space model.

The colorant may be a colorant from Greenville Colorants (New Brunswick, NJ) or Milliken & Company (Spartanburg, SC). For example, the colorant is a colorant that is compatible for use with the fire retardant salts described herein, such as colorants used in magnesium chloride dust-control and road-stabilization formulations, or in magnesium chloride de-icing formulations. The colorant may be Elcomine Scarlet NAS, Elcomine Scarlaet NAS EX, or Iron Oxide GC-110P from Greenville Colorants. The colorant may be a combination of Liquitint 564 and Iron Oxide GC-110P.

The colorant of the composition 200 may be a dye or include encapsulated-dye fugitive pigments without ultraviolet absorbers. Compared to water soluble dyes, encapsulated-dye pigments are less likely to permanently stain the normal vegetation and/or ground in the drop zone. The fugitive component is present in an amount which provides a color (second hues) to the forest fire retardant composition 200 which is contrasts with the color of the vegetation and/or ground in the drop zone (normally green, blue-green and/or brown). Advantageously, the second hue is red, orange or pink. The color of the dye may be red, orange, purple, or pink or any combination of the four. Preferably, the dye is one that is compatible with the fire retardant salts described herein. Alternatively, the composition 200 may be colorless if no colorant is added.

The colorant may also include a non-fugitive component, i.e., a component which is insoluble in the carrier liquid and which, if colored, does not necessarily fade after aerial application of the forest fire retardant composition 200. The non-fugitive component of the colorant is present in an amount sufficient to improve the aerial visibility of the composition when it is first applied to the vegetation. However, the non-fugitive component is present in less than an amount which prevents the composition from thereafter fading a neutral color. The colorant may be a combination of the fugitive and non-fugitive components. The non-fugitive component in the forest fire retardant composition 200 may be iron oxide (Fe₂O₃ and/or Fe₃O₄).

The iron oxide may be present in combination with the fugitive colorant described above and titanium dioxide or it may be present alone. The weight of the non-fugitive colorant may contain a minimum of at least 12 grams of the non-fugitive colorant in accordance with Specification 5100-304d (Jan. 7, 2020, amended May 6, 2021), which is hereby incorporated by reference in its entirety.

The weight percent of colorant (e.g., fluorescent pigment and/or dye), relative to the total weight of the liquid concentrate dispersion 201 is about 0.02% to about 6.0%, preferably about 0.04% to about 5.5%, more preferably about 0.06% to about 5.0%, and particularly about 0.08% to about 4.5%.

The weight percent of colorant (e.g., fluorescent pigment and/or dye), relative to the total weight of the final diluted product 202 is about 0.02% to about 6.0%, preferably about 0.04% to about 5.5%, more preferably about 0.06% to about 5.0%, and particularly about 0.08% to about 4.5%.

The composition 200 may also include an inorganic pigment. The inorganic pigment may act as a colorant. The inorganic pigment may include but is not limited to Iron Oxide, titanium dioxide, magnesium hydroxide, cobalt blue, cerulean blue, malachite, earth green, raw umber, raw sienna, iron black, or burnt sienna. The Iron Oxide may act as an opacifier. The titanium dioxide may act as a pigment, for example, to provide a white pigment. The titanium dioxide may also act as a photo-responsive material to create opacity by scattering light or by protecting the components of the forest fire retardant composition 200 from UV degradation.

In the liquid concentrate dispersion 201, the weight percent of the inorganic pigment relative to the total weight of the liquid concentrate dispersion 201 is about 0.002% to about 3.5%, preferably about 0.005% to about 3.0%, more preferably about 0.008% to about 2.5%, and particularly about 0.01% to about 2.0%.

In the final diluted product 202, the weight percent of the inorganic pigment relative to the total weight of the final diluted product 202 is about 0.005% to about 3.5%, preferably about 0.01% to about 3.0%, more preferably about 0.02% to about 2.5%, and particularly about 0.03% to about 2.0%.

In the liquid concentrate dispersion 201, the weight percent of the total colorant relative to the total weight of the liquid concentrate dispersion 201 is about 0.01% to about 7.0%, preferably about 0.02% to about 6.5%, more preferably about 0.04% to about 6.0%, and particularly about 0.06% to about 5.5%.

In the final diluted product 202, the weight percent of the total colorant relative to the total weight of the final diluted product 202 is about 0.02% to about 5.0%, preferably about 0.04% to about 4.5%, more preferably about 0.06% to about 4.0%, and particularly about 0.08% to about 3.5%.

The composition 200 may also include a glow-in-the-dark additive. The glow-in-the-dark additive improves the visibility of the fire retardant composition during periods of darkness. Nighttime visibility of the composition is improved, for example, to the naked human eye and/or using imaging equipment such as goggles. The glow-in-the-dark additive may include one or more of a fluorescent or phosphorescent material. The glow-in-the-dark additive can include one or more phosphorescent additives that imparts photoluminescence properties to the forest fire retardant composition 200. The phosphorescent additive may exhibit fluorescence and/or phosphorescence. The phosphorescent additive may be charged with sunlight or artificial lighting, such as UV radiation or Fluorescent lighting. The phosphorescent additive may emit light in the visible light region or in the ultraviolet region. Alternatively, the phosphorescent additive may emit light in the near infrared region and be visualized using infrared goggles. Examples of the phosphorescent additive include LumiNova, LumiNova Green (G), LumiNova G PS-2, LumiNova Blue Green (BG), a zinc sulfide pigment, doped zinc oxide, doped calcium sulfide, strontium aluminate, or mixtures thereof. The amount of the glow-in-the-dark additive, relative to the amount of composition 200 is about 100 g/1000 L to about 1000 g/1000 L, preferably about 200 g/1000 L to about 800 g/1000 L, and more preferably about 300 g/1000 L to about 700 g/1000 L. For example, the amount of the glow-in-the-dark additive, relative to the amount of composition 200 is about 350 g/1000 L to about 550 g/1000 L.

The glow-in the-dark additive may also include one or more fluorophores. The fluorophore(s) may exhibit fluorescence and/or phosphorescence. The fluorophore(s) may be visible in the near infrared region (i.e., 700 nm-1700 nm wavelength of light). Visualization can be achieved using near infrared goggles. Examples of fluorophores include CH1055 (4.8-Bis(2-(4-(bis(4-(2-carboxyethyl)phenyl)amino)phenyl)-5H-[1,2,5]thiadiazolo[3,4-f]benzo[c][1,2,5]thiadiazole), as well as Cy7 or Cy7.5, or mixtures thereof. Glow-in-the-dark additives that exhibit fluorescence include fluorescent pigments described above.

The composition 200 may optionally include other ingredients, such as spoilage inhibitors, anti-caking agents, flow conditioners, anti-foaming agents, foaming agents, stability additives, biocide, thickening agents, surfactants, adjuvants, corrosion inhibitors other than those of the corrosion inhibiting system, opacifiers, additional coloring agents, liquid carrier, dedusters, and water. The deduster may include an oil, for example mineral oil.

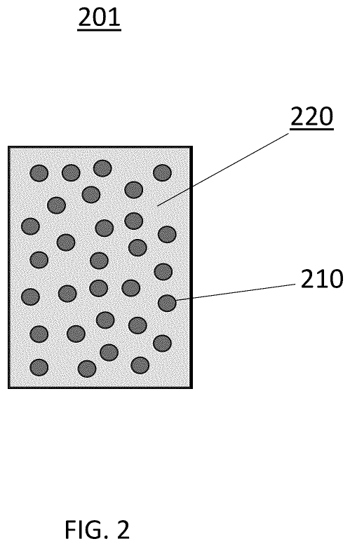

Referring to FIG. 2, the composition 200 may begin as a liquid concentrate dispersion 201. The liquid concentrate dispersion 201 may contain more than one phase, including at least one dispersed phase 210 and at least one dispersion medium 220. The liquid concentrate dispersion 201 may form a heterogeneous system made up of the dispersed phase 210 and the dispersion medium 220. As used herein, a “liquid concentrate dispersion,” when referring to the liquid concentrate dispersion 201, refers to a liquid concentrate dispersion 201 in which distributed particles of one or more components of the composition 200 are scattered (e.g., dispersed) in a continuous phase of another material (i.e., the dispersion medium 220). Also as used herein, “dispersed phase,” when referring to the liquid concentrate dispersion 201, refers to the one or more components of the composition 200 that are uniformly or non-uniformly distributed in a medium (i.e., the dispersion medium 220) in the form of colloidal particles, solid particles, droplets, or bubbles. Also as used herein, “dispersion medium,” when referring to the liquid concentrate dispersion 201, refers to the medium in which the “dispersed phase” is distributed. The liquid concentrate dispersion 201 may be in the form of a suspension and/or colloid.

In one embodiment, the dispersed phase 210 may include one or more components of the composition 200. For example, dispersed phase 210 may include, but is not limited to, the retardant compound(s), the corrosion inhibitor(s), the thickening agent(s), the polysaccharide gum, the first thickening agent, the second thickening agent, the buffering agent(s), the surfactant(s), the adjuvant(s), the colorant (e.g., a dye and/or fluorescent pigment), the inorganic pigment, the glow-in-the-dark additive, the spoilage inhibitor(s), the flow conditioner(s), the anti-foaming agent(s), the foaming agent(s), the stability additive(s), the biocide, the opacifier(s), and/or the liquid carrier. In one embodiment, the dispersed phase 210 includes the retardant compound(s), a first thickening agent, the colorant(s), and the inorganic pigment(s). In another embodiment, the dispersed phase 210 includes the retardant compound(s), a first thickening agent, the colorant(s) (e.g., a dye and/or fluorescent pigment), and the inorganic pigment. In yet another embodiment, the dispersed phase 210 includes the retardant compound(s).

The one or more components of the composition 200 may be placed in the dispersion medium 220 at a concentration above their solubility limit in the dispersion medium 220. As a result, the dispersed phase 210 may include one or more components of the composition 200 that are phase separated from the dispersion medium 220. The one or more components of the composition 200 that make up the dispersed phase 210 may be distributed in the dispersion medium 220 in the form of colloidal particles, solid particles, droplets, and/or bubbles. Preferably, the one or more components of the composition 200 that make up the dispersed phase 210 are substantially not dissolved in the dispersion medium 220. As used herein, “substantially not dissolved,” when referring to one or more components of the composition 200 that make up the dispersed phase 210, refers to a component(s) of the composition 200 that is less than 25% by weight dissolved in the dispersion medium 220. For example, the dispersed phase 210 may include one or more components of the composition 200 that are less than 20% by weight dissolved, less than 18% by weight dissolved, less than 15% by weight dissolved, less than 12% by weight dissolved, less than 10% by weight dissolved, less than 8% by weight dissolved, less than 5% by weight dissolved, less than 2% by weight dissolved, less than 1% by weight dissolved, less than 0.5% by weight dissolved, less than 0.1% by weight dissolved, or less than 0.01% by weight dissolved in the dispersion medium 220, including all values in between.

In another embodiment, one or more components of the composition 200 may be substantially dissolved in the dispersion medium 220. For example, the one or more components of the composition 200 that may be substantially dissolved in the dispersion medium 220 may include, but is not limited to, the retardant compound(s), the corrosion inhibitor(s), the thickening agent(s), the polysaccharide gum, the first thickening agent, the second thickening agent, the buffering agent(s), the surfactant(s), the adjuvant(s), the colorant(s) (e.g., a dye and/or fluorescent pigment), the inorganic pigment, the glow-in-the-dark additive, the spoilage inhibitor(s), the flow conditioner(s), the anti-foaming agent(s), the foaming agent(s), the stability additive(s), the biocide, the opacifier(s), and/or the liquid carrier. In one embodiment, the second thickening agent, the buffering agent(s), the surfactant(s), the adjuvant(s), the glow-in-the-dark additive, the spoilage inhibitor(s), the flow conditioner(s), the anti-foaming agent(s), the foaming agent(s), the stability additive(s), the biocide, the opacifier(s), the liquid carrier, and/or the deduster may be substantially dissolved in the dispersion medium 220.

The one or more components of the composition 200 may be soluble in the dispersion medium 220. The one or more components of the composition 200 may be placed in the dispersion medium 220 at a concentration below their solubility limit in the dispersion medium 220. As a result, the dispersion medium 220 and the one or more components of the composition 200 that are substantially dissolved in the dispersion medium 220 may form a homogeneous mixture in which the dispersed phase 210 is dispersed in. As used herein “substantially dissolved,” when referring to one or more components of the composition 200 that are contained in the dispersion medium 220, refers to a component(s) of the composition 200 that is greater than 25% by weight dissolved in the dispersion medium 220. For example, the dispersion medium 220 may include one or more components of the composition 200 that are greater than 27% by weight dissolved, greater than 29% by weight dissolved, greater than 30% by weight dissolved, greater than 40% by weight dissolved, greater than 50% by weight dissolved, greater than 60% by weight dissolved, greater than 70% by weight dissolved, greater than 90% by weight dissolved, and/or 100% by weight dissolved in the dispersion medium 220, including all values in between.

The dispersion medium 220 may include water or another liquid. Preferably the dispersion medium 220 is a non-aqueous liquid. For example, the dispersion medium 220 may include, but is not limited to, ethylene glycol, polyethylene glycol (PEG), PEG-400 (e.g., a low-molecular-weight grade of polyethylene glycol), di(propylene glycol) methyl ether (DPG-ME), tripropylene glycol methyl ether (TPG-ME), hexylene glycol, triethylene glycol (TEG), triethylene glycol methyl ether (TEG-ME), diethylene glycol monoethyl ether (DEG-EE), glycerol, propylene glycol (PG), polypropylene glycol, propylene carbonate, 1,3 propanediol, a polyol, and/or a glycol ether, and combinations thereof. Alternatively, the dispersion medium 220 may be an aqueous liquid. For example, the dispersion medium 220 may be water. The water may be tap water or water from other convenient water sources. In one embodiment, the dispersion medium 220 may be water. The dispersed phase 210 may include a fire retardant that is substantially not soluble in water, magnesium hydroxide or calcium carbonate. for example, magnesium hydroxide or calcium carbonate. In this embodiment, the fire retardant may also be present in the final diluted product 202 in a dispersed phase 210.

In another embodiment, the dispersion medium 220 may be a mixture of an aqueous liquid and a non-aqueous liquid. In the dispersion medium 220, the weight percent of the aqueous liquid:non-aqueous liquid may be about 0%:100% to about 100%:0%, including about 5%:95%, 10%:90%, 15%:85%, 20%:80%, 25%:75%, 30%:70%, 35%:65%, 40%:60%, 45%:55%, 50%:50%, 55%:45%, 60%:40%, 65%:35%, 70%:30%, 75%:25%, 80%:20%, 85%:15%, 90%:10%, 95%:5%, and any range between any two such ratios.

In the liquid concentrate dispersion 201, the weight percent of the dispersion medium 220 relative to the total weight of the liquid concentrate dispersion 201 is about 1% to about 60%, preferably about 2% to about 55%, more preferably about 3% to about 50%, and particularly about 4% to about 45%.

In the final diluted product 202, the weight percent of the dispersion medium 220 relative to the total weight of the final diluted product 202 is about 0.5% to about 30%, preferably about 0.75% to about 25%, more preferably about 1% to about 20%, and particularly about 1.5% to about 15%.

Instead of (or in addition to), the one or more thickening agents described above, the dispersion medium 220 may also help control the viscosity of the liquid concentrate dispersion 201 and/or composition 200. For example, PEG-400 may provide a liquid concentrate dispersion 201 viscosity of approximately 2620 cP, PG may provide a liquid concentrate dispersion 201 viscosity of approximately 1460 cP, TPG-ME may provide a liquid concentrate dispersion 201 viscosity of approximately 650 cP, and DEG-EE may provide a liquid concentrate dispersion 201 viscosity of approximately 287.5 cP. In another embodiment, a mixture of dispersion mediums 220 may be used to help control the viscosity of the liquid concentrate dispersion 201 and/or composition 200. The dispersion medium 220 may include a mixture of two or more of the dispersion mediums 220 disclosed herein. For example, the dispersion medium 220 may include a mixture of glycerol and PG, which may provide a liquid concentrate dispersion 201 viscosity of approximately 1600 cP to approximately 5000 cP.

Instead of (or in addition to), the one or more thickening agents described above and/or the dispersion medium 220, the size of the colloidal particles, solid particles, droplets, and/or bubbles in the dispersed phase 210 may also help control the viscosity and/or stability of the liquid concentrate dispersion 201 and/or composition 200. For example, the size of the one or more components of liquid concentrate dispersion 201 in the dispersed phase 210 may be about 0.01 mm, about 0.05 mm, about 0.1 mm, about 0.2 mm, about 0.3 mm, about 0.5 mm, about 0.6 mm. about 0.7 mm, about 0.8 mm, about 0.9 mm, about 1.0 mm, about 1.5 mm, about 2.0 mm, about 2.5 mm, about 3.0 mm, or about 3.5 mm. The size of the one or more components of liquid concentrate dispersion 201 in the dispersed phase 210 may also be referred to using mesh sizes. For example, the size of the one or more components of liquid concentrate dispersion 201 in the dispersed phase 210 may be about 3 mesh, about 4 mesh, about 5 mesh, about 6 mesh, about 7 mesh, about 8 mesh, about 10 mesh, about 12 mesh, about 14 mesh, about 16 mesh, about 18 mesh, about 20 mesh, about 25 mesh, about 30 mesh, about 35 mesh, about 40 mesh, about 45 mesh, about 50 mesh, about 60 mesh, about 70 mesh, about 80 mesh, about 100 mesh, about 120 mesh, about 140 mesh, about 170 mesh, about 200 mesh, about 230 mesh, about 270 mesh, about 325 mesh, or about 400 mesh.

Decreasing the size of the particles in the in the dispersed phase 210 (e.g., by grinding the one or more components of the composition 200 present in the liquid concentrate dispersion 201 in the dispersed phase 210) may increase the viscosity and/or stability of the liquid concentrate dispersion 201. For example, a dispersed phase 210 with a mixture of particle sizes may provide a liquid concentrate dispersion 201 viscosity of about 700 cP to about 800 cP, a dispersed phase 210 with a particle size of about 0.4 mm (e.g., about 40 mesh) to about 0.25 mm (e.g., about 60 mesh) may provide a liquid concentrate dispersion 201 viscosity of about 800 cP to about 900 cP, a dispersed phase 210 with a particle size of about 0.25 mm (e.g., about 60 mesh) to about 0.17 mm (e.g., about 80 mesh) may provide a liquid concentrate dispersion 201 viscosity of about 1400 cP to about 1500 cP, and a dispersed phase 210 with a particle size of about 0.15 mm (e.g., about 100 mesh) or less may provide a liquid concentrate dispersion 201 viscosity of about 2200 cP to about 2300 cP.

In one embodiment, the viscosity of the liquid concentrate dispersion 201 may be moderate to maintain a homogenous mixture. For example, the viscosity of the liquid concentrate dispersion 201 may be about 150 cP to about 2500 cP, preferably about 200 cP to about 1,500 cP. If the viscosity of the liquid concentrate dispersion 201 is too low (e.g., less than about 10 cP), the dispersed phase 210 may separate from the dispersion medium 220. In contrast, if the viscosity of the liquid concentrate dispersion is too high, the liquid concentrate dispersion 201 may be difficult to pump. Preferably, the viscosity of the liquid concentrate dispersion 201 is sufficient to stabilize the formulation and prevent or reduce the formation of precipitates or syneresis. Preferably, the viscosity of the liquid concentrate dispersion 201 is not too high to impede pumping of the liquid concentrate dispersion 201 and/or make the liquid concentrate dispersion 201 susceptible to forming a gel (e.g., gelling).

In another embodiment, the dispersion medium 220 may not be sufficient to yield the desired viscosity of the composition 200. As described above, the composition 200 may also include at least one thickening agent. In one embodiment, the composition 200 may include a first thickening agent. Preferably the first thickening agent is a thickening agent that is not active (e.g., does not moderate the viscosity) in the liquid concentrate dispersion 201 but may become active in the final diluted product 202. Thus, the first thickening agent may act to adjust the viscosity of the final diluted product 202 without adjusting the viscosity of the liquid concentrate dispersion 201. For example, the first thickening agent may include, but is not limited to, a gum that does not thicken and/or dissolve in the desired dispersion medium 220.

In one embodiment, the first thickening agent may be a thickening agent that is substantially not dissolved in the dispersion medium 220 such that the first thickening agent is present in the liquid concentrate dispersion 201 in the dispersed phase 210. In this embodiment, the first thickening agent present in the dispersed phase 210 may only become active or impart viscosity to the composition 200 once the first thickening agent is hydrated with water (e.g., during the formation of the final diluted product 202).

The composition 200 may also include a second thickening agent. Preferably the second thickening agent is a thickening agent that is active (e.g., does contribute to the viscosity) in the liquid concentrate dispersion 201. The second thickening agent may also be active in the final diluted product 202. Thus, the second thickening agent may act to adjust the viscosity of the liquid concentrate dispersion 201 and/or the final diluted product 202. For example, the second thickening agent may include, but is not limited to, an inorganic material such as a clay or a silica, and/or a gum that may thicken and/or dissolve in the desired dispersion medium 220.

In one embodiment, the second thickening agent may be substantially not dissolved in the dispersion medium 220 such that second thickening agent is also present in the liquid concentrate dispersion 201 in the dispersed phase 210. In this embodiment, the second thickening agent may act to adjust the viscosity of the liquid concentrate dispersion 201 once the second thickening agent is dispersed in the dispersion medium 220. In another embodiment, the second thickening agent may be a thickening agent that is substantially dissolved in the dispersion medium 220 such that the second thickening agent is present in the liquid concentrate dispersion 201 in solution with the dispersion medium 220. In this embodiment, the second thickening agent may be active or impart viscosity to the liquid concentrate dispersion 201 once the second thickening agent is dissolved in the dispersion medium 220.

In one embodiment, the first thickening agent may be a first polysaccharide gum and the second thickening agent may be a second polysaccharide gum. The second polysaccharide gum may act to obtain the desired liquid concentrate dispersion viscosity and the a first polysaccharide gum may act to obtain the described final diluted product 202 viscosity. In another embodiment, the first thickening agent may be a polysaccharide gum and the second thickening agent may be a clay. In yet another embodiment, the first thickening agent may be a polysaccharide gum and the second thickening agent may be silica.

The liquid concentrate dispersions 201 disclosed herein may present several advantages over traditional liquid concentrates. First, the liquid concentrate dispersions 201 disclosed herein may have increased the mix ratios. In some embodiments, the liquid concentrate dispersions 201 disclosed herein may have a mix ratio that is above the solubility limit of the fire retardant in water. For example, magnesium chloride (MgCl₂) may be soluble in water to approximately 35% by weight at room temperature. However, a liquid concentrate dispersion 201 including magnesium chloride and a non-aqueous liquid may include approximately 50% by weight magnesium chloride. In contrast to water, MgCl₂ in the proper non-aqueous liquid may not salt out or form large salt crystals, as the magnesium chloride may not dissolve or be soluble in the non-aqueous liquid and instead may form a dispersion. Second, the liquid concentrate dispersions 201 disclosed herein may be less likely to form fire retardant crystals (e.g., salt crystals) due to either the solubility of the fire retardant in water and/or temperature variations in the environment. Third, the liquid concentrate dispersions 201 disclosed herein may enable the use of additional fire retardant materials that have lower solubility rates, such as magnesium sulfate (MgSO₄) which is soluble up to approximately 28% by weight, and thus traditionally are not ideal for a liquid concentrate fire retardant since the salt concentration in the liquid concentrate may have a low mix ratio.

Finally, the use of non-aqueous liquids as a dispersion medium may also enable higher dilution factors by limiting the viscosity of water-soluble thickeners. In typical aqueous liquid concentrates, the concentrate may have a high thickener concentration to ensure the proper viscosity of the final diluted product after the liquid concentrate is diluted with water. However, as would be appreciated by one of ordinary skill in the art, viscosity is not linear with concentration of thickener. Therefore, typical aqueous liquid concentrates may have much higher viscosities. However, a thickening agent may not impart viscosity to a solution unless the thickening agent is dissolved in the solution and in order for the thickening agent to dissolve in solution, the solution may need to be substantially aqueous in nature. Thus, for the liquid concentrate dispersions 201 disclosed herein wherein the dispersion medium 220 is a non-aqueous liquid, there may be no substantial viscosity added from dissolving, dispersing, or suspending a thickening agent in the non-aqueous dispersion medium 220. As a result, the liquid concentrate dispersions 201 disclosed herein may allow for lower viscosities than traditional liquid concentrates. The liquid concentrate dispersions 201 disclosed herein may also enable the production of a final diluted product 202 with a viscosity higher than that of the liquid concentrate dispersion 201. Traditional aqueous liquid concentrates typically lead to low viscosity (e.g., about 150 cP to about 400 cP) long-term retardants. However, the liquid concentrate dispersions 201 disclosed herein may lead to medium viscosity (e.g., about 401 cP to about 800 cP) or high viscosity (e.g., about 801 cP to about 1500 cP, or higher) final diluted product 202(s).

### Forming the Liquid Concentrate Dispersion 201

The components of the forest fire retardant composition 200 are batch mixed to form a liquid concentrate dispersion 201. Alternatively, the forest fire retardant composition 200 may be mixed using continuous mixing equipment. Prior to mixing, one or more of the components of the forest fire retardant composition 200 may be ground down to reduce particle size. The mixing should be controlled to ensure that all of the dry components are adequately dispersed in the dispersion medium 220. The liquid concentrate dispersion 201 is chemically stable under normal temperatures and pressures. Once mixed, the liquid concentrate dispersion 201 is then stored, substantially in the absence of air and/or external moisture, in a sealed container. The liquid concentrate dispersion 201 should be protected from exposure to humidity and moisture. For example, the sealed container for storage and shipment to the point of use (e.g., airfield) may be a 1,000 L tote, a 5-gallon pail or a 55-gallon drum. The liquid concentrate dispersion 201 is chemically stable under normal temperatures and pressures. The liquid concentrate dispersion 201 may be a low, medium, or high viscosity liquid concentrate dispersion 201. The viscosity may be in the range of 150-400 cP, 401 cP to 800 cP, or >801 cP, for a low, medium, or high viscosity liquid concentrate dispersion 201, respectively.

The liquid concentrate dispersion 201 may be supplied as part of a kit that includes a sealed container for storage and shipment, substantially in the absence of air and/or external moisture, (e.g., 1,000 L tote, a 5-gallon pail or a 55-gallon drum) and instructions for using the liquid concentrate dispersion 201 to form the final diluted product 202 (described below). Air-sealed bags with a plastic liner supplied by Semi-Bulk Systems Inc. (St. Louis, MO) can be used. Alternatively, an air-permeable moisture barrier can be used, such as a barrier made of a silicone material. In the case where the final diluted product 202 is to be applied on a localized scale by homeowners or local officials, for example, the kit may contain a tank for mixing and applying the final diluted product 202 (e.g., a 1-2 gallon hand-held or 4 gallon backpack or 5 gallon cart-style container with an applicator wand and/or hose, or a 15-25 gallon tank capable of being mounted on or pulled behind an all-terrain vehicle or truck), and instructions for using the liquid concentrate dispersion 201 to form and apply the final diluted product 202.

### Forming the Final Diluted Product 202

The final diluted product 202 is formed by mixing the liquid concentrate dispersion 201 with water. The liquid concentrate dispersion 201 is shipped to the point of use (e.g., airfield), where it is diluted with water or other solvent to form the final diluted product 202. The water may be tap water or water from other convenient water sources. The product is mixed using the current mixing equipment available to the USFS. The liquid concentrate dispersion 201 is very miscible in water and special mixing precautions are not necessary other than to limit splash escaping the mixing vessel. The tank contents should be circulated via a centrifugal pump or another stirring means to ensure uniform mixing. Upon mixing the liquid concentrate dispersion 201 with water to form the final diluted product 202, the dispersed phase 210 may be substantially dissolved in water such that the final diluted product 202 is a homogeneous mixture.

The product is stirred for about 20-30 minutes before being allowed to stand to develop a stable viscosity and ensure a uniform mixture. The final diluted product 202 can also be prepared on a commercial batch scale by combining the liquid concentrate dispersion 201 with a measured amount of water in an appropriate mix vessel such as an agitated mix tank.

Alternatively, the final diluted composition 202 may be prepared on a commercial batch scale using continuous mixing equipment. The rate of addition of liquid concentrate to water should be controlled to assure efficient mixing of the concentrate and the water. The final diluted product 202 forms a stable solution and/or suspension and should be stirred after standing to eliminate any settling of the components.

The final diluted composition 202 can also be batch mixed by feeding the liquid concentrate dispersion 201 into a well-circulated mix-batch tank. Alternatively, the final diluted composition 202 may be mixed using continuous mixing equipment. Mix tank agitation may be provided via an overhead mechanical stirring apparatus or alternatively by a circulation pump sized to provide turbulent mixing. Alternatively, a venturi-type vacuum eductor mixer or an in-line high-shear mixer can be used. The final diluted product 202 is in a form suitable to fight forest fires via aerial- or ground-based application.

The final diluted product 202 is a long-term forest fire retardant with improved aerial visibility for either a direct or indirect attack. The resulting final diluted product 202 is an opaque pink or red-purple solution and/or suspension that resists settling. The final diluted product 202 should be mixed approximately every 7-10 days to ensure uniform density. The viscosity of the final diluted product 202 can be adjusted to accommodate a variety of aircrafts by adjusting the amounts of thickening agent(s) added to the mixture. The final diluted product 202 may be a low, medium, or high viscosity long term retardant. The viscosity may be in the range of 150-400 cP, 401 cP to 800 cP, or >801 cP, for a low, medium, or high viscosity long term retardant, respectively. Once blended with water, the final diluted product 202 is a homogeneous, stable fluid that requires only infrequent stirring. The final diluted product 202 is hydrated into a stable mixture in 20 minutes, without the use of special equipment.

### EXAMPLES

### Example 1

In Example 1, a liquid concentrate dispersion was prepared containing the amounts of ingredients listed in Table 2 below. The values in Table 2 can be varied by ±0.01%, or ±0.05%, or ±0.1%, or ±0.5%, or ±1.0%, or ±1.5%, or ±2%, or ±2.5%, or ±3.0%, or ±3.5%, or ±4.0%, or ±4.5%, or ±5.0%. The viscosity of the liquid concentrate dispersion 201 of Example 1 may be in the range of about 2200 cP to about 3000 cP, for example about 2620 cP.

TABLE 2
Dry Concentrate according to Example 1

| | Weight Percent of |
|---|---|
| | Each Ingredient in |
| Ingredient | Dry Concentrate |
| DAP | 90.44% |
| Mineral Oil | 0.85% |
| Corrosion Inhibitor (approximately 40% | 3.41% |
| water) | |
| Thickening agent 1-Polysaccharide | 2.56% |
| gum | |
| Red Iron Oxide | 0.17% |
| Fluorescent Pigment | 1.71% |
| Surfactant | 0.85% |
| Water | 0.00% |
| Total Weight of Dry Concentrate | 100% |

In Example 1, the final diluted product 202 was prepared by mixing approximately 5.5 gallons of water with 1 gallon of the liquid concentrate dispersion. The amounts of the ingredients in the Example 1 final diluted product 202 are listed in Table 3 below. The values in Table 3 can be varied by ±0.01%, or ±0.05%, or ±0.1%, or ±0.5%, or ±1.0%, or ±1.5%, or ±2%, or ±2.5%, or ±3.0%, or ±3.5%, or ±4.0%, or ±4.5%, or ±5.0%. The concentration of salt in the Example 1 final diluted product 202 is about 5% to 20% by weight in water, preferably about 6% to 18%, more preferably about 7% to 16%. For example, the weight percent of salt in the Example 1 final diluted product 202 is about 10.3%±1.0%.

TABLE 3
Final Diluted Product according to Example 1

| | Weight Percent of |
|---|---|
| | Each Ingredient in |
| | Final Diluted |
| Ingredient | Product |
| DAP | 10.60% |
| Mineral Oil | 0.10% |
| Corrosion Inhibitor (approximately 40% | 0.40% |
| water) | |
| Thickening agent 1-Polysaccharide | 0.30% |
| gum | |
| Red Iron Oxide | 0.02% |
| Fluorescent Pigment | 0.20% |
| Surfactant | 0.10% |
| Water | 88.28% |
| Total Weight of Final Diluted Product | 100% |

The density of the final diluted product 202 of Example 1 may be in the range of about 0.8 g/mL to about 1.3 g/mL, for example about 1.0 g/mL to about 1.2 g/mL. The pH of the final diluted product 202 of Example 1 may be in the range of about 6.0 to about 7.0, for example about 6.4. The N/P molar ratio of the final diluted product 202 of Example 1 may be in the range of about 1.0 to about 2.0, for example about 1.4. The viscosity of the final diluted product 202 of Example 1 may be in the range of about 200 cP to about 300 cP, for example about 225 cP.

### Example 2

In Example 2, a liquid concentrate dispersion was prepared containing the amounts of ingredients listed in Table 4 below. The values in Table 4 can be varied by ±0.01%, or ±0.05%, or ±0.1%, or ±0.5%, or ±1.0%, or ±1.5%, or ±2%, or ±2.5%, or ±3.0%, or ±3.5%, or ±4.0%, or ±4.5%, or ±5.0%. The viscosity of the liquid concentrate dispersion 201 of Example 2 may be in the range of about 600 cP to about 1000 cP, for example about 796 cP.

TABLE 4
Dry Concentrate according to Example 2

| | Weight Percent of |
|---|---|
| | Each Ingredient in |
| Ingredient | Dry Concentrate |
| DAP | 92.56% |
| Mineral Oil | 0.44% |
| Corrosion Inhibitor (approximately 40% | 0.44% |
| water) | |
| Thickening agent 1-Polysaccharide | 3.06% |
| gum | |
| Red Iron Oxide | 0.31% |
| Fluorescent Pigment | 3.06% |
| Surfactant | 0.15% |
| Water | 0.00% |
| Total Weight of Dry Concentrate | 100% |

In Example 2, the final diluted product 202 was prepared by mixing approximately 5.0 gallons of water with 1 gallon of the liquid concentrate dispersion. The amounts of the ingredients in the Example 2 final diluted product 202 are listed in Table 5 below. The values in Table 5 can be varied by ±0.01%, or ±0.05%, or ±0.1%, or ±0.5%, or ±1.0%, or ±1.5%, or ±2%, or ±2.5%, or ±3.0%, or ±3.5%, or ±4.0%, or ±4.5%, or ±5.0%. The concentration of salt in the Example 2 final diluted product 202 is about 5% to 20% by weight in water, preferably about 6% to 18%, more preferably about 7% to 16%. For example, the weight percent of salt in the Example 2 final diluted product 202 is about 10.3%±1.0%.

TABLE 5
Final Diluted Product according to Example 2

| | Weight Percent of |
|---|---|
| | Each Ingredient in |
| | Final Diluted |
| Ingredient | Product |
| DAP | 10.60% |
| Mineral Oil | 0.05% |
| Corrosion Inhibitor (approximately 40% | 0.05% |
| water) | |
| Thickening agent 1-Polysaccharide | 0.35% |
| gum | |
| Red Iron Oxide | 0.04% |
| Fluorescent Pigment | 0.35% |
| Surfactant | 0.02% |
| Water | 88.55% |
| Total Weight of Final Diluted Product | 100% |

The density of the final diluted product 202 of Example 2 may be in the range of about 0.7 g/mL to about 1.3 g/mL, for example about 0.9 g/mL to about 1.2 g/mL. The pH of the final diluted product 202 of Example 2 may be in the range of about 6.0 to about 7.0, for example about 6.4. The N/P molar ratio of the final diluted product 202 of Example 2 may be in the range of about 1.0 to about 2.0, for example about 1.4. The viscosity of the final diluted product 202 of Example 2 may be in the range of about 150 cP to about 300 cP, for example about 216 cP.

### Example 3

In Example 3, a liquid concentrate dispersion was prepared containing the amounts of ingredients listed in Table 6 below. The values in Table 6 can be varied by ±0.01%, or ±0.05%, or ±0.1%, or ±0.5%, or ±1.0%, or ±1.5%, or ±2%, or ±2.5%, or ±3.0%, or ±3.5%, or ±4.0%, or ±4.5%, or ±5.0%. The viscosity of the liquid concentrate dispersion 201 of Example 3 may be in the range of about 400 cP to about 800 cP, for example about 650 cP.

TABLE 6
Dry Concentrate according to Example 3

| | Weight Percent of |
|---|---|
| | Each Ingredient in |
| Ingredient | Dry Concentrate |
| DAP | 92.36% |
| Mineral Oil | 0.44% |
| Corrosion Inhibitor (approximately 40% | 0.65% |
| water) | |
| Thickening agent 1-Polysaccharide | 3.05% |
| gum | |
| Red Iron Oxide | 0.30% |
| Fluorescent Pigment | 3.05% |
| Surfactant | 0.15% |
| Water | 0.00% |
| Total Weight of Dry Concentrate | 100% |

In Example 3, the final diluted product 202 was prepared by mixing approximately 5.1 gallons of water with 1 gallon of the liquid concentrate dispersion. The amounts of the ingredients in the Example 3 final diluted product 202 are listed in Table 7 below. The values in Table 7 can be varied by ±0.01%, or ±0.05%, or ±0.1%, or ±0.5%, or ±1.0%, or ±1.5%, or ±2%, or ±2.5%, or ±3.0%, or ±3.5%, or ±4.0%, or ±4.5%, or ±5.0%. The concentration of salt in the Example 3 final diluted product 202 is about 5% to 20% by weight in water, preferably about 6% to 18%, more preferably about 7% to 16%. For example, the weight percent of salt in the Example 3 final diluted product 202 is about 10.3%±1.0%.

TABLE 7
Final Diluted Product according to Example 3

| | Weight Percent of |
|---|---|
| | Each Ingredient in |
| | Final Diluted |
| Ingredient | Product |
| DAP | 10.600% |
| Mineral Oil | 0.050% |
| Corrosion Inhibitor (approximately 40% | 0.075% |
| water) | |
| Thickening agent 1-Polysaccharide | 0.350% |
| gum | |
| Red Iron Oxide | 0.035% |
| Fluorescent Pigment | 0.350% |
| Surfactant | 0.017% |
| Water | 88.523% |
| Total Weight of Final Diluted Product | 100% |

The density of the final diluted product 202 of Example 3 may be in the range of about 0.8 g/mL to about 1.5 g/mL, for example about 1.0 g/mL to about 1.4 g/mL. The pH of the final diluted product 202 of Example 3 may be in the range of about 6.5 to about 7.5, for example about 6.8. The N/P molar ratio of the final diluted product 202 of Example 3 may be in the range of about 1.0 to about 2.0, for example about 1.4. The viscosity of the final diluted product 202 of Example 3 may be in the range of about 150 cP to about 300 cP, for example about 213 cP.

### Example 4

In Example 4, a liquid concentrate dispersion was prepared containing the amounts of ingredients listed in Table 8 below. The values in Table 8 can be varied by ±0.01%, or ±0.05%, or ±0.1%, or ±0.5%, or ±1.0%, or ±1.5%, or ±2%, or ±2.5%, or ±3.0%, or ±3.5%, or ±4.0%, or ±4.5%, or ±5.0%. The viscosity of the liquid concentrate dispersion 201 of Example 4 may be in the range of about 150 cP to about 500 cP, for example about 288 cP.

TABLE 8
Dry Concentrate according to Example 4

| | Weight Percent of |
|---|---|
| | Each Ingredient in |
| Ingredient | Dry Concentrate |
| MAP | 92.36% |
| Mineral Oil | 0.44% |
| Corrosion Inhibitor (approximately 40% | 0.65% |
| water) | |
| Thickening agent 1-Polysaccharide | 3.05% |
| gum | |
| Red Iron Oxide | 0.30% |
| Fluorescent Pigment | 3.05% |
| Surfactant | 0.15% |
| Water | 0.00% |
| Total Weight of Dry Concentrate | 100% |

In Example 4, the final diluted product 202 was prepared by mixing approximately 5.2 gallons of water with 1 gallon of the liquid concentrate dispersion. The amounts of the ingredients in the Example 4 final diluted product 202 are listed in Table 9 below. The values in Table 9 can be varied by ±0.01%, or ±0.05%, or ±0.1%, or ±0.5%, or ±1.0%, or ±1.5%, or ±2%, or ±2.5%, or ±3.0%, or ±3.5%, or ±4.0%, or ±4.5%, or ±5.0%. The concentration of salt in the Example 4 final diluted product 202 is about 5% to 20% by weight in water, preferably about 6% to 18%, more preferably about 7% to 16%. For example, the weight percent of salt in the Example 4 final diluted product 202 is about 10.3%±1.0%.

TABLE 9
Final Diluted Product according to Example 4

| | Weight Percent of |
|---|---|
| | Each Ingredient in |
| | Final Diluted |
| Ingredient | Product |
| MAP | 10.600% |
| Mineral Oil | 0.050% |
| Corrosion Inhibitor (approximately 40% | 0.075% |
| water) | |
| Thickening agent 1-Polysaccharide | 0.350% |
| gum | |
| Red Iron Oxide | 0.035% |
| Fluorescent Pigment | 0.350% |
| Surfactant | 0.017% |
| Water | 88.523% |
| Total Weight of Final Diluted Product | 100% |

The density of the final diluted product 202 of Example 4 may be in the range of about 0.7 g/mL to about 1.4 g/mL, for example about 0.9 g/mL to about 1.2 g/mL. The pH of the final diluted product 202 of Example 4 may be in the range of about 6.0 to about 7.0, for example about 6.4. The N/P molar ratio of the final diluted product 202 of Example 4 may be in the range of about 1.0 to about 2.0, for example about 1.4. The viscosity of the final diluted product 202 of Example 4 may be in the range of about 150 cP to about 300 cP, for example about 211 cP.

### Example 5

In Example 5, a liquid concentrate dispersion was prepared containing the amounts of ingredients listed in Table 10 below. The values in Table 10 can be varied by ±0.01% or ±0.05%, or ±0.1% or ±0.5%,or ±1.0%,or ±1.5%,or ±2%,or ±2.5%, or ±3.0%, or ±3.5%, or ±4.0%, or ±4.5%, or ±5.0%. The viscosity of the liquid concentrate dispersion 201 of Example 5 may be in the range of about 300 cP to about 800 cP, for example about 492 cP.

TABLE 10
Dry Concentrate according to Example 5

| | Weight Percent of |
|---|---|
| | Each Ingredient in |
| Ingredient | Dry Concentrate |
| MAP | 69.69% |
| Mineral Oil | 0.38% |
| Corrosion Inhibitor (approximately 40% | 0.38% |
| water) | |
| Buffering Agent | 24.23% |
| Thickening agent 1-Polysaccharide | 2.27% |
| gum | |
| Red Iron Oxide | 0.27% |
| Fluorescent Pigment | 2.65% |
| Surfactant | 0.13% |
| Water | 0.00% |
| Total Weight of Dry Concentrate | 100% |

In Example 5, the final diluted product 202 was prepared by mixing approximately 5.4 gallons of water with 1 gallon of the liquid concentrate dispersion. The amounts of the ingredients in the Example 5 final diluted product 202 are listed in Table 11 below. The values in Table 11 can be varied by ±0.01%, or ±0.05%, or ±0.1%, or ±0.5%, or ±1.0%, or ±1.5%, or ±2%, or ±2.5%, or ±3.0%, or ±3.5%, or ±4.0%, or ±4.5%, or ±5.0%. The concentration of salt in the Example 5 final diluted product 202 is about 5% to 20% by weight in water, preferably about 6% to 18%, more preferably about 7% to 16%. For example, the weight percent of salt in the Example 5 final diluted product 202 is about 10.3%±1.0%.

TABLE 11
Final Diluted Product according to Example 5

| | Weight Percent of |
|---|---|
| | Each Ingredient in |
| | Final Diluted |
| Ingredient | Product |
| MAP | 9.200% |
| Mineral Oil | 0.050% |
| Corrosion Inhibitor (approximately 40% | 0.050% |
| water) | |
| Buffering Agent | 3.199% |
| Thickening agent 1-Polysaccharide | 0.300% |
| gum | |
| Red Iron Oxide | 0.035% |
| Fluorescent Pigment | 0.350% |
| Surfactant | 0.017% |
| Water | 86.799% |
| Total Weight of Final Diluted Product | 100% |

The density of the final diluted product 202 of Example 5 may be in the range of about 0.7 g/mL to about 1.4 g/mL, for example about 0.9 g/mL to about 1.2 g/mL. The pH of the final diluted product 202 of Example 5 may be in the range of about 6.0 to about 7.0, for example about 6.4. The N/P molar ratio of the final diluted product 202 of Example 5 may be in the range of about 1.0 to about 2.0, for example about 1.4. The viscosity of the final diluted product 202 of Example 5 may be in the range of about 150 cP to about 300 cP, for example about 216 cP.

### Example 6

In Example 6, a liquid concentrate dispersion was prepared containing the amounts of ingredients listed in Table 12 below. The values in Table 12 can be varied by ±0.01% or ±0.05%, or ±0.1% or ±0.5%,or ±1.0%,or ±1.5%,or ±2%,or ±2.5%, or ±3.0%, or ±3.5%, or ±4.0%, or ±4.5%, or ±5.0%. The viscosity of the liquid concentrate dispersion 201 of Example 6 may be in the range of about 150 cP to about 500 cP, for example about 373 cP.

TABLE 12
Dry Concentrate according to Example 6

| | Weight Percent of |
|---|---|
| | Each Ingredient in |
| Ingredient | Dry Concentrate |
| SAP-TH | 95.05% |
| Mineral Oil | 0.28% |
| Corrosion Inhibitor (approximately 40% | 0.42% |
| water) | |
| Thickening agent 1-Polysaccharide | 1.97% |
| gum | |
| Red Iron Oxide | 0.20% |
| Fluorescent Pigment | 1.97% |
| Surfactant | 0.10% |
| Water | 0.00% |
| Total Weight of Dry Concentrate | 100% |

In Example 6, the final diluted product 202 was prepared by mixing approximately 5.1 gallons of water with 1 gallon of the liquid concentrate dispersion. The amounts of the ingredients in the Example 6 final diluted product 202 are listed in Table 13 below. The values in Table 13 can be varied by ±0.01%, or ±0.05%, or ±0.1%, or ±0.5%, or ±1.0%, or ±1.5%, or ±2%, or ±2.5%, or ±3.0%, or ±3.5%, or ±4.0%, or ±4.5%, or ±5.0%. The concentration of salt in the Example 6 final diluted product 202 is about 5% to 20% by weight in water, preferably about 6% to 18%, more preferably about 7% to 16%. For example, the weight percent of salt in the Example 6 final diluted product 202 is about 10.3%±1.0%.

TABLE 13
Final Diluted Product according to Example 6

| | Weight Percent of |
|---|---|
| | Each Ingredient in |
| | Final Diluted |
| Ingredient | Product |
| SAP-TH | 16.850% |
| Mineral Oil | 0.050% |
| Corrosion Inhibitor (approximately 40% | 0.075% |
| water) | |
| Thickening agent 1-Polysaccharide | 0.350% |
| gum | |
| Red Iron Oxide | 0.035% |
| Fluorescent Pigment | 0.350% |
| Surfactant | 0.017% |
| Water | 82.273% |
| | 16.850% |
| Total Weight of Final Diluted Product | 100% |

The density of the final diluted product 202 of Example 6 may be in the range of about 0.7 g/mL to about 1.4 g/mL, for example about 0.9 g/mL to about 1.2 g/mL. The pH of the final diluted product 202 of Example 6 may be in the range of about 6.0 to about 7.0, for example about 6.4. The N/P molar ratio of the final diluted product 202 of Example 6 may be in the range of about 1.0 to about 2.0, for example about 1.4. The viscosity of the final diluted product 202 of Example 6 may be in the range of about 150 cP to about 300 cP, for example about 231 cP.

### Example 7

In Example 7, a liquid concentrate dispersion was prepared containing the amounts of ingredients listed in Table 14 below. The values in Table 14 can be varied by ±0.01% or ±0.05%, or ±0.1% or ±0.5%,or ±1.0%,or ±1.5%,or ±2%,or ±2.5%, or ±3.0%, or ±3.5%, or ±4.0%, or ±4.5%, or ±5.0%. The viscosity of the liquid concentrate dispersion 201 of Example 7 may be in the range of about 1400 cP to about 1800 cP, for example about 1600 cP.

TABLE 14
Dry Concentrate according to Example 7

| | Weight Percent of |
|---|---|
| | Each Ingredient in |
| Ingredient | Dry Concentrate |
| DAP | 44.63% |
| DSP | 47.98% |
| Mineral Oil | 0.42% |
| Corrosion Inhibitor (approximately 40% | 0.63% |
| water) | |
| Thickening agent 1-Polysaccharide | 2.95% |
| gum | |
| Red Iron Oxide | 0.29% |
| Fluorescent Pigment | 2.95% |
| Surfactant | 0.14% |
| Water | 0.00% |
| Total Weight of Dry Concentrate | 100% |

In Example 7, the final diluted product 202 was prepared by mixing approximately 5.5 gallons of water with 1 gallon of the liquid concentrate dispersion. The amounts of the ingredients in the Example 7 final diluted product 202 are listed in Table 15 below. The values in Table 15 can be varied by ±0.01%, or ±0.05%, or ±0.1%, or ±0.5%, or ±1.0%, or ±1.5%, or ±2%, or ±2.5%, or ±3.0%, or ±3.5%, or ±4.0%, or ±4.5%, or ±5.0%. The concentration of salt in the Example 7 final diluted product 202 is about 5% to 20% by weight in water, preferably about 6% to 18%, more preferably about 7% to 16%. For example, the weight percent of salt in the Example 7 final diluted product 202 is about 10.1%±1.0%.

TABLE 15
Final Diluted Product according to Example 7

| | Weight Percent of |
|---|---|
| | Each Ingredient in |
| | Final Diluted |
| Ingredient | Product |
| DAP | 5.300% |
| DSP | 5.698% |
| Mineral Oil | 0.050% |
| Corrosion Inhibitor (approximately 40% | 0.075% |
| water) | |
| Thickening agent 1-Polysaccharide | 0.350% |
| gum | |
| Red Iron Oxide | 0.035% |
| Fluorescent Pigment | 0.350% |
| Surfactant | 0.017% |
| Water | 88.126% |
| Total Weight of Final Diluted Product | 100% |

The density of the final diluted product 202 of Example 7 may be in the range of about 0.7 g/mL to about 1.4 g/mL, for example about 0.9 g/mL to about 1.2 g/mL. The pH of the final diluted product 202 of Example 7 may be in the range of about 5.5 to about 6.5, for example about 6.1. The N/P molar ratio of the final diluted product 202 of Example 7 may be in the range of about 1.0 to about 2.0, for example about 1.3. The viscosity of the final diluted product 202 of Example 7 may be in the range of about 150 cP to about 300 cP, for example about 218 cP.

### Example 8

In Example 8, a liquid concentrate dispersion was prepared containing the amounts of ingredients listed in Table 16 below. The values in Table 16 can be varied by ±0.01% or ±0.05%, or ±0.1% or ±0.5%,or ±1.0%,or ±1.5%,or ±2%,or ±2.5%, or ±3.0%, or ±3.5%, or ±4.0%, or ±4.5%, or ±5.0%. The viscosity of the liquid concentrate dispersion 201 of Example 8 may be in the range of about 1200 cP to about 1800 cP, for example about 1460 cP.

TABLE 16
Dry Concentrate according to Example 8

| | Weight Percent of |
|---|---|
| | Each Ingredient in |
| Ingredient | Dry Concentrate |
| MAP | 71.28% |
| Buffering Agent | 22.51% |
| Corrosion Inhibitor (approximately 40% | 0.56% |
| water) | |
| Thickening agent 1-Polysaccharide | 2.63% |
| gum | |
| Red Iron Oxide | 0.26% |
| Fluorescent Pigment | 2.63% |
| Surfactant | 0.13% |
| Water | 0.00% |
| Total Weight of Dry Concentrate | 100% |

In Example 8, the final diluted product 202 was prepared by mixing approximately 5.4 gallons of water with 1 gallon of the liquid concentrate dispersion. The amounts of the ingredients in the Example 8 final diluted product 202 are listed in Table 17 below. The values in Table 17 can be varied by ±0.01%, or ±0.05%, or ±0.1%, or ±0.5%, or ±1.0%, or ±1.5%, or ±2%, or ±2.5%, or ±3.0%, or ±3.5%, or ±4.0%, or ±4.5%, or ±5.0%. The concentration of salt in the Example 8 final diluted product 202 is about 5% to 20% by weight in water, preferably about 6% to 18%, more preferably about 7% to 16%. For example, the weight percent of salt in the Example 8 final diluted product 202 is about 10.1%±1.0%.

TABLE 17
Final Diluted Product according to Example 8

| | Weight Percent of |
|---|---|
| | Each Ingredient in |
| | Final Diluted |
| Ingredient | Product |
| MAP | 9.500% |
| Buffering Agent | 3.000% |
| Corrosion Inhibitor (approximately 40% | 0.075% |
| water) | |
| Thickening agent 1-Polysaccharide | 0.350% |
| gum | |
| Red Iron Oxide | 0.035% |
| Fluorescent Pigment | 0.350% |
| Surfactant | 0.017% |
| Water | 86.673% |
| Total Weight of Final Diluted Product | 100% |

The density of the final diluted product 202 of Example 8 may be in the range of about 0.8 g/mL to about 1.5 g/mL, for example about 0.9 g/mL to about 1.4 g/mL. The pH of the final diluted product 202 of Example 8 may be in the range of about 7.0 to about 8.0, for example about 7.3. The N/P molar ratio of the final diluted product 202 of Example 8 may be in the range of about 1.0 to about 2.0, for example about 1.3. The viscosity of the final diluted product 202 of Example 8 may be in the range of about 200 cP to about 400 cP, for example about 316 cP.

### Example 9

In Example 9, a liquid concentrate dispersion was prepared containing the amounts of ingredients listed in Table 18 below. The values in Table 18 can be varied by ±0.01% or ±0.05%, or ±0.1% or ±0.5%,or ±1.0%,or ±1.5%,or ±2%,or ±2.5%, or ±3.0%, or ±3.5%, or ±4.0%, or ±4.5%, or ±5.0%. The viscosity of the liquid concentrate dispersion 201 of Example 9 may be in the range of about 1,000 cP to about 3,000 cP, for example about 1728 cP.

TABLE 18
Dry Concentrate according to Example 9

| | Weight Percent of |
|---|---|
| | Each Ingredient in |
| Ingredient | Dry Concentrate |
| DAP | 76.11% |
| Buffering Agent | 17.95% |
| Corrosion Inhibitor (approximately 40% | 0.54% |
| water) | |
| Thickening agent 1-Polysaccharide | 2.51% |
| gum | |
| Red Iron Oxide | 0.25% |
| Fluorescent Pigment | 2.51% |
| Surfactant | 0.12% |
| Water | 0.00% |
| Total Weight of Dry Concentrate | 100% |

In Example 9, the final diluted product 202 was prepared by mixing approximately 5.89 gallons of water with 1 gallon of the liquid concentrate dispersion. The amounts of the ingredients in the Example 9 final diluted product 202 are listed in Table 19 below. The values in Table 19 can be varied by ±0.01%, or ±0.05%, or ±0.1%, or ±0.5%, or ±1.0%, or ±1.5%, or ±2%, or ±2.5%, or ±3.0%, or ±3.5%, or ±4.0%, or ±4.5%, or ±5.0%. The concentration of salt in the Example 9 final diluted product 202 is about 5% to 20% by weight in water, preferably about 6% to 18%, more preferably about 7% to 16%. For example, the weight percent of salt in the Example 9 final diluted product 202 is about 10.1%±1.0%.

TABLE 19
Final Diluted Product according to Example 9

| | Weight Percent of |
|---|---|
| | Each Ingredient in |
| | Final Diluted |
| Ingredient | Product |
| DAP | 10.600% |
| Buffering Agent | 2.500% |
| Corrosion Inhibitor (approximately 40% | 0.075% |
| water) | |
| Thickening agent 1-Polysaccharide | 0.350% |
| gum | |
| Red Iron Oxide | 0.035% |
| Fluorescent Pigment | 0.350% |
| Surfactant | 0.017% |
| Water | 86.073% |
| Total Weight of Final Diluted Product | 100% |

The density of the final diluted product 202 of Example 9 may be in the range of about 0.8 g/mL to about 1.5 g/mL, for example about 0.9 g/mL to about 1.4 g/mL. The pH of the final diluted product 202 of Example 9 may be in the range of about 5.5 to about 6.5, for example about 6.14. The N/P molar ratio of the final diluted product 202 of Example 9 may be in the range of about 1.0 to about 2.0, for example about 1.3. The viscosity of the final diluted product 202 of Example 9 may be in the range of about 150 cP to about 300 cP, for example about 195 cP.

### Example 10

In Example 10, a liquid concentrate dispersion was prepared containing the amounts of ingredients listed in Table 20 below. The values in Table 20 can be varied by ±0.01% or ±0.05%, or ±0.1% or ±0.5%,or ±1.0%,or ±1.5%,or ±2%,or ±2.5%, or ±3.0%, or ±3.5%, or ±4.0%, or ±4.5%, or ±5.0%. The viscosity of the liquid concentrate dispersion 201 of Example 10 may be in the range of about 500 cP to about 800 cP, for example about 666 cP.

TABLE 20
Dry Concentrate according to Example 10

| | Weight Percent of |
|---|---|
| | Each Ingredient in |
| Ingredient | Dry Concentrate |
| MAP | 77.75% |
| Buffering Agent | 15.48% |
| Corrosion Inhibitor (approximately 40% | 0.61% |
| water) | |
| Thickening agent 1-Polysaccharide | 2.86% |
| gum | |
| Red Iron Oxide | 0.29% |
| Fluorescent Pigment | 2.86% |
| Surfactant | 0.14% |
| Water | 0.00% |
| Total Weight of Dry Concentrate | 100% |

In Example 10, the final diluted product 202 was prepared by mixing approximately 5.5 gallons of water with 1 gallon of the liquid concentrate dispersion. The amounts of the ingredients in the Example 10 final diluted product 202 are listed in Table 21 below. The values in Table 21 can be varied by ±0.01%, or ±0.05%, or ±0.1%, or ±0.5%, or ±1.0%, or ±1.5%, or ±2%, or ±2.5%, or ±3.0%, or ±3.5%, or ±4.0%, or ±4.5%, or ±5.0%. The concentration of salt in the Example 10 final diluted product 202 is about 5% to 20% by weight in water, preferably about 6% to 18%, more preferably about 7% to 16%. For example, the weight percent of salt in the Example 10 final diluted product 202 is about 10.1%±1.0%.

TABLE 21
Final Diluted Product according to Example 10

| | Weight Percent of |
|---|---|
| | Each Ingredient in |
| | Final Diluted |
| Ingredient | Product |
| MAP | 9.500% |
| Buffering Agent | 1.892% |
| Corrosion Inhibitor (approximately 40% | 0.075% |
| water) | |
| Thickening agent 1-Polysaccharide | 0.350% |
| gum | |
| Red Iron Oxide | 0.035% |
| Fluorescent Pigment | 0.350% |
| Surfactant | 0.017% |
| Water | 87.781% |
| Total Weight of Final Diluted Product | 100% |

The density of the final diluted product 202 of Example 10 may be in the range of about 0.8 g/mL to about 1.5 g/mL, for example about 0.9 g/mL to about 1.4 g/mL. The pH of the final diluted product 202 of Example 10 may be in the range of about 5.0 to about 6.0, for example about 5.43. The N/P molar ratio of the final diluted product 202 of Example 10 may be in the range of about 0.8 to about 2.0, for example about 1.0. The viscosity of the final diluted product 202 of Example 10 may be in the range of about 250 cP to about 400 cP, for example about 297.5 cP.

### Example 11

In Example 11, a liquid concentrate dispersion was prepared containing the amounts of ingredients listed in Table 22 below. The values in Table 22 can be varied by ±0.01% or ±0.05%, or ±0.1% or ±0.5%,or ±1.0%,or ±1.5%,or ±2%,or ±2.5%, or ±3.0%, or ±3.5%, or ±4.0%, or ±4.5%, or ±5.0%. The viscosity of the liquid concentrate dispersion 201 of Example 11 may be in the range of about 2000 cP to about 8000 cP, for example about 5000 cP.

TABLE 22
Liquid Concentrate according to Example 11

| | Weight Percent of |
|---|---|
| | Each Ingredient in |
| Ingredient | Liquid Concentrate |
| MAP | 42.90% |
| Buffering Agent | 13.55% |
| Corrosion Inhibitor (approximately 40% | 0.34% |
| water) | |
| Thickening agent 1-Polysaccharide | 1.58% |
| gum | |
| Red Iron Oxide | 0.16% |
| Fluorescent Pigment | 1.58% |
| Surfactant | 0.08% |
| Water | 39.82% |
| Total Weight of Liquid Concentrate | 100% |

In Example 11, the final diluted product 202 was prepared by mixing approximately 5.7 gallons of water with 1 gallon of the liquid concentrate dispersion. The amounts of the ingredients in the Example 11 final diluted product 202 are listed in Table 23 below. The values in Table 23 can be varied by ±0.01%, or ±0.05%, or ±0.1%, or ±0.5%, or ±1.0%, or ±1.5%, or ±2%, or ±2.5%, or ±3.0%, or ±3.5%, or ±4.0%, or ±4.5%, or ±5.0%. The concentration of salt in the Example 11 final diluted product 202 is about 5% to 20% by weight in water, preferably about 6% to 18%, more preferably about 7% to 16%. For example, the weight percent of salt in the Example 11 final diluted product 202 is about 10.0%±1.0%.

TABLE 23
Final Diluted Product according to Example 11

| | Weight Percent of |
|---|---|
| | Each Ingredient in |
| | Final Diluted |
| Ingredient | Product |
| MAP | 9.500% |
| Buffering Agent | 3.000% |
| Corrosion Inhibitor (approximately 40% | 0.075% |
| water) | |
| Thickening agent 1-Polysaccharide | 0.350% |
| gum | |
| Red Iron Oxide | 0.035% |
| Fluorescent Pigment | 0.350% |
| Surfactant | 0.017% |
| Water | 86.673% |
| Total Weight of Final Diluted Product | 100% |

The density of the final diluted product 202 of Example 11 may be in the range of about 0.8 g/mL to about 1.5 g/mL, for example about 0.9 g/mL to about 1.4 g/mL. The pH of the final diluted product 202 of Example 11 may be in the range of about 6.0 to about 7.0, for example about 6.4. The N/P molar ratio of the final diluted product 202 of Example 11 may be in the range of about 1.0 to about 2.0, for example about 1.5. The viscosity of the final diluted product 202 of Example 11 may be in the range of about 150 cP to about 400 cP, for example about 183 cP.

### Example 12

In Example 12, a liquid concentrate dispersion was prepared containing the amounts of ingredients listed in Table 24 below. The values in Table 24 can be varied by ±0.01% or ±0.05%, or ±0.1% or ±0.5%,or ±1.0%,or ±1.5%,or ±2%,or ±2.5%, or ±3.0%, or ±3.5%, or ±4.0%, or ±4.5%, or ±5.0%. The viscosity of the liquid concentrate dispersion 201 of Example 12 may be in the range of about 5,000 cP to about 10,000 cP, for example about 8,000 cP.

TABLE 24
Dry Concentrate according to Example 12

| | Weight Percent of |
|---|---|
| | Each Ingredient in |
| Ingredient | Dry Concentrate |
| MAP | 48.92% |
| DAP | 21.42% |
| DSP | 22.96% |
| Corrosion Inhibitor (approximately 40% | 0.77% |
| water) | |
| Thickening agent 1-Polysaccharide | 3.18% |
| gum | |
| Red Iron Oxide | 0.32% |
| Fluorescent Pigment | 2.27% |
| Surfactant | 0.15% |
| Water | 0.00% |
| Total Weight of Dry Concentrate | 100% |

In Example 12, the final diluted product 202 was prepared by mixing approximately 5.4 gallons of water with 1 gallon of the liquid concentrate dispersion. The amounts of the ingredients in the Example 12 final diluted product 202 are listed in Table 25 below. The values in Table 25 can be varied by ±0.01%, or ±0.05%, or ±0.1%, or ±0.5%, or ±1.0%, or ±1.5%, or ±2%, or ±2.5%, or ±3.0%, or ±3.5%, or ±4.0%, or ±4.5%, or ±5.0%. The concentration of salt in the Example 12 final diluted product 202 is about 5% to 20% by weight in water, preferably about 6% to 18%, more preferably about 7% to 16%. For example, the weight percent of salt in the Example 12 final diluted product 202 is about 10.0%±1.0%.

TABLE 25
Final Diluted Product according to Example 12

| | Weight Percent of |
|---|---|
| | Each Ingredient in |
| | Final Diluted |
| Ingredient | Product |
| MAP | 5.39% |
| DAP | 2.36% |
| DSP | 2.53% |
| Corrosion Inhibitor (approximately 40% | 0.09% |
| water) | |
| Thickening agent 1-Polysaccharide | 0.35% |
| gum | |
| Red Iron Oxide | 0.04% |
| Fluorescent Pigment | 0.25% |
| Surfactant | 0.02% |
| Water | 88.983% |
| Total Weight of Final Diluted Product | 100% |

The density of the final diluted product 202 of Example 12 may be in the range of about 0.8 g/mL to about 1.5 g/mL, for example about 0.9 g/mL to about 1.4 g/mL. The pH of the final diluted product 202 of Example 12 may be in the range of about 6.0 to about 7.0, for example about 6.37. The N/P molar ratio of the final diluted product 202 of Example 12 may be in the range of about 1.0 to about 2.0, for example about 1.5. The viscosity of the final diluted product 202 of Example 12 may be in the range of about 150 cP to about 300 cP, for example about 187 cP.

### Example 13

In Example 13, a liquid concentrate dispersion was prepared containing the amounts of ingredients listed in Table 26 below. The values in Table 26 can be varied by ±0.01% or ±0.05%, or ±0.1% or ±0.5%,or ±1.0%,or ±1.5%,or ±2%,or ±2.5%, or ±3.0%, or ±3.5%, or ±4.0%, or ±4.5%, or ±5.0%. The viscosity of the liquid concentrate dispersion 201 of Example 13 may be in the range of about 500 cP to about 1,000 cP, for example about 800 cP.

TABLE 26
Dry Concentrate according to Example 13

| | Weight Percent of |
|---|---|
| | Each Ingredient in |
| Ingredient | Dry Concentrate |
| DAP | 41.45% |
| Buffering Agent | 7.61% |
| DSP | 44.57% |
| Corrosion Inhibitor (approximately 40% | 0.65% |
| water) | |
| Thickening agent 1-Polysaccharide | 2.66% |
| gum | |
| Red Iron Oxide | 0.27% |
| Fluorescent Pigment | 2.66% |
| Surfactant | 0.13% |
| Water | 0.00% |
| Total Weight of Dry Concentrate | 100% |

In Example 13, the final diluted product 202 was prepared by mixing approximately 5.53 gallons of water with 1 gallon of the liquid concentrate dispersion. The amounts of the ingredients in the Example 13 final diluted product 202 are listed in Table 27 below. The values in Table 27 can be varied by ±0.01%, or ±0.05%, or ±0.1%, or ±0.5%, or ±1.0%, or ±1.5%, or ±2%, or ±2.5%, or ±3.0%, or ±3.5%, or ±4.0%, or ±4.5%, or ±5.0%. The concentration of salt in the Example 13 final diluted product 202 is about 5% to 20% by weight in water, preferably about 6% to 18%, more preferably about 7% to 16%. For example, the weight percent of salt in the Example 13 final diluted product 202 is about 10.0%±1.0%.

TABLE 27
Final Diluted Product according to Example 13

| | Weight Percent of |
|---|---|
| | Each Ingredient in |
| | Final Diluted |
| Ingredient | Product |
| DAP | 5.45% |
| Buffering Agent | 1.00% |
| DSP | 5.86% |
| Corrosion Inhibitor (approximately 40% | 0.09% |
| water) | |
| Thickening agent 1-Polysaccharide | 0.35% |
| gum | |
| Red Iron Oxide | 0.04% |
| Fluorescent Pigment | 0.35% |
| Surfactant | 0.02% |
| Water | 86.853% |
| Total Weight of Final Diluted Product | 100% |

The density of the final diluted product 202 of Example 13 may be in the range of about 0.8 g/mL to about 1.5 g/mL, for example about 0.9 g/mL to about 1.4 g/mL. The pH of the final diluted product 202 of Example 13 may be in the range of about 6.0 to about 7.0, for example about 6.5. The N/P molar ratio of the final diluted product 202 of Example 13 may be in the range of about 1.0 to about 2.0, for example about 1.5. The viscosity of the final diluted product 202 of Example 13 may be in the range of about 150 cP to about 400 cP, for example about 176 cP.

### Example 14

In Example 14, a liquid concentrate dispersion was prepared containing the amounts of ingredients listed in Table 28 below. The values in Table 28 can be varied by ±0.01% or ±0.05%, or ±0.1% or ±0.5%,or ±1.0%,or ±1.5%,or ±2%,or ±2.5%, or ±3.0%, or ±3.5%, or ±4.0%, or ±4.5%, or ±5.0%. The viscosity of the liquid concentrate dispersion 201 of Example 14 may be in the range of about 300 cP to about 800 cP, for example about 500 cP.

TABLE 28
Dry Concentrate according to Example 14

| | Weight Percent of |
|---|---|
| | Each Ingredient in |
| Ingredient | Dry Concentrate |
| MAP | 49.84% |
| DAP | 21.82% |
| DSP | 23.39% |
| Corrosion Inhibitor (approximately 40% | 0.79% |
| water) | |
| Thickening agent 1-Polysaccharide | 3.24% |
| gum | |
| Surfactant | 0.92% |
| Water | 0.00% |
| Total Weight of Dry Concentrate | 100% |

In Example 14, the final diluted product 202 was prepared by mixing approximately 5.4 gallons of water with 1 gallon of the liquid concentrate dispersion. The amounts of the ingredients in the Example 14 final diluted product 202 are listed in Table 29 below. The values in Table 29 can be varied by ±0.01%, or ±0.05%, or ±0.1%, or ±0.5%, or ±1.0%, or ±1.5%, or ±2%, or ±2.5%, or ±3.0%, or ±3.5%, or ±4.0%, or ±4.5%, or ±5.0%. The concentration of salt in the Example 14 final diluted product 202 is about 5% to 20% by weight in water, preferably about 6% to 18%, more preferably about 7% to 16%. For example, the weight percent of salt in the Example 14 final diluted product 202 is about 10.0%±1.0%.

TABLE 29
Final Diluted Product according to Example 14

| | Weight Percent of |
|---|---|
| | Each Ingredient in |
| | Final Diluted |
| Ingredient | Product |
| MAP | 5.39% |
| DAP | 2.36% |
| DSP | 2.53% |
| Corrosion Inhibitor (approximately 40% | 0.09% |
| water) | |
| Thickening agent 1-Polysaccharide | 0.35% |
| gum | |
| Surfactant | 0.10% |
| Water | 89.185% |
| Total Weight of Final Diluted Product | 100% |

The density of the final diluted product 202 of Example 14 may be in the range of about 0.8 g/mL to about 1.5 g/mL, for example about 0.9 g/mL to about 1.4 g/mL. The pH of the final diluted product 202 of Example 14 may be in the range of about 6.0 to about 7.0, for example about 6.5. The N/P molar ratio of the final diluted product 202 of Example 14 may be in the range of about 1.0 to about 2.0, for example about 1.5. The viscosity of the final diluted product 202 of Example 14 may be in the range of about 150 cP to about 400 cP, for example about 166 cP.

### Example 15

In Example 15, a liquid concentrate dispersion was prepared containing the amounts of ingredients listed in Table 30 below. The values in Table 30 can be varied by ±0.01% or ±0.05%, or ±0.1% or ±0.5%,or ±1.0%,or ±1.5%,or ±2%,or ±2.5%, or ±3.0%, or ±3.5%, or ±4.0%, or ±4.5%, or ±5.0%. The viscosity of the liquid concentrate dispersion 201 of Example 15 may be in the range of about 700 cP to about 1000 cP, for example about 896 cP.

TABLE 30
Dry Concentrate according to Example 15

| | Weight Percent of |
|---|---|
| | Each Ingredient in |
| Ingredient | Dry Concentrate |
| MAP | 43.70% |
| Ammonium Sulfate | 16.05% |
| DSP | 34.44% |
| Corrosion Inhibitor (approximately 40% | 0.83% |
| water) | |
| Thickening agent 1-Polysaccharide | 2.64% |
| gum | |
| Red Iron Oxide | 0.30% |
| Fluorescent Pigment | 1.88% |
| Surfactant | 0.15% |
| Water | 0.00% |
| Total Weight of Dry Concentrate | 100% |

In Example 15, the final diluted product 202 was prepared by mixing approximately 5.9 gallons of water with 1 gallon of the liquid concentrate dispersion. The amounts of the ingredients in the Example 15 final diluted product 202 are listed in Table 31 below. The values in Table 31 can be varied by ±0.01%, or ±0.05%, or ±0.1%, or ±0.5%, or ±1.0%, or ±1.5%, or ±2%, or ±2.5%, or ±3.0%, or ±3.5%, or ±4.0%, or ±4.5%, or ±5.0%. The concentration of salt in the Example 15 final diluted product 202 is about 5% to 20% by weight in water, preferably about 6% to 18%, more preferably about 7% to 16%. For example, the weight percent of salt in the Example 15 final diluted product 202 is about 10.0%±1.0%.

TABLE 31
Final Diluted Product according to Example 15

| | Weight Percent of |
|---|---|
| | Each Ingredient in |
| | Final Diluted |
| Ingredient | Product |
| MAP | 5.80% |
| Ammonium Sulfate | 2.13% |
| DSP | 4.57% |
| Corrosion Inhibitor (approximately 40% | 0.11% |
| water) | |
| Thickening agent 1-Polysaccharide | 0.35% |
| gum | |
| Red Iron Oxide | 0.04% |
| Fluorescent Pigment | 0.25% |
| Surfactant | 0.02% |
| Water | 86.732% |
| Total Weight of Final Diluted Product | 100% |

The density of the final diluted product 202 of Example 15 may be in the range of about 0.8 g/mL to about 1.5 g/mL, for example about 0.9 g/mL to about 1.4 g/mL. The pH of the final diluted product 202 of Example 15 may be in the range of about 6.0 to about 7.0, for example about 6.5. The N/P molar ratio of the final diluted product 202 of Example 15 may be in the range of about 1.0 to about 2.0, for example about 1.5. The viscosity of the final diluted product 202 of Example 15 may be in the range of about 150 cP to about 400 cP, for example about 170 cP.

### Example 16

In Example 16, a liquid concentrate dispersion was prepared containing the amounts of ingredients listed in Table 32 below. The values in Table 32 can be varied by ±0.01% or ±0.05%, or ±0.1% or ±0.5%,or ±1.0%,or ±1.5%,or ±2%,or ±2.5%, or ±3.0%, or ±3.5%, or ±4.0%, or ±4.5%, or ±5.0%. The viscosity of the liquid concentrate dispersion 201 of Example 16 may be in the range of about 150 cP to about 500 cP, for example about 328 cP.

TABLE 32
Dry Concentrate according to Example 16

| | Weight Percent of |
|---|---|
| | Each Ingredient in |
| Ingredient | Dry Concentrate |
| MAP | 45.09% |
| Ammonium Chloride | 13.38% |
| DSP | 35.54% |
| Corrosion Inhibitor (approximately 40% | 0.86% |
| water) | |
| Thickening agent 1-Polysaccharide | 2.72% |
| gum | |
| Red Iron Oxide | 0.31% |
| Fluorescent Pigment | 1.94% |
| Surfactant | 0.16% |
| Water | 0.00% |
| Total Weight of Dry Concentrate | 100% |

In Example 16, the final diluted product 202 was prepared by mixing approximately 5.2 gallons of water with 1 gallon of the liquid concentrate dispersion. The amounts of the ingredients in the Example 16 final diluted product 202 are listed in Table 33 below. The values in Table 33 can be varied by ±0.01%, or ±0.05%, or ±0.1%, or ±0.5%, or ±1.0%, or ±1.5%, or ±2%, or ±2.5%, or ±3.0%, or ±3.5%, or ±4.0%, or ±4.5%, or ±5.0%. The concentration of salt in the Example 16 final diluted product 202 is about 5% to 20% by weight in water, preferably about 6% to 18%, more preferably about 7% to 16%. For example, the weight percent of salt in the Example 16 final diluted product 202 is about 10.0%±1.0%.

TABLE 33
Final Diluted Product according to Example 16

| | Weight Percent of |
|---|---|
| | Each Ingredient in |
| | Final Diluted |
| Ingredient | Product |
| MAP | 5.80% |
| Ammonium Chloride | 1.72% |
| DSP | 4.57% |
| Corrosion Inhibitor (approximately 40% | 0.11% |
| water) | |
| Thickening agent 1-Polysaccharide | 0.35% |
| gum | |
| Red Iron Oxide | 0.04% |
| Fluorescent Pigment | 0.25% |
| Surfactant | 0.02% |
| Water | 87.142% |
| Total Weight of Final Diluted Product | 100% |

The density of the final diluted product 202 of Example 16 may be in the range of about 0.8 g/mL to about 1.5 g/mL, for example about 0.9 g/mL to about 1.4 g/mL. The pH of the final diluted product 202 of Example 16 may be in the range of about 6.0 to about 7.0, for example about 6.5. The N/P molar ratio of the final diluted product 202 of Example 16 may be in the range of about 1.0 to about 2.0, for example about 1.5. The viscosity of the final diluted product 202 of Example 16 may be in the range of about 150 cP to about 400 cP, for example about 181 cP.

### Example 17

In Example 17, a liquid concentrate dispersion was prepared containing the amounts of ingredients listed in Table 34 below. The values in Table 34 can be varied by ±0.01% or ±0.05%, or ±0.1% or ±0.5%,or ±1.0%,or ±1.5%,or ±2%,or ±2.5%, or ±3.0%, or ±3.5%, or ±4.0%, or ±4.5%, or ±5.0%. The viscosity of the liquid concentrate dispersion 201 of Example 17 may be in the range of about 1000 cP to about 1500 cP, for example about 1158 cP.

TABLE 34
Dry Concentrate according to Example 17

| | Weight Percent of |
|---|---|
| | Each Ingredient in |
| Ingredient | Dry Concentrate |
| DAP | 48.79% |
| Monosodium Phosphate | 44.32% |
| Corrosion Inhibitor (approximately 40% | 0.98% |
| water) | |
| Thickening agent 1-Polysaccharide | 3.13% |
| gum | |
| Red Iron Oxide | 0.36% |
| Fluorescent Pigment | 2.24% |
| Surfactant | 0.18% |
| Water | 0.00% |
| Total Weight of Dry Concentrate | 100% |

In Example 17, the final diluted product 202 was prepared by mixing approximately 7.0 gallons of water with 1 gallon of the liquid concentrate dispersion. The amounts of the ingredients in the Example 17 final diluted product 202 are listed in Table 35 below. The values in Table 35 can be varied by ±0.01%, or ±0.05%, or ±0.1%, or ±0.5%, or ±1.0%, or ±1.5%, or ±2%, or ±2.5%, or ±3.0%, or ±3.5%, or ±4.0%, or ±4.5%, or ±5.0%. The concentration of salt in the Example 17 final diluted product 202 is about 5% to 20% by weight in water, preferably about 6% to 18%, more preferably about 7% to 16%. For example, the weight percent of salt in the Example 17 final diluted product 202 is about 10.0%±1.0%.

TABLE 35
Final Diluted Product according to Example 17

| | Weight Percent of |
|---|---|
| | Each Ingredient in |
| | Final Diluted |
| Ingredient | Product |
| DAP | 5.45% |
| Monosodium Phosphate | 4.95% |
| Corrosion Inhibitor (approximately 40% | 0.11% |
| water) | |
| Thickening agent 1-Polysaccharide | 0.35% |
| gum | |
| Red Iron Oxide | 0.04% |
| Fluorescent Pigment | 0.25% |
| Surfactant | 0.02% |
| Water | 88.830% |
| Total Weight of Final Diluted Product | 100% |

The density of the final diluted product 202 of Example 17 may be in the range of about 0.8 g/mL to about 1.5 g/mL, for example about 0.9 g/mL to about 1.4 g/mL. The pH of the final diluted product 202 of Example 17 may be in the range of about 5.5 to about 6.5, for example about 6.0. The N/P molar ratio of the final diluted product 202 of Example 17 may be in the range of about 1.0 to about 2.0, for example about 1.3. The viscosity of the final diluted product 202 of Example 17 may be in the range of about 100 cP to about 400 cP, for example about 147 cP.

### Example 18

In Example 18, a liquid concentrate dispersion was prepared containing the amounts of ingredients listed in Table 36 below. The values in Table 36 can be varied by ±0.01% or ±0.05%, or ±0.1% or ±0.5%,or ±1.0%,or ±1.5%,or ±2%,or ±2.5%, or ±3.0%, or ±3.5%, or ±4.0%, or ±4.5%, or ±5.0%. The viscosity of the liquid concentrate dispersion 201 of Example 18 may be in the range of about 1000 cP to about 1500 cP, for example about 1352 cP.

TABLE 36
Dry Concentrate according to Example 18

| | Weight Percent of |
|---|---|
| | Each Ingredient in |
| Ingredient | Dry Concentrate |
| DAP | 46.58% |
| Monosodium Phosphate | 42.31% |
| Citric Acid | 4.53% |
| Corrosion Inhibitor (approximately 40% | 0.94% |
| water) | |
| Thickening agent 1-Polysaccharide | 2.99% |
| gum | |
| Red Iron Oxide | 0.34% |
| Fluorescent Pigment | 2.14% |
| Surfactant | 0.17% |
| Water | 0.00% |
| Total Weight of Dry Concentrate | 100% |

In Example 18, the final diluted product 202 was prepared by mixing approximately 6.9 gallons of water with 1 gallon of the liquid concentrate dispersion. The amounts of the ingredients in the Example 18 final diluted product 202 are listed in Table 37 below. The values in Table 37 can be varied by ±0.01%, or ±0.05%, or ±0.1%, or ±0.5%, or ±1.0%, or ±1.5%, or ±2%, or ±2.5%, or ±3.0%, or ±3.5%, or ±4.0%, or ±4.5%, or ±5.0%. The concentration of salt in the Example 18 final diluted product 202 is about 5% to 20% by weight in water, preferably about 6% to 18%, more preferably about 7% to 16%. For example, the weight percent of salt in the Example 18 final diluted product 202 is about 10.0%±1.0%.

TABLE 37
Final Diluted Product according to Example 18

| | Weight Percent of |
|---|---|
| | Each Ingredient in |
| | Final Diluted |
| Ingredient | Product |
| DAP | 5.45% |
| Monosodium Phosphate | 4.95% |
| Citric Acid | 0.53% |
| Corrosion Inhibitor (approximately 40% | 0.11% |
| water) | |
| Thickening agent 1-Polysaccharide | 0.35% |
| gum | |
| Red Iron Oxide | 0.04% |
| Fluorescent Pigment | 0.25% |
| Surfactant | 0.02% |
| Water | 88.300% |
| Total Weight of Final Diluted Product | 100% |

The density of the final diluted product 202 of Example 18 may be in the range of about 0.8 g/mL to about 1.5 g/mL, for example about 0.9 g/mL to about 1.4 g/mL. The pH of the final diluted product 202 of Example 18 may be in the range of about 5.5 to about 6.5, for example about 6.1. The N/P molar ratio of the final diluted product 202 of Example 18 may be in the range of about 1.0 to about 2.0, for example about 1.3. The viscosity of the final diluted product 202 of Example 18 may be in the range of about 150 cP to about 400 cP, for example about 167 cP.

### Example 19

In Example 19, a liquid concentrate dispersion was prepared containing the amounts of ingredients listed in Table 38 below. The values in Table 38 can be varied by ±0.01% or ±0.05%, or ±0.1% or ±0.5%,or ±1.0%,or ±1.5%,or ±2%,or ±2.5%, or ±3.0%, or ±3.5%, or ±4.0%, or ±4.5%, or ±5.0%. The viscosity of the liquid concentrate dispersion 201 of Example 19 may be in the range of about 100 cP to about 500 cP, for example about 171 cP.

TABLE 38
Dry Concentrate according to Example 19

| | Weight Percent of |
|---|---|
| | Each Ingredient in |
| Ingredient | Dry Concentrate |
| MAP | 52.53% |
| DSP | 43.22% |
| Corrosion Inhibitor (approximately 40% | 0.61% |
| water) | |
| Thickening agent 1-Polysaccharide | 1.94% |
| gum | |
| Red Iron Oxide | 0.22% |
| Fluorescent Pigment | 1.38% |
| Surfactant | 0.11% |
| Water | 0.00% |
| Total Weight of Dry Concentrate | 100% |

In Example 19, the final diluted product 202 was prepared by mixing approximately 6.6 gallons of water with 1 gallon of the liquid concentrate dispersion. The amounts of the ingredients in the Example 19 final diluted product 202 are listed in Table 39 below. The values in Table 39 can be varied by ±0.01%, or ±0.05%, or ±0.1%, or ±0.5%, or ±1.0%, or ±1.5%, or ±2%, or ±2.5%, or ±3.0%, or ±3.5%, or ±4.0%, or ±4.5%, or ±5.0%. The concentration of salt in the Example 19 final diluted product 202 is about 5% to 20% by weight in water, preferably about 6% to 18%, more preferably about 7% to 16%. For example, the weight percent of salt in the Example 19 final diluted product 202 is about 9.5%±1.0%.

TABLE 39
Final Diluted Product according to Example 19

| | Weight Percent of |
|---|---|
| | Each Ingredient in |
| | Final Diluted |
| Ingredient | Product |
| MAP | 9.50% |
| DSP | 7.82% |
| Corrosion Inhibitor (approximately 40% | 0.11% |
| water) | |
| Thickening agent 1-Polysaccharide | 0.35% |
| gum | |
| Red Iron Oxide | 0.04% |
| Fluorescent Pigment | 0.25% |
| Surfactant | 0.02% |
| Water | 81.914% |
| Total Weight of Final Diluted Product | 100% |

The density of the final diluted product 202 of Example 19 may be in the range of about 0.8 g/mL to about 1.5 g/mL, for example about 0.9 g/mL to about 1.4 g/mL. The pH of the final diluted product 202 of Example 19 may be in the range of about 7.5 to about 8.5, for example about 8.2. The viscosity of the final diluted product 202 of Example 19 may be in the range of about 150 cP to about 400 cP, for example about 182 cP.

### Example 20

In Example 20, a liquid concentrate dispersion was prepared containing the amounts of ingredients listed in Table 40 below. The values in Table 40 can be varied by ±0.01% or ±0.05%, or ±0.1% or ±0.5%,or ±1.0%,or ±1.5%,or ±2%,or ±2.5%, or ±3.0%, or ±3.5%, or ±4.0%, or ±4.5%, or ±5.0%. The viscosity of the liquid concentrate dispersion 201 of Example 20 may be in the range of about 100 cP to about 500 cP, for example about 254 cP.

TABLE 40
Dry Concentrate according to Example 20

| | Weight Percent of |
|---|---|
| | Each Ingredient in |
| Ingredient | Dry Concentrate |
| MAP | 71.27% |
| DSP | 22.96% |
| Corrosion Inhibitor (approximately 40% | 0.83% |
| water) | |
| Thickening agent 1-Polysaccharide | 2.63% |
| gum | |
| Red Iron Oxide | 0.30% |
| Fluorescent Pigment | 1.88% |
| Surfactant | 0.15% |
| Water | 0.00% |
| Total Weight of Dry Concentrate | 100% |

In Example 20, the final diluted product 202 was prepared by mixing approximately 4.4 gallons of water with 1 gallon of the liquid concentrate dispersion. The amounts of the ingredients in the Example 20 final diluted product 202 are listed in Table 41 below. The values in Table 41 can be varied by ±0.01%, or ±0.05%, or ±0.1%, or ±0.5%, or ±1.0%, or ±1.5%, or ±2%, or ±2.5%, or ±3.0%, or ±3.5%, or ±4.0%, or ±4.5%, or ±5.0%. The concentration of salt in the Example 20 final diluted product 202 is about 5% to 20% by weight in water, preferably about 6% to 18%, more preferably about 7% to 16%. For example, the weight percent of salt in the Example 20 final diluted product 202 is about 9.0%±1.0%.

TABLE 41
Final Diluted Product according to Example 20

| | Weight Percent of |
|---|---|
| | Each Ingredient in |
| | Final Diluted |
| Ingredient | Product |
| MAP | 9.50% |
| DSP | 3.06% |
| Corrosion Inhibitor (approximately 40% | 0.11% |
| water) | |
| Thickening agent 1-Polysaccharide | 0.35% |
| gum | |
| Red Iron Oxide | 0.04% |
| Fluorescent Pigment | 0.25% |
| Surfactant | 0.02% |
| Water | 86.670% |
| Total Weight of Final Diluted Product | 100% |

The density of the final diluted product 202 of Example 20 may be in the range of about 0.8 g/mL to about 1.5 g/mL, for example about 0.9 g/mL to about 1.4 g/mL. The pH of the final diluted product 202 of Example 20 may be in the range of about 8.0 to about 9.0, for example about 8.5. The viscosity of the final diluted product 202 of Example 20 may be in the range of about 150 cP to about 400 cP, for example about 161 cP.

### Example 21

In Example 21, a liquid concentrate dispersion was prepared containing the amounts of ingredients listed in Table 42 below. The values in Table 42 can be varied by ±0.01%, or ±0.05%, or ±0.1%, or ±0.5%, or ±1.0%, or ±1.5%, or ±2%, or ±2.5%, or ±3.0%, or ±3.5%, or ±4.0%, or ±4.5%, or ±5.0%. The viscosity of the liquid concentrate dispersion 201 of Example 21 may be in the range of about 4000 cP to about 8000 cP, for example about 5770 cP.

TABLE 42
Dry Concentrate according to Example 21

| | Weight Percent of |
|---|---|
| | Each Ingredient in |
| Ingredient | Dry Concentrate |
| DAP | 37.82% |
| Dipotassium phosphate | 49.90% |
| Citric Acid | 6.94% |
| Corrosion Inhibitor (approximately 40% | 0.76% |
| water) | |
| Thickening agent 1-Polysaccharide | 2.43% |
| gum | |
| Red Iron Oxide | 0.28% |
| Fluorescent Pigment | 1.73% |
| Surfactant | 0.14% |
| Water | 0.00% |
| Total Weight of Dry Concentrate | 100% |

In Example 21, the final diluted product 202 was prepared by mixing approximately 5.1 gallons of water with 1 gallon of the liquid concentrate dispersion. The amounts of the ingredients in the Example 21 final diluted product 202 are listed in Table 43 below. The values in Table 43 can be varied by ±0.01%, or ±0.05%, or ±0.1%, or ±0.5%, or ±1.0%, or ±1.5%, or ±2%, or ±2.5%, or ±3.0%, or ±3.5%, or ±4.0%, or ±4.5%, or ±5.0%. The concentration of salt in the Example 21 final diluted product 202 is about 5% to 20% by weight in water, preferably about 6% to 18%, more preferably about 7% to 16%. For example, the weight percent of salt in the Example 21 final diluted product 202 is about 11.0%±1.0%.

TABLE 43
Final Diluted Product according to Example 21

| | Weight Percent of |
|---|---|
| | Each Ingredient in |
| | Final Diluted |
| Ingredient | Product |
| MgSO₄ | 11.000% |
| Thickening agent-Polysaccharide Gum | 0.270% |
| Fluorescent Pigment | 0.310% |
| Corrosion Inhibitor (approximately 40% | 0.100% |
| water) | |
| Inorganic Pigment | 0.030% |
| Propylene Carbonate | 11.400% |
| Water | 76.890% |
| Total Weight of Final Diluted Product | 100% |

The density of the final diluted product 202 of Example 21 may be in the range of about 0.8 g/mL to about 1.5 g/mL, for example about 0.9 g/mL to about 1.4 g/mL. The pH of the final diluted product 202 of Example 21 may be in the range of about 7.0 to about 8.0, for example about 7.2. The viscosity of the final diluted product 202 of Example 21 may be in the range of about 150 cP to about 400 cP, for example about 220 cP.

### Example 22

In Example 22, a liquid concentrate dispersion was prepared containing the amounts of ingredients listed in Table 44 below. The values in Table 44 can be varied by ±0.01% or ±0.05%,or ±0.1% or ±0.5%,or ±1.0%,or ±1.5%,or ±2%,or ±2.5%, or ±3.0%, or ±3.5%, or ±4.0%, or ±4.5%, or ±5.0%. The viscosity of the liquid concentrate dispersion 201 of Example 22 may be in the range of about 100 cP to about 500 cP, for example about 153 cP.

TABLE 44
Liquid Concentrate Dispersion according to Example 22

| | Weight Percent of |
|---|---|
| | Each Ingredient in |
| | Liquid Concentrate |
| Ingredient | Dispersion |
| KHCO₃ | 37.334% |
| K₂CO₃ | 12.023% |
| Thickening agent-Polysaccharide Gum | 1.321% |
| Fluorescent Pigment | 1.311% |
| Corrosion Inhibitor (approximately 40% | 0.453% |
| water) | |
| Inorganic Pigment | 0.145% |
| Surfactant | 0.098% |
| Propylene Carbonate | 47.315% |
| Water | 0.000% |
| Total Weight of Liquid Concentrate | 100% |
| Dispersion | |

In Example 22, the final diluted product 202 was prepared by mixing approximately 6.8 gallons of water with 1 gallon of the liquid concentrate dispersion. The amounts of the ingredients in the Example 22 final diluted product 202 are listed in Table 45 below. The values in Table 45 can be varied by ±0.01%, or ±0.05%, or ±0.1%, or ±0.5%, or ±1.0%, or ±1.5%, or ±2%, or ±2.5%, or ±3.0%, or ±3.5%, or ±4.0%, or ±4.5%, or ±5.0%. The concentration of salt in the Example 22 final diluted product 202 is about 5% to 20% by weight in water, preferably about 6% to 18%, more preferably about 7% to 16%. For example, the weight percent of salt in the Example 22 final diluted product 202 is about 9.5%±1.0%.

TABLE 45
Final Diluted Product according to Example 22

| | Weight Percent of |
|---|---|
| | Each Ingredient in |
| | Final Diluted |
| Ingredient | Product |
| KHCO₃ | 7.152% |
| K₂CO₃ | 2.303% |
| Thickening agent-Polysaccharide Gum | 0.253% |
| Fluorescent Pigment | 0.251% |
| Corrosion Inhibitor (approximately 40% | 0.087% |
| water) | |
| Inorganic Pigment | 0.028% |
| Surfactant | 0.019% |
| Propylene Carbonate | 9.064% |
| Water | 80.843% |
| Total Weight of Final Diluted Product | 100% |

The density of the final diluted product 202 of Example 22 may be in the range of about 0.8 g/mL to about 1.5 g/mL, for example about 0.9 g/mL to about 1.4 g/mL. The pH of the final diluted product 202 of Example 22 may be in the range of about 10.0 to about 11.0, for example about 10.4. The viscosity of the final diluted product 202 of Example 22 may be in the range of about 150 cP to about 400 cP, for example about 189 cP.

### Example 23

In Example 23, a liquid concentrate dispersion was prepared containing the amounts of ingredients listed in Table 46 below. The values in Table 46 can be varied by ±0.01%, or ±0.05%, or ±0.1%, or ±0.5%, or ±1.0%, or ±1.5%, or ±2%, or ±2.5%, or ±3.0%, or ±3.5%, or ±4.0%, or ±4.5%, or ±5.0%. The viscosity of the liquid concentrate dispersion 201 of Example 23 may be in the range of about 100 cP to about 500 cP, for example about 129 cP.

TABLE 46
Liquid Concentrate according to Example 23

| | Weight Percent of |
|---|---|
| | Each Ingredient in |
| | Liquid Concentrate |
| Ingredient | Dispersion |
| MAP | 32.825% |
| DAP | 4.008% |
| DSP | 2.200% |
| Thickening agent-Polysaccharide Gum | 1.187% |
| Fluorescent Pigment | 0.966% |
| Corrosion Inhibitor | 0.345% |
| Corrosion Inhibitor | 0.089% |
| Inorganic Pigment | 0.093% |
| Surfactant | 0.097% |
| DPG-ME | 58.189% |
| Water | 0.000% |
| Total Weight of Liquid | 100% |
| Concentrate Dispersion | |

In Example 23, the final diluted product 202 was prepared by mixing approximately 3.5 gallons of water with 1 gallon of the liquid concentrate dispersion. The amounts of the ingredients in the Example 23 final diluted product 202 are listed in Table 47 below. The values in Table 47 can be varied by ±0.01%, or ±0.05%, or ±0.1%, or ±0.5%, or ±1.0%, or ±1.5%, or ±2%, or ±2.5%, or ±3.0%, or ±3.5%, or ±4.0%, or ±4.5%, or ±5.0%. The concentration of salt in the Example 23 final diluted product 202 is about 5% to 20% by weight in water, preferably about 6% to 18%, more preferably about 7% to 16%. For example, the weight percent of salt in the Example 23 final diluted product 202 is about 10.1%±1.0%.

TABLE 47
Final Diluted Product according to Example 23

| | Weight Percent of |
|---|---|
| | Each Ingredient in |
| | Final Diluted |
| Ingredient | Product |
| MAP | 8.460% |
| DAP | 1.033% |
| DSP | 0.567% |
| Thickening agent-Polysaccharide Gum | 0.306% |
| Fluorescent Pigment | 0.249% |
| Corrosion Inhibitor | 0.089% |
| Corrosion Inhibitor | 0.023% |
| Inorganic Pigment | 0.024% |
| Surfactant | 0.025% |
| DPG-ME | 14.997% |
| Water | 74.227% |
| Total Weight of Final | 100% |
| Diluted Product | |

The density of the final diluted product 202 of Example 23 may be in the range of about 0.8 g/mL to about 1.5 g/mL, for example about 0.9 g/mL to about 1.4 g/mL. The pH of the final diluted product 202 of Example 23 may be in the range of about 5.0 to about 6.0, for example about 5.5. The viscosity of the final diluted product 202 of Example 23 may be in the range of about 150 cP to about 400 cP, for example about 247 cP.

### Example 24

In Example 24, a liquid concentrate dispersion was prepared containing the amounts of ingredients listed in Table 48 below. The values in Table 48 can be varied by ±0.01% or ±0.05%, or ±0.1% or ±0.5%,or ±1.0%,or ±1.5%,or ±2%,or ±2.5%, or ±3.0%, or ±3.5%, or ±4.0%, or ±4.5%, or ±5.0%. The viscosity of the liquid concentrate dispersion 201 of Example 24 may be in the range of about 800 cP to about 1200 cP, for example about 1010 cP.

TABLE 48
Liquid Concentrate Dispersion according to Example 24

| | Weight Percent of |
|---|---|
| | Each Ingredient in |
| | Liquid Concentrate |
| Ingredient | Dispersion |
| MAP | 53.827% |
| DAP | 6.566% |
| DSP | 3.608% |
| Thickening agent-Polysaccharide Gum | 1.947% |
| Fluorescent Pigment | 1.584% |
| Corrosion Inhibitor | 0.235% |
| Corrosion Inhibitor | 0.146% |
| Inorganic Pigment | 0.127% |
| Surfactant | 0.159% |
| DPG-ME | 31.800% |
| Water | 0.000% |
| Total Weight of Liquid | 100% |
| Concentrate Dispersion | |

In Example 24, the final diluted product 202 was prepared by mixing approximately 8.2 gallons of water with 1 gallon of the liquid concentrate dispersion. The amounts of the ingredients in the Example 24 final diluted product 202 are listed in Table 49 below. The values in Table 49 can be varied by ±0.01%, or ±0.05%, or ±0.1%, or ±0.5%, or ±1.0%, or ±1.5%, or ±2%, or ±2.5%, or ±3.0%, or ±3.5%, or ±4.0%, or ±4.5%, or ±5.0%. The concentration of salt in the Example 24 final diluted product 202 is about 5% to 20% by weight in water, preferably about 6% to 18%, more preferably about 7% to 16%. For example, the weight percent of salt in the Example 24 final diluted product 202 is about 10.1%±1.0%.

TABLE 49
Final Diluted Product according to Example 24

| | Weight Percent of |
|---|---|
| | Each Ingredient in |
| | Final Diluted |
| Ingredient | Product |
| MAP | 8.460% |
| DAP | 1.032% |
| DSP | 0.567% |
| Thickening agent-Polysaccharide Gum | 0.306% |
| Fluorescent Pigment | 0.249% |
| Corrosion Inhibitor | 0.037% |
| Corrosion Inhibitor | 0.023% |
| Inorganic Pigment | 0.020% |
| Surfactant | 0.025% |
| DPG-ME | 4.998% |
| Water | 84.283% |
| Total Weight of Final | 100% |
| Diluted Product | |

The density of the final diluted product 202 of Example 24 may be in the range of about 0.8 g/mL to about 1.5 g/mL, for example about 0.9 g/mL to about 1.4 g/mL. The pH of the final diluted product 202 of Example 24 may be in the range of about 5.0 to about 6.0, for example about 5.4. The viscosity of the final diluted product 202 of Example 24 may be in the range of about 150 cP to about 400 cP, for example about 209 cP.

### Example 25

In Example 25, a liquid concentrate dispersion was prepared containing the amounts of ingredients listed in Table 50 below. The values in Table 50 can be varied by ±0.01% or ±0.05%, or ±0.1% or ±0.5%,or ±1.0%,or ±1.5%,or ±2%,or ±2.5%, or ±3.0%, or ±3.5%, or ±4.0%, or ±4.5%, or ±5.0%. The viscosity of the liquid concentrate dispersion 201 of Example 25 may be in the range of about 800 cP to about 1200 cP, for example about 972 cP.

TABLE 50
Liquid Concentrate Dispersion according to Example 25

| | Weight Percent of |
|---|---|
| | Each Ingredient in |
| | Liquid Concentrate |
| Ingredient | Dispersion |
| MAP | 9.632% |
| DAP | 40.666% |
| DSP | 2.721% |
| Thickening agent-Polysaccharide Gum | 1.445% |
| Fluorescent Pigment | 1.204% |
| Corrosion Inhibitor (approximately 40% | 0.433% |
| water) | |
| Corrosion Inhibitor | 0.096% |
| Inorganic Pigment | 0.096% |
| Surfactant | 0.120% |
| DPG-ME | 43.585% |
| Water | 0.000% |
| Total Weight of Liquid | 100% |
| Concentrate Dispersion | |

In Example 25, the final diluted product 202 was prepared by mixing approximately 5.5 gallons of water with 1 gallon of the liquid concentrate dispersion. The amounts of the ingredients in the Example 25 final diluted product 202 are listed in Table 51 below. The values in Table 51 can be varied by ±0.01%, or ±0.05%, or ±0.1%, or ±0.5%, or ±1.0%, or ±1.5%, or ±2%, or ±2.5%, or ±3.0%, or ±3.5%, or ±4.0%, or ±4.5%, or ±5.0%. The concentration of salt in the Example 25 final diluted product 202 is about 5% to 20% by weight in water, preferably about 6% to 18%, more preferably about 7% to 16%. For example, the weight percent of salt in the Example 25 final diluted product 202 is about 11.0%±1.0%.

TABLE 51
Final Diluted Product according to Example 25

| | Weight Percent of |
|---|---|
| | Each Ingredient in |
| | Final Diluted |
| Ingredient | Product |
| MAP | 2.000% |
| DAP | 8.444% |
| DSP | 0.565% |
| Thickening agent-Polysaccharide Gum | 0.300% |
| Fluorescent Pigment | 0.250% |
| Corrosion Inhibitor (approximately 40% | 0.090% |
| water) | 0.020% |
| Corrosion Inhibitor | 0.020% |
| Inorganic Pigment | 0.025% |
| Surfactant | 9.050% |
| DPG-ME | 79.236% |
| Water | |
| Total Weight of Final Diluted Product | 100% |

The density of the final diluted product 202 of Example 25 may be in the range of about 0.8 g/mL to about 1.5 g/mL, for example about 0.9 g/mL to about 1.4 g/mL. The pH of the final diluted product 202 of Example 25 may be in the range of about 6.5 to about 7.5, for example about 7.0. The viscosity of the final diluted product 202 of Example 25 may be in the range of about 150 cP to about 400 cP, for example about 246 cP.

### Example 26

In Example 26, a liquid concentrate dispersion was prepared containing the amounts of ingredients listed in Table 52 below. The values in Table 52 can be varied by ±0.01% or ±0.05%, or ±0.1% or ±0.5%,or ±1.0%,or ±1.5%,or ±2%,or ±2.5%, or ±3.0%, or ±3.5%, or ±4.0%, or ±4.5%, or ±5.0%. The viscosity of the liquid concentrate dispersion 201 of Example 26 may be in the range of about 1800 cP to about 2200 cP, for example about 1950 cP.

TABLE 52
Liquid Concentrate Dispersion according to Example 26

| | Weight Percent of |
|---|---|
| | Each Ingredient in |
| | Liquid Concentrate |
| Ingredient | Dispersion |
| MAP | 42.079% |
| DAP | 5.143% |
| DSP | 2.845% |
| Thickening agent-Polysaccharide Gum | 1.462% |
| Thickening agent-Clay | 1.393% |
| Fluorescent Pigment | 1.253% |
| Corrosion Inhibitor (approximately 40% | 0.453% |
| water) | |
| Corrosion Inhibitor | 0.104% |
| Inorganic Pigment | 0.124% |
| Surfactant | 0.124% |
| DPG-ME | 44.989% |
| Water | 0.000% |
| Total Weight of Liquid | 100% |
| Concentrate Dispersion | |

In Example 26, the final diluted product 202 was prepared by mixing approximately 5.2 gallons of water with 1 gallon of the liquid concentrate dispersion. The amounts of the ingredients in the Example 26 final diluted product 202 are listed in Table 53 below. The values in Table 53 can be varied by ±0.01%, or ±0.05%, or ±0.1%, or ±0.5%, or ±1.0%, or ±1.5%, or ±2%, or ±2.5%, or ±3.0%, or ±3.5%, or ±4.0%, or ±4.5%, or ±5.0%. The concentration of salt in the Example 26 final diluted product 202 is about 5% to 20% by weight in water, preferably about 6% to 18%, more preferably about 7% to 16%. For example, the weight percent of salt in the Example 26 final diluted product 202 is about 10.1%±1.0%.

TABLE 53
Final Diluted Product according to Example 26

| | Weight Percent of |
|---|---|
| | Each Ingredient in |
| | Final Diluted |
| Ingredient | Product |
| MAP | 8.460% |
| DAP | 1.034% |
| DSP | 0.572% |
| Thickening agent-Polysaccharide Gum | 0.300% |
| Thickening agent-Clay | 0.280% |
| Fluorescent Pigment | 0.252% |
| Corrosion Inhibitor (approximately 40% | 0.091% |
| water) | |
| Corrosion Inhibitor | 0.021% |
| Inorganic Pigment | 0.025% |
| Surfactant | 0.025% |
| DPG-ME | 9.045% |
| Water | 79.895% |
| Total Weight of Final Diluted Product | 100% |

The density of the final diluted product 202 of Example 26 may be in the range of about 0.8 g/mL to about 1.5 g/mL, for example about 0.9 g/mL to about 1.4 g/mL. The pH of the final diluted product 202 of Example 26 may be in the range of about 5.0 to about 6.0, for example about 5.4. The viscosity of the final diluted product 202 of Example 26 may be in the range of about 150 cP to about 400 cP, for example about 227 cP.

### Example 27

In Example 27, a liquid concentrate dispersion was prepared containing the amounts of ingredients listed in Table 54 below. The values in Table 54 can be varied by ±0.01% or ±0.05%, or ±0.1% or ±0.5%,or ±1.0%,or ±1.5%,or ±2%,or ±2.5%, or ±3.0%, or ±3.5%, or ±4.0%, or ±4.5%, or ±5.0%. The viscosity of the liquid concentrate dispersion 201 of Example 27 may be in the range of about 20 cP to about 200 cP, for example about 48 cP.

TABLE 54
Liquid Concentrate Dispersion according to Example 27

| | Weight Percent of |
|---|---|
| | Each Ingredient in |
| | Liquid Concentrate |
| Ingredient | Dispersion |
| Na₂CO₃ | 2.448% |
| NaHCO₃ | 46.512% |
| MSP | 2.448% |
| Thickening agent-Polysaccharide Gum | 1.224% |
| Fluorescent Pigment | 1.224% |
| Corrosion Inhibitor (approximately 40% | 1.469% |
| water) | |
| Inorganic Pigment | 0.122% |
| Surfactant | 0.245% |
| DPG-ME | 44.308% |
| Water | 0.000% |
| Total Weight of Liquid | 100% |
| Concentrate Dispersion | |

In Example 27, the final diluted product 202 was prepared by mixing approximately 5.2 gallons of water with 1 gallon of the liquid concentrate dispersion. The amounts of the ingredients in the Example 27 final diluted product 202 are listed in Table 55 below. The values in Table 55 can be varied by ±0.01%, or ±0.05%, or ±0.1%, or ±0.5%, or ±1.0%, or ±1.5%, or ±2%, or ±2.5%, or ±3.0%, or ±3.5%, or ±4.0%, or ±4.5%, or ±5.0%. The concentration of salt in the Example 27 final diluted product 202 is about 5% to 20% by weight in water, preferably about 6% to 18%, more preferably about 7% to 16%. For example, the weight percent of salt in the Example 27 final diluted product 202 is about 10.5%±1.0%.

TABLE 55
Final Diluted Product according to Example 27

| | Weight Percent of |
|---|---|
| | Each Ingredient in |
| | Final Diluted |
| Ingredient | Product |
| Na₂CO₃ | 0.500% |
| NaHCO₃ | 9.500% |
| MSP | 0.500% |
| Thickening agent-Polysaccharide Gum | 0.250% |
| Fluorescent Pigment | 0.250% |
| Corrosion Inhibitor (approximately 40% | 0.250% |
| water) | 0.300% |
| Inorganic Pigment | 0.025% |
| Surfactant | 0.050% |
| DPG-ME | 9.050% |
| Water | 79.575% |
| Total Weight of Final Diluted Product | 100% |

The density of the final diluted product 202 of Example 27 may be in the range of about 0.8 g/mL to about 1.5 g/mL, for example about 0.9 g/mL to about 1.4 g/mL. The pH of the final diluted product 202 of Example 27 may be in the range of about 8.0 to about 9.0, for example about 8.4. The viscosity of the final diluted product 202 of Example 27 may be in the range of about 150 cP to about 400 cP, for example about 188 cP.

### Example 28

In Example 28, a liquid concentrate dispersion was prepared containing the amounts of ingredients listed in Table 56 below. The values in Table 56 can be varied by ±0.01%, or ±0.05%, or ±0.1%, or ±0.5%, or ±1.0%, or ±1.5%, or ±2%, or ±2.5%, or ±3.0%, or ±3.5%, or ±4.0%, or ±4.5%, or ±5.0%. The viscosity of the liquid concentrate dispersion 201 of Example 28 may be in the range of about 8000 cP to about 12,000 cP, for example greater than about 10,000 cP.

TABLE 56
Liquid Concentrate Dispersion according to Example 28

| | Weight Percent of |
|---|---|
| | Each Ingredient in |
| | Liquid Concentrate |
| Ingredient | Dispersion |
| CaCl₂ | 52.569% |
| Thickening agent-Polysaccharide Gum | 1.195% |
| Fluorescent Pigment | 1.195% |
| Corrosion Inhibitor (approximately 40% | 1.434% |
| water) | |
| Inorganic Pigment | 0.119% |
| Surfactant | 0.239% |
| DPG-ME | 43.250% |
| Water | 0.000% |
| Total Weight of Liquid | 100% |
| Concentrate Dispersion | |

In Example 28, the final diluted product 202 was prepared by mixing approximately 4.8 gallons of water with 1 gallon of the liquid concentrate dispersion. The amounts of the ingredients in the Example 28 final diluted product 202 are listed in Table 57 below. The values in Table 57 can be varied by ±0.01%, or ±0.05%, or ±0.1%, or ±0.5%, or ±1.0%, or ±1.5%, or ±2%, or ±2.5%, or ±3.0%, or ±3.5%, or ±4.0%, or ±4.5%, or ±5.0%. The concentration of salt in the Example 28 final diluted product 202 is about 5% to 20% by weight in water, preferably about 6% to 18%, more preferably about 7% to 16%. For example, the weight percent of salt in the Example 28 final diluted product 202 is about 11.0%±1.0%.

TABLE 57
Final Diluted Product according to Example 28

| | Weight Percent of |
|---|---|
| | Each Ingredient in |
| | Final Diluted |
| Ingredient | Product |
| CaCl₂ | 11.000% |
| Thickening agent-Polysaccharide Gum | 0.250% |
| Fluorescent Pigment | 0.250% |
| Corrosion Inhibitor (approximately 40% | 0.300% |
| water) | |
| Inorganic Pigment | 0.025% |
| Surfactant | 0.050% |
| DPG-ME | 9.050% |
| Water | 79.075% |
| Total Weight of Final Diluted | 100% |
| Product | |

The density of the final diluted product 202 of Example 28 may be in the range of about 0.8 g/mL to about 1.5 g/mL, for example about 0.9 g/mL to about 1.4 g/mL. The pH of the final diluted product 202 of Example 28 may be in the range of about 7.5 to about 8.5, for example about 8.0. The viscosity of the final diluted product 202 of Example 28 may be in the range of about 150 cP to about 400 cP, for example about 164 cP.

### Example 29

In Example 29, a liquid concentrate dispersion was prepared containing the amounts of ingredients listed in Table 58 below. The values in Table 58 can be varied by ±0.01% or ±0.05%, or ±0.1% or ±0.5%,or ±1.0%,or ±1.5%,or ±2%,or ±2.5%, or ±3.0%, or ±3.5%, or ±4.0%, or ±4.5%, or ±5.0%. The viscosity of the liquid concentrate dispersion 201 of Example 29 may be in the range of about 8000 cP to about 12,000 cP, for example greater than about 10,000 cP.

TABLE 58
Liquid Concentrate Dispersion according to Example 29

| | Weight Percent of |
|---|---|
| | Each Ingredient in |
| | Liquid Concentrate |
| Ingredient | Dispersion Product |
| Mg(OH)₂ | 54.732% |
| Thickening Agent-Polysaccharide Gum | 1.140% |
| Fluorescent Pigment | 1.140% |
| Corrosion Inhibitor (approximately 40% | 1.368% |
| water) | |
| Inorganic Pigment | 0.114% |
| Surfactant | 0.228% |
| DPG-ME | 41.277% |
| Water | 0.000% |
| Total Weight of Final Diluted Product | 100% |

In Example 29, the final diluted product 202 was prepared by mixing approximately 4.9 gallons of water with 1 gallon of the liquid concentrate dispersion. The amounts of the ingredients in the Example 29 final diluted product 202 are listed in Table 59 below. The values in Table 59 can be varied by ±0.01%, or ±0.05%, or ±0.1%, or ±0.5%, or ±1.0%, or ±1.5%, or ±2%, or ±2.5%, or ±3.0%, or ±3.5%, or ±4.0%, or ±4.5%, or ±5.0%. The concentration of salt in the Example 29 final diluted product 202 is about 5% to 20% by weight in water, preferably about 6% to 18%, more preferably about 7% to 16%. For example, the weight percent of salt in the Example 29 final diluted product 202 is about 12.0%±1.0%.

TABLE 59
Final Diluted Product according to Example 29

| | Weight Percent of |
|---|---|
| | Each Ingredient in |
| | Final Diluted |
| Ingredient | Product |
| Mg(OH)₂ | 12.000% |
| Thickening Agent-Polysaccharide Gum | 0.250% |
| Fluorescent Pigment | 0.250% |
| Corrosion Inhibitor (approximately 40% | 0.300% |
| water) | |
| Inorganic Pigment | 0.025% |
| Surfactant | 0.050% |
| DPG-ME | 9.050% |
| Water | 78.075% |
| Total Weight of Final Diluted Product | 100% |

The density of the final diluted product 202 of Example 29 may be in the range of about 0.8 g/mL to about 1.5 g/mL, for example about 0.9 g/mL to about 1.4 g/mL. The pH of the final diluted product 202 of Example 29 may be in the range of about 9.0 to about 10.0, for example about 9.7. The viscosity of the final diluted product 202 of Example 29 may be in the range of about 100 cP to about 400 cP, for example about 145 cP.

### Example 30

In Example 30, a liquid concentrate dispersion was prepared containing the amounts of ingredients listed in Table 60 below. The values in Table 60 can be varied by ±0.01%, or ±0.05%, or ±0.1%, or ±0.5%, or ±1.0%, or ±1.5%, or ±2%, or ±2.5%, or ±3.0%, or ±3.5%, or ±4.0%, or ±4.5%, or ±5.0%. The viscosity of the liquid concentrate dispersion 201 of Example 30 may be in the range of about 800 cP to about 1200 cP, for example about 1168 cP.

TABLE 60
Liquid Concentrate Dispersion according to Example 30

| | Weight Percent of Each Ingredient |
|---|---|
| Ingredient | in Liquid Concentrate Dispersion |
| C₂K₂O₄ | 50.000% |
| Thickening Agent-Polysaccharide Gum | 1.250% |
| Fluorescent Pigment | 1.250% |
| Corrosion Inhibitor (approximately | 1.500% |
| 40% water) | |
| Inorganic Pigment | 0.150% |
| Surfactant | 0.500% |
| PEG-400 | 45.250% |
| Water | 0.000% |
| Total Weight of Liquid Concentrate | 100% |
| Dispersion | |

In Example 30, the final diluted product 202 was prepared by mixing approximately 5.9 gallons of water with 1 gallon of liquid concentrate dispersion. The amounts of the ingredients in the Example 30 final diluted product 202 are listed in Table 61 below. The values in Table 61 can be varied by ±0.01%, or ±0.05%, or ±0.1%, or ±0.5%, or ±1.0%, or ±1.5%, or ±2%, or ±2.5%, or ±3.0%, or ±3.5%, or ±4.0%, or ±4.5%, or ±5.0%. The concentration of salt in the Example 30 final diluted product 202 is about 5% to 20% by weight in water, preferably about 6% to 18%, more preferably about 7% to 16%. For example, the weight percent of salt in the Example 30 final diluted product 202 is about 10.0%±1.0%.

TABLE 61
Final Diluted Product according to Example 30

| | Weight Percent of |
|---|---|
| | Each Ingredient in |
| | Final Diluted |
| Ingredient | Product |
| C₂K₂O₄ | 10.000% |
| Thickening Agent-Polysaccharide Gum | 0.250% |
| Fluorescent Pigment | 0.250% |
| Corrosion Inhibitor (approximately 40% | 0.300% |
| water) | |
| Inorganic Pigment | 0.030% |
| Surfactant | 0.100% |
| PEG-400 | 9.050% |
| Water | 80.020% |
| Total Weight of Final Diluted Product | 100% |

The density of the final diluted product 202 of Example 30 may be in the range of about 0.8 g/mL to about 1.5 g/mL, for example about 0.9 g/mL to about 1.4 g/mL. The pH of the final diluted product 202 of Example 30 may be in the range of about 8.5 to about 9.5, for example about 8.9. The viscosity of the final diluted product 202 of Example 30 may be in the range of about 150 cP to about 400 cP, for example about 189 cP.

### Example 31

In Example 31, a liquid concentrate dispersion was prepared containing the amounts of ingredients listed in Table 62 below. The values in Table 62 can be varied by ±0.01% or ±0.05%, or ±0.1% or ±0.5%,or ±1.0%,or ±1.5%,or ±2%,or ±2.5%, or ±3.0%, or ±3.5%, or ±4.0%, or ±4.5%, or ±5.0%. The viscosity of the liquid concentrate dispersion 201 of Example 31 may be in the range of about 600 cP to about 1000 cP, for example about 748 cP.

TABLE 62
Liquid Concentrate Dispersion according to Example 31

| | Weight Percent of Each Ingredient |
|---|---|
| Ingredient | in Liquid Concentrate Dispersion |
| MAP | 42.843% |
| DAP | 5.292% |
| DSP | 2.873% |
| Thickening Agent-Polysaccharide Gum 1 | 1.260% |
| Thickening Agent-Polysaccharide Gum 2 | 0.076% |
| Fluorescent Pigment | 1.260% |
| Corrosion Inhibitor (approximately | 0.454% |
| 40% water) | |
| Corrosion Inhibitor | 0.101% |
| Inorganic Pigment | 0.101% |
| Surfactant | 0.126% |
| Propylene Glycol | 45.615% |
| Water | 0.000% |
| Total Weight of Liquid Concentrate | 100% |
| Dispersion | |

In Example 31, the final diluted product 202 was prepared by mixing approximately 5.6 gallons of water with 1 gallon of the liquid concentrate dispersion. The amounts of the ingredients in the Example 31 final diluted product 202 are listed in Table 63 below. The values in Table 63 can be varied by ±0.01%, or ±0.05%, or ±0.1%, or ±0.5%, or ±1.0%, or ±1.5%, or ±2%, or ±2.5%, or ±3.0%, or ±3.5%, or ±4.0%, or ±4.5%, or ±5.0%. The concentration of salt in the Example 31 final diluted product 202 is about 5% to 20% by weight in water, preferably about 6% to 18%, more preferably about 7% to 16%. For example, the weight percent of salt in the Example 31 final diluted product 202 is about 10.1%±1.0%.

TABLE 63
Final Diluted Product according to Example 31

| | Weight Percent of |
|---|---|
| | Each Ingredient in |
| | Final Diluted |
| Ingredient | Product |
| MAP | 8.500% |
| DAP | 1.050% |
| DSP | 0.570% |
| Thickening Agent-Polysaccharide Gum 1 | 0.250% |
| Thickening Agent-Polysaccharide Gum 2 | 0.015% |
| Fluorescent Pigment | 0.250% |
| Corrosion Inhibitor (approximately 40% | 0.090% |
| water) | |
| Corrosion Inhibitor | 0.020% |
| Inorganic Pigment | 0.020% |
| Surfactant | 0.025% |
| Propylene Glycol | 9.050% |
| Water | 80.160% |
| Total Weight of Final Diluted Product | 100% |

The density of the final diluted product 202 of Example 31 may be in the range of about 0.8 g/mL to about 1.5 g/mL, for example about 0.9 g/mL to about 1.4 g/mL. The pH of the final diluted product 202 of Example 31 may be in the range of about 5.0 to about 6.0, for example about 5.35. The viscosity of the final diluted product 202 of Example 31 may be in the range of about 150 cP to about 300 cP, for example about 186 cP.

### Example 32

In Example 32, a liquid concentrate dispersion was prepared containing the amounts of ingredients listed in Table 64 below. The values in Table 64 can be varied by ±0.01% or ±0.05%, or ±0.1% or ±0.5%,or ±1.0%,or ±1.5%,or ±2%,or ±2.5%, or ±3.0%, or ±3.5%, or ±4.0%, or ±4.5%, or ±5.0%. The viscosity of the liquid concentrate dispersion 201 of Example 32 may be in the range of about 400 cP to about 800 cP, for example about 622 cP.

TABLE 64
Liquid Concentrate Dispersion according to Example 32

| | Weight Percent of Each Ingredient |
|---|---|
| Ingredient | in Liquid Concentrate Dispersion |
| MAP | 42.832% |
| DAP | 5.291% |
| DSP | 2.872% |
| Thickening Agent-Polysaccharide Gum 1 | 1.260% |
| Thickening Agent-Polysaccharide Gum 2 | 0.101% |
| Fluorescent Pigment | 1.260% |
| Corrosion Inhibitor (approximately | 0.454% |
| 40% water) | |
| Corrosion Inhibitor | 0.101% |
| Inorganic Pigment | 0.101% |
| Surfactant | 0.126% |
| Propylene Glycol | 45.603% |
| Water | 0.000% |
| Total Weight of Liquid Concentrate | 100% |
| Dispersion | |

In Example 32, the final diluted product 202 was prepared by mixing approximately 5.6 gallons of water with 1 gallon of the liquid concentrate dispersion. The amounts of the ingredients in the Example 32 final diluted product 202 are listed in Table 65 below. The values in Table 65 can be varied by ±0.01%, or ±0.05%, or ±0.1%, or ±0.5%, or ±1.0%, or ±1.5%, or ±2%, or ±2.5%, or ±3.0%, or ±3.5%, or ±4.0%, or ±4.5%, or ±5.0%. The concentration of salt in the Example 32 final diluted product 202 is about 5% to 20% by weight in water, preferably about 6% to 18%, more preferably about 7% to 16%. For example, the weight percent of salt in the Example 32 final diluted product 202 is about 10.1%±1.0%.

TABLE 65
Final Diluted Product according to Example 32

| | Weight Percent of |
|---|---|
| | Each Ingredient in |
| | Final Diluted |
| Ingredient | Product |
| MAP | 8.500% |
| DAP | 1.050% |
| DSP | 0.570% |
| Thickening Agent-Polysaccharide Gum 1 | 0.250% |
| Thickening Agent-Polysaccharide Gum 2 | 0.020% |
| Fluorescent Pigment | 0.250% |
| Corrosion Inhibitor (approximately 40% | 0.090% |
| water) | |
| Corrosion Inhibitor | 0.020% |
| Inorganic Pigment | 0.020% |
| Surfactant | 0.025% |
| Propylene Glycol | 9.050% |
| Water | 80.155% |
| Total Weight of Final Diluted Product | 100% |

The density of the final diluted product 202 of Example 32 may be in the range of about 0.8 g/mL to about 1.5 g/mL, for example about 0.9 g/mL to about 1.4 g/mL. The pH of the final diluted product 202 of Example 32 may be in the range of about 5.0 to about 6.0, for example about 5.45. The viscosity of the final diluted product 202 of Example 32 may be in the range of about 150 cP to about 400 cP, for example about 235 cP.

### Example 33

In Example 33, a liquid concentrate dispersion was prepared containing the amounts of ingredients listed in Table 66 below. The values in Table 66 can be varied by ±0.01% or ±0.05%, or ±0.1% or ±0.5%,or ±1.0%,or ±1.5%,or ±2%,or ±2.5%, or ±3.0%, or ±3.5%, or ±4.0%, or ±4.5%, or ±5.0%. The viscosity of the liquid concentrate dispersion 201 of Example 33 may be in the range of about 2000 cP to about 5000 cP, for example about 3500 cP.

TABLE 66
Liquid Concentrate Dispersion according to Example 33

| | Weight Percent of Each Ingredient |
|---|---|
| Ingredient | in Liquid Concentrate Dispersion |
| MAP | 50.631% |
| DAP | 6.254% |
| DSP | 3.395% |
| Thickening Agent-Polysaccharide Gum 1 | 1.489% |
| Thickening Agent-Polysaccharide Gum 2 | 0.077% |
| Fluorescent Pigment | 1.489% |
| Corrosion Inhibitor (approximately | 0.536% |
| 40% water) | |
| Corrosion Inhibitor | 0.119% |
| Inorganic Pigment | 0.119% |
| Surfactant | 0.149% |
| Propylene Glycol | 35.740% |
| Water | 0.000% |
| Total Weight of Liquid Concentrate | 100% |
| Dispersion | |

In Example 33, the final diluted product 202 was prepared by mixing approximately 7.1 gallons of water with 1 gallon of the liquid concentrate dispersion. The amounts of the ingredients in the Example 33 final diluted product 202 are listed in Table 67 below. The values in Table 67 can be varied by ±0.01%, or ±0.05%, or ±0.1%, or ±0.5%, or ±1.0%, or ±1.5%, or ±2%, or ±2.5%, or ±3.0%, or ±3.5%, or ±4.0%, or ±4.5%, or ±5.0%. The concentration of salt in the Example 33 final diluted product 202 is about 5% to 20% by weight in water, preferably about 6% to 18%, more preferably about 7% to 16%. For example, the weight percent of salt in the Example 33 final diluted product 202 is about 10.1%±1.0%.

TABLE 67
Final Diluted Product according to Example 33

| | Weight Percent of |
|---|---|
| | Each Ingredient in |
| | Final Diluted |
| Ingredient | Product |
| MAP | 8.500% |
| DAP | 1.050% |
| DSP | 0.570% |
| Thickening Agent-Polysaccharide Gum 1 | 0.250% |
| Thickening Agent-Polysaccharide Gum 2 | 0.013% |
| Fluorescent Pigment | 0.250% |
| Corrosion Inhibitor (approximately 40% | 0.090% |
| water) | |
| Corrosion Inhibitor | 0.020% |
| Inorganic Pigment | 0.020% |
| Surfactant | 0.025% |
| Propylene Glycol | 6.000% |
| Water | 83.212% |
| Total Weight of Final Diluted Product | 100% |

The density of the final diluted product 202 of Example 33 may be in the range of about 0.8 g/mL to about 1.5 g/mL, for example about 0.9 g/mL to about 1.4 g/mL. The pH of the final diluted product 202 of Example 33 may be in the range of about 5.0 to about 6.0, for example about 5.3. The N/P molar ratio of the final diluted product 202 of Example 33 may be in the range of about 0.6 to about 2.0, for example about 1.0. The viscosity of the final diluted product 202 of Example 33 may be in the range of about 150 cP to about 400 cP, for example about 192 cP.

### Example 34

In Example 34, a liquid concentrate dispersion was prepared containing the amounts of ingredients listed in Table 68 below. The values in Table 68 can be varied by ±0.01% or ±0.05%, or ±0.1% or ±0.5%,or ±1.0%,or ±1.5%,or ±2%,or ±2.5%, or ±3.0%, or ±3.5%, or ±4.0%, or ±4.5%, or ±5.0%. The viscosity of the liquid concentrate dispersion 201 of Example 34 may be in the range of about 400 cP to about 800 cP, for example about 674 cP.

TABLE 68
Liquid Concentrate Dispersion according to Example 34

| | Weight Percent of Each Ingredient |
|---|---|
| Ingredient | in Liquid Concentrate Dispersion |
| MAP | 46.479% |
| DAP | 5.741% |
| DSP | 3.117% |
| Thickening Agent-Polysaccharide Gum 1 | 1.367% |
| Thickening Agent-Polysaccharide Gum 2 | 0.071% |
| Fluorescent Pigment | 1.367% |
| Corrosion Inhibitor (approximately | 0.492% |
| 40% water) | |
| Corrosion Inhibitor | 0.109% |
| Inorganic Pigment | 0.109% |
| Surfactant | 0.137% |
| Propylene Glycol | 41.010% |
| Water | 0.000% |
| Total Weight of Liquid Concentrate | 100% |
| Dispersion | |

In Example 34, the final diluted product 202 was prepared by mixing approximately 6.2 gallons of water with 1 gallon of the liquid concentrate dispersion. The amounts of the ingredients in the Example 34 final diluted product 202 are listed in Table 69 below. The values in Table 69 can be varied by ±0.01%, or ±0.05%, or ±0.1%, or ±0.5%, or ±1.0%, or ±1.5%, or ±2%, or ±2.5%, or ±3.0%, or ±3.5%, or ±4.0%, or ±4.5%, or ±5.0%. The concentration of salt in the Example 34 final diluted product 202 is about 5% to 20% by weight in water, preferably about 6% to 18%, more preferably about 7% to 16%. For example, the weight percent of salt in the Example 34 final diluted product 202 is about 10.1%±1.0%.

TABLE 69
Final Diluted Product according to Example 34

| | Weight Percent of |
|---|---|
| | Each Ingredient in |
| | Final Diluted |
| Ingredient | Product |
| MAP | 8.500% |
| DAP | 1.050% |
| DSP | 0.570% |
| Thickening Agent-Polysaccharide Gum 1 | 0.250% |
| Thickening Agent-Polysaccharide Gum 2 | 0.013% |
| Fluorescent Pigment | 0.250% |
| Corrosion Inhibitor (approximately 40% | 0.090% |
| water) | |
| Corrosion Inhibitor | 0.020% |
| Inorganic Pigment | 0.020% |
| Surfactant | 0.025% |
| Propylene Glycol | 7.500% |
| Water | 81.712% |
| Total Weight of Final Diluted Product | 100% |

The density of the final diluted product 202 of Example 34 may be in the range of about 0.8 g/mL to about 1.5 g/mL, for example about 0.9 g/mL to about 1.4 g/mL. The pH of the final diluted product 202 of Example 34 may be in the range of about 5.0 to about 6.0, for example about 5.3. The N/P molar ratio of the final diluted product 202 of Example 34 may be in the range of about 0.6 to about 2.0, for example about 1.0. The viscosity of the final diluted product 202 of Example 34 may be in the range of about 150 cP to about 400 cP, for example about 209 cP.

### Example 35

In Example 35, a liquid concentrate dispersion was prepared containing the amounts of ingredients listed in Table 70 below. The values in Table 70 can be varied by ±0.01% or ±0.05%, or ±0.1% or ±0.5%,or ±1.0%,or ±1.5%,or ±2%,or ±2.5%, or ±3.0%, or ±3.5%, or ±4.0%, or ±4.5%, or ±5.0%. The viscosity of the liquid concentrate dispersion 201 of Example 35 may be in the range of about 200 cP to about 500 cP, for example about 342 cP.

TABLE 70
Liquid Concentrate Dispersion according to Example 35

| | Weight Percent of Each Ingredient |
|---|---|
| Ingredient | in Liquid Concentrate Dispersion |
| MAP | 43.154% |
| DAP | 5.250% |
| DSP | 0.510% |
| Thickening Agent-Polysaccharide Gum | 3.061% |
| Fluorescent Pigment | 1.275% |
| Corrosion Inhibitor (approximately | 0.459% |
| 40% water) | |
| Corrosion Inhibitor | 0.102% |
| Surfactant | 0.128% |
| DPG-ME | 46.061% |
| Water | 0.000% |
| Total Weight of Liquid Concentrate | 100% |
| Dispersion | |

In Example 35, the final diluted product 202 was prepared by mixing approximately 5.2 gallons of water with 1 gallon of the liquid concentrate dispersion. The amounts of the ingredients in the Example 35 final diluted product 202 are listed in Table 71 below. The values in Table 71 can be varied by ±0.01%, or ±0.05%, or ±0.1%, or ±0.5%, or ±1.0%, or ±1.5%, or ±2%, or ±2.5%, or ±3.0%, or ±3.5%, or ±4.0%, or ±4.5%, or ±5.0%. The concentration of salt in the Example 35 final diluted product 202 is about 5% to 20% by weight in water, preferably about 6% to 18%, more preferably about 7% to 16%. For example, the weight percent of salt in the Example 35 final diluted product 202 is about 9.6%±1.0%.

TABLE 71
Final Diluted Product according to Example 35

| | Weight Percent of |
|---|---|
| | Each Ingredient in |
| | Final Diluted |
| Ingredient | Product |
| MAP | 8.460% |
| DAP | 1.029% |
| DSP | 0.100% |
| Thickening Agent-Polysaccharide Gum | 0.600% |
| Fluorescent Pigment | 0.250% |
| Corrosion Inhibitor (approximately 40% | 0.090% |
| water) | |
| Corrosion Inhibitor | 0.020% |
| Surfactant | 0.025% |
| DPG-ME | 9.030% |
| Water | 80.396% |
| Total Weight of Final Diluted Product | 100% |

The density of the final diluted product 202 of Example 35 may be in the range of about 0.8 g/mL to about 1.5 g/mL, for example about 0.9 g/mL to about 1.4 g/mL. The pH of the final diluted product 202 of Example 35 may be in the range of about 5.0 to about 6.0, for example about 5.42. The N/P molar ratio of the final diluted product 202 of Example 35 may be in the range of about 0.6 to about 2.0, for example about 1.1. The viscosity of the final diluted product 202 of Example 35 may be in the range of about 200 cP to about 400 cP, for example about 284 cP.

### Example 36

In Example 36, a liquid concentrate dispersion was prepared containing the amounts of ingredients listed in Table 72 below. The values in Table 72 can be varied by ±0.01% or ±0.05%, or ±0.1% or ±0.5%,or ±1.0%,or ±1.5%,or ±2%,or ±2.5%, or ±3.0%, or ±3.5%, or ±4.0%, or ±4.5%, or ±5.0%. The viscosity of the liquid concentrate dispersion 201 of Example 36 may be in the range of about 1000 cP to about 1400 cP, for example about 1204 cP.

TABLE 72
Liquid Concentrate Dispersion according to Example 36

| | Weight Percent of Each Ingredient |
|---|---|
| Ingredient | in Liquid Concentrate Dispersion |
| MAP | 42.503% |
| DAP | 5.171% |
| DSP | 0.502% |
| Thickening Agent-Polysaccharide Gum | 3.014% |
| Thickening Agent-Silica | 1.507% |
| Fluorescent Pigment | 1.256% |
| Corrosion Inhibitor (approximately | 0.452% |
| 40% water) | |
| Corrosion Inhibitor | 0.100% |
| Surfactant | 0.126% |
| DPG-ME | 45.367% |
| Water | 0.000% |
| Total Weight of Liquid Concentrate | 100% |
| Dispersion | |

In Example 36, the final diluted product 202 was prepared by mixing approximately 5.1 gallons of water in 1 gallon of the liquid concentrate dispersion. The amounts of the ingredients in the Example 36 final diluted product 202 are listed in Table 73 below. The values in Table 73 can be varied by ±0.01%, or ±0.05%, or ±0.1%, or ±0.5%, or ±1.0%, or ±1.5%, or ±2%, or ±2.5%, or ±3.0%, or ±3.5%, or ±4.0%, or ±4.5%, or ±5.0%. The concentration of salt in the Example 36 final diluted product 202 is about 5% to 20% by weight in water, preferably about 6% to 18%, more preferably about 7% to 16%. For example, the weight percent of salt in the Example 36 final diluted product 202 is about 9.6%±1.0%.

TABLE 73
Final Diluted Product according to Example 36

| | Weight Percent of |
|---|---|
| | Each Ingredient in |
| | Final Diluted |
| Ingredient | Product |
| MAP | 8.460% |
| DAP | 1.029% |
| DSP | 0.100% |
| Thickening Agent - Polysaccharide Gum | 0.600% |
| Thickening Agent - Silica | 0.300% |
| Fluorescent Pigment | 0.250% |
| Corrosion Inhibitor (approximately 40% water) | 0.090% |
| Corrosion Inhibitor | 0.020% |
| Surfactant | 0.025% |
| DPG-ME | 9.030% |
| Water | 80.096% |
| Total Weight of Final Diluted Product | 100% |

The density of the final diluted product 202 of Example 36 may be in the range of about 0.8 g/mL to about 1.5 g/mL, for example about 0.9 g/mL to about 1.4 g/mL. The pH of the final diluted product 202 of Example 36 may be in the range of about 5.0 to about 6.0, for example about 5.40. The N/P molar ratio of the final diluted product 202 of Example 36 may be in the range of about 0.6 to about 2.0, for example about 1.1. The viscosity of the final diluted product 202 of Example 36 may be in the range of about 250 cP to about 450 cP, for example about 321 cP.

### Example 37

In Example 37, a liquid concentrate dispersion was prepared containing the amounts of ingredients listed in Table 74 below. The values in Table 74 can be varied by ±0.01% or ±0.05%, or ±0.1% or ±0.5%,or ±1.0%,or ±1.5%,or ±2%,or ±2.5%, or ±3.0%, or ±3.5%, or ±4.0%, or ±4.5%, or ±5.0%. The viscosity of the liquid concentrate dispersion 201 of Example 37 may be in the range of about 4000 cP to about 8000 cP, for example about 5620 cP.

TABLE 74
Liquid Concentrate Dispersion according to Example 37

| | Weight Percent of Each |
|---|---|
| | Ingredient in Liquid |
| Ingredient | Concentrate Dispersion |
| MAP | 42.060% |
| DAP | 5.117% |
| DSP | 0.497% |
| Thickening Agent - Polysaccharide Gum | 2.983% |
| Thickening Agent - Silica | 2.536% |
| Fluorescent Pigment | 1.243% |
| Corrosion Inhibitor (approximately 40% water) | 0.447% |
| Corrosion Inhibitor | 0.099% |
| Surfactant | 0.124% |
| DPG-ME | 44.894% |
| Water | 0.000% |
| Total Weight of Liquid Concentrate Dispersion | 100% |

In Example 37, the final diluted product 202 was prepared by mixing approximately 5.0 gallons of water with 1 gallon of the liquid concentrate dispersion. The amounts of the ingredients in the Example 37 final diluted product 202 are listed in Table 75 below. The values in Table 75 can be varied by ±0.01%, or ±0.05%, or ±0.1%, or ±0.5%, or ±1.0%, or ±1.5%, or ±2%, or ±2.5%, or ±3.0%, or ±3.5%, or ±4.0%, or ±4.5%, or ±5.0%. The concentration of salt in the Example 37 final diluted product 202 is about 5% to 20% by weight in water, preferably about 6% to 18%, more preferably about 7% to 16%. For example, the weight percent of salt in the Example 37 final diluted product 202 is about 9.6%±1.0%.

TABLE 75
Final Diluted Product according to Example 37

| | Weight Percent of |
|---|---|
| | Each Ingredient in |
| | Final Diluted |
| Ingredient | Product |
| MAP | 8.460% |
| DAP | 1.029% |
| DSP | 0.100% |
| Thickening Agent - Polysaccharide Gum | 0.600% |
| Thickening Agent - Silica | 0.510% |
| Fluorescent Pigment | 0.250% |
| Corrosion Inhibitor (approximately 40% water) | 0.090% |
| Corrosion Inhibitor | 0.020% |
| Surfactant | 0.025% |
| DPG-ME | 9.030% |
| Water | 79.886% |
| Total Weight of Final Diluted Product | 100% |

The density of the final diluted product 202 of Example 37 may be in the range of about 0.8 g/mL to about 1.5 g/mL, for example about 0.9 g/mL to about 1.4 g/mL. The pH of the final diluted product 202 of Example 37 may be in the range of about 5.0 to about 6.0, for example about 5.36. The N/P molar ratio of the final diluted product 202 of Example 37 may be in the range of about 0.6 to about 2.0, for example about 1.1. The viscosity of the final diluted product 202 of Example 37 may be in the range of about 250 cP to about 450 cP, for example about 335 cP.

### Example 38

In Example 38, a liquid concentrate dispersion was prepared containing the amounts of ingredients listed in Table 76 below. The values in Table 76 can be varied by ±0.01% or ±0.05%, or ±0.1% or ±0.5%,or ±1.0%,or ±1.5%,or ±2%,or ±2.5%, or ±3.0%, or ±3.5%, or ±4.0%, or ±4.5%, or ±5.0%. The viscosity of the liquid concentrate dispersion 201 of Example 38 may be in the range of about 1000 cP to about 5000 cP, for example about 2770 cP.

TABLE 76
Liquid Concentrate Dispersion according to Example 38

| | Weight Percent of Each |
|---|---|
| | Ingredient in Liquid |
| Ingredient | Concentrate Dispersion |
| Mg(OH)₂ | 30.003% |
| Thickening Agent - Polysaccharide Gum | 0.750% |
| Fluorescent Pigment | 0.750% |
| Corrosion Inhibitor (approximately 40% water) | 0.270% |
| Surfactant | 0.060% |
| Water | 68.167% |
| Total Weight of Liquid Concentrate Dispersion | 100% |

In Example 38, the final diluted product 202 was prepared by mixing approximately 2.2 gallons of water with 1 gallon of the liquid concentrate dispersion. The amounts of the ingredients in the Example 38 final diluted product 202 are listed in Table 77 below. The values in Table 77 can be varied by ±0.01%, or ±0.05%, or ±0.1%, or ±0.5%, or ±1.0%, or ±1.5%, or ±2%, or ±2.5%, or ±3.0%, or ±3.5%, or ±4.0%, or ±4.5%, or ±5.0%. The concentration of salt in the Example 38 final diluted product 202 is about 5% to 20% by weight in water, preferably about 6% to 18%, more preferably about 7% to 16%. For example, the weight percent of salt in the Example 38 final diluted product 202 is about 10.0%±1.0%.

TABLE 77
Final Diluted Product according to Example 38

| | Weight Percent of |
|---|---|
| | Each Ingredient in |
| | Final Diluted |
| Ingredient | Product |
| Mg(OH)₂ | 10.000% |
| Thickening Agent - Polysaccharide Gum | 0.250% |
| Fluorescent Pigment | 0.250% |
| Corrosion Inhibitor (approximately 40% water) | 0.090% |
| Surfactant | 0.020% |
| Water | 89.390% |
| Total Weight of Final Diluted Product | 100% |

The density of the final diluted product 202 of Example 38 may be in the range of about 0.8 g/mL to about 1.5 g/mL, for example about 0.9 g/mL to about 1.4 g/mL. The pH of the final diluted product 202 of Example 38 may be in the range of about 10.0 to about 11.0, for example about 10.4. The viscosity of the final diluted product 202 of Example 38 may be in the range of about 100 cP to about 400 cP, for example about 119 cP.

### Example 39

In Example 39, a liquid concentrate dispersion was prepared containing the amounts of ingredients listed in Table 78 below. The values in Table 78 can be varied by ±0.01%, or ±0.05%, or ±0.1%, or ±0.5%, or ±1.0%, or ±1.5%, or ±2%, or ±2.5%, or ±3.0%, or ±3.5%, or ±4.0%, or ±4.5%, or ±5.0%. The viscosity of the liquid concentrate dispersion 201 of Example 39 may be in the range of about 800 cP to about 11.00 cP, for example about 970 cP.

TABLE 78
Liquid Concentrate Dispersion according to Example 39

| | Weight Percent of Each |
|---|---|
| | Ingredient in Liquid |
| Ingredient | Concentrate Dispersion |
| CaCO₃ | 71.225% |
| Thickening Agent - Clay | 0.427% |
| Water | 28.348% |
| Total Weight of Liquid Concentrate Dispersion | 100% |

In Example 39, the final diluted product 202 was prepared by mixing approximately 10.63 gallons of water with 1 gallon of the liquid concentrate dispersion. The amounts of the ingredients in the Example 39 final diluted product 202 are listed in Table 79 below. The values in Table 79 can be varied by ±0.01%, or ±0.05%, or ±0.1%, or ±0.5%, or ±1.0%, or ±1.5%, or ±2%, or ±2.5%, or ±3.0%, or ±3.5%, or ±4.0%, or ±4.5%, or ±5.0%. The concentration of salt in the Example 39 final diluted product 202 is about 5% to 20% by weight in water, preferably about 6% to 18%, more preferably about 7% to 16%. For example, the weight percent of salt in the Example 39 final diluted product 202 is about 10.0%±1.0%.

TABLE 79
Final Diluted Product according to Example 39

| | Weight Percent of |
|---|---|
| | Each Ingredient in |
| | Final Diluted |
| Ingredient | Product |
| CaCO₃ | 10.000% |
| Thickening Agent - Clay | 0.060% |
| Water | 89.940% |
| Total Weight of Final Diluted Product | 100% |

The density of the final diluted product 202 of Example 39 may be in the range of about 0.8 g/mL to about 1.5 g/mL, for example about 0.9 g/mL to about 1.4 g/mL. The pH of the final diluted product 202 of Example 39 may be in the range of about 7.0 to about 8.0, for example about 7.79. The viscosity of the final diluted product 202 of Example 39 may be in the range of about 10 cP to about 200 cP.

### Example 40

In Example 40, a liquid concentrate dispersion was prepared containing the amounts of ingredients listed in Table 80 below. The values in Table 80 can be varied by ±0.01% or ±0.05%, or ±0.1% or ±0.5%,or ±1.0%,or ±1.5%,or ±2%,or ±2.5%, or ±3.0%, or ±3.5%, or ±4.0%, or ±4.5%, or ±5.0%. The viscosity of the liquid concentrate dispersion 201 of Example 40 may be in the range of about 3,000 cP to about 6,000 cP, for example about 5,000 cP.

TABLE 80
Liquid Concentrate Dispersion according to Example 40

| | Weight Percent of Each |
|---|---|
| | Ingredient in Liquid |
| Ingredient | Concentrate Dispersion |
| MAP | 25.302% |
| DAP | 25.302% |
| DSP | 0.253% |
| Thickening Agent - Polysaccharide Gum 1 | 0.030% |
| Thickening Agent - Polysaccharide Gum 2 | 1.265% |
| Fluorescent Pigment | 1.265% |
| Corrosion Inhibitor (approximately 40% water) | 0.455% |
| Corrosion Inhibitor | 0.101% |
| Inorganic Pigment | 0.101% |
| Surfactant | 0.127% |
| Propylene Glycol | 45.797% |
| Water | 0.000% |
| Total Weight of Liquid Concentrate Dispersion | 100% |

In Example 40, the final diluted product 202 was prepared by mixing approximately 5.6 gallons of water with 1 gallon of the liquid concentrate dispersion. The amounts of the ingredients in the Example 40 final diluted product 202 are listed in Table 81 below. The values in Table 81 can be varied by ±0.01%, or ±0.05%, or ±0.1%, or ±0.5%, or ±1.0%, or ±1.5%, or ±2%, or ±2.5%, or ±3.0%, or ±3.5%, or ±4.0%, or ±4.5%, or ±5.0%. The concentration of salt in the Example 40 final diluted product 202 is about 5% to 20% by weight in water, preferably about 6% to 18%, more preferably about 7% to 16%. For example, the weight percent of salt in the Example 40 final diluted product 202 is about 10.1%±1.0%.

TABLE 81
Final Diluted Product according to Example 40

| | Weight Percent of |
|---|---|
| | Each Ingredient in |
| | Final Diluted |
| Ingredient | Product |
| MAP | 5.000% |
| DAP | 5.000% |
| DSP | 0.050% |
| Thickening Agent - Polysaccharide Gum 1 | 0.006% |
| Thickening Agent - Polysaccharide Gum 2 | 0.25% |
| Fluorescent Pigment | 0.25% |
| Corrosion Inhibitor (approximately 40% water) | 0.09% |
| Corrosion Inhibitor | 0.02% |
| Inorganic Pigment | 0.020% |
| Surfactant | 0.025% |
| Propylene Glycol | 9.050% |
| Water | 80.239% |
| Total Weight of Final Diluted Product | 100% |

The density of the final diluted product 202 of Example 40 may be in the range of about 0.8 g/mL to about 1.5 g/mL, for example about 0.9 g/mL to about 1.4 g/mL. The pH of the final diluted product 202 of Example 40 may be in the range of about 6.0 to about 7.0, for example about 6.4. The N/P molar ratio of the final diluted product 202 of Example 40 may be in the range of about 1.0 to about 2.0, for example about 1.5. The viscosity of the final diluted product 202 of Example 40 may be in the range of about 150 cP to about 300 cP, for example about 194 cP.

### Example 41

In Example 41, a liquid concentrate dispersion was prepared containing the amounts of ingredients listed in Table 82 below. The values in Table 82 can be varied by ±0.01%, or ±0.05%, or ±0.1%, or ±0.5%, or ±1.0%, or ±1.5%, or ±2%, or ±2.5%, or ±3.0%, or ±3.5%, or ±4.0%, or ±4.5%, or ±5.0%. The viscosity of the liquid concentrate dispersion 201 of Example 41 may be in the range of about 3,000 cP to about 6,000 cP, for example about 5,000 cP.

TABLE 82
Liquid Concentrate Dispersion according to Example 41

| | Weight Percent of Each |
|---|---|
| | Ingredient in Liquid |
| Ingredient | Concentrate Dispersion |
| MAP | 20.186% |
| DAP | 29.541% |
| MSP | 2.462% |
| Thickening Agent - Polysaccharide Gum 1 | 0.030% |
| Thickening Agent - Polysaccharide Gum 2 | 1.231% |
| Fluorescent Pigment | 1.231% |
| Corrosion Inhibitor (approximately 40% water) | 0.443% |
| Corrosion Inhibitor | 0.098% |
| Inorganic Pigment | 0.098% |
| Surfactant | 0.123% |
| Propylene Glycol | 44.557% |
| Water | 0.000% |
| Total Weight of Liquid Concentrate Dispersion | 100% |

In Example 41, the final diluted product 202 was prepared by mixing approximately 5.4 gallons of water with 1 gallon of the liquid concentrate dispersion. The amounts of the ingredients in the Example 41 final diluted product 202 are listed in Table 83 below. The values in Table 83 can be varied by ±0.01%, or ±0.05%, or ±0.1%, or ±0.5%, or ±1.0%, or ±1.5%, or ±2%, or ±2.5%, or ±3.0%, or ±3.5%, or ±4.0%, or ±4.5%, or ±5.0%. The concentration of salt in the Example 41 final diluted product 202 is about 5% to 20% by weight in water, preferably about 6% to 18%, more preferably about 7% to 16%. For example, the weight percent of salt in the Example 41 final diluted product 202 is about 10.6%±1.0%.

TABLE 83
Final Diluted Product according to Example 41

| | Weight Percent of |
|---|---|
| | Each Ingredient in |
| | Final Diluted |
| Ingredient | Product |
| MAP | 4.100% |
| DAP | 6.000% |
| MSP | 0.500% |
| Thickening Agent - Polysaccharide Gum 1 | 0.006% |
| Thickening Agent - Polysaccharide Gum 2 | 0.25% |
| Fluorescent Pigment | 0.25% |
| Corrosion Inhibitor (approximately 40% water) | 0.09% |
| Corrosion Inhibitor | 0.02% |
| Inorganic Pigment | 0.020% |
| Surfactant | 0.025% |
| Propylene Glycol | 9.050% |
| Water | 79.689% |
| Total Weight of Final Diluted Product | 100% |

The density of the final diluted product 202 of Example 41 may be in the range of about 0.8 g/mL to about 1.5 g/mL, for example about 0.9 g/mL to about 1.4 g/mL. The pH of the final diluted product 202 of Example 41 may be in the range of about 6.0 to about 7.0, for example about 6.6. The N/P molar ratio of the final diluted product 202 of Example 41 may be in the range of about 1.0 to about 2.0, for example about 1.5. The viscosity of the final diluted product 202 of Example 41 may be in the range of about 150 cP to about 300 cP, for example about 190 cP.

### Example 42

In Example 42, a liquid concentrate dispersion was prepared containing the amounts of ingredients listed in Table 84 below. The values in Table 84 can be varied by ±0.01% or ±0.05%, or ±0.1% or ±0.5%,or ±1.0%,or ±1.5%,or ±2%,or ±2.5%, or ±3.0%, or ±3.5%, or ±4.0%, or ±4.5%, or ±5.0%. The viscosity of the liquid concentrate dispersion 201 of Example 42 may be in the range of about 3,000 cP to about 6,000 cP, for example about 5,000 cP.

TABLE 84
Liquid Concentrate Dispersion according to Example 42

| | Weight Percent of Each |
|---|---|
| | Ingredient in Liquid |
| Ingredient | Concentrate Dispersion |
| MAP | 16.658% |
| DAP | 33.315% |
| MSP | 2.450% |
| Thickening Agent - Polysaccharide Gum 1 | 0.029% |
| Thickening Agent - Polysaccharide Gum 2 | 1.225% |
| Fluorescent Pigment | 1.225% |
| Corrosion Inhibitor (approximately 40% water) | 0.441% |
| Corrosion Inhibitor | 0.098% |
| Inorganic Pigment | 0.098% |
| Surfactant | 0.122% |
| Propylene Glycol | 44.339% |
| Water | 0.000% |
| Total Weight of Liquid Concentrate Dispersion | 100% |

In Example 42, the final diluted product 202 was prepared by mixing approximately 5.4 gallons of water with 1 gallon of the liquid concentrate dispersion. The amounts of the ingredients in the Example 42 final diluted product 202 are listed in Table 85 below. The values in Table 85 can be varied by ±0.01%, or ±0.05%, or ±0.1%, or ±0.5%, or ±1.0%, or ±1.5%, or ±2%, or ±2.5%, or ±3.0%, or ±3.5%, or ±4.0%, or ±4.5%, or ±5.0%. The concentration of salt in the Example 42 final diluted product 202 is about 5% to 20% by weight in water, preferably about 6% to 18%, more preferably about 7% to 16%. For example, the weight percent of salt in the Example 42 final diluted product 202 is about 10.7%±1.0%.

TABLE 85
Final Diluted Product according to Example 42

| | Weight Percent of |
|---|---|
| | Each Ingredient in |
| | Final Diluted |
| Ingredient | Product |
| MAP | 3.400% |
| DAP | 6.800% |
| MSP | 0.500% |
| Thickening Agent - Polysaccharide Gum 1 | 0.006% |
| Thickening Agent - Polysaccharide Gum 2 | 0.25% |
| Fluorescent Pigment | 0.25% |
| Corrosion Inhibitor (approximately 40% water) | 0.09% |
| Corrosion Inhibitor | 0.02% |
| Inorganic Pigment | 0.020% |
| Surfactant | 0.025% |
| Propylene Glycol | 9.050% |
| Water | 79.589% |
| Total Weight of Final Diluted Product | 100% |

The density of the final diluted product 202 of Example 42 may be in the range of about 0.8 g/mL to about 1.5 g/mL, for example about 0.9 g/mL to about 1.4 g/mL. The pH of the final diluted product 202 of Example 42 may be in the range of about 6.5 to about 7.5, for example about 6.8. The N/P molar ratio of the final diluted product 202 of Example 42 may be in the range of about 1.0 to about 2.0, for example about 1.6. The viscosity of the final diluted product 202 of Example 42 may be in the range of about 150 cP to about 300 cP, for example about 202 cP.

### Example 43

In Example 43, a liquid concentrate dispersion was prepared containing the amounts of ingredients listed in Table 86 below. The values in Table 86 can be varied by ±0.01% or ±0.05%, or ±0.1% or ±0.5%,or ±1.0%,or ±1.5%,or ±2%,or ±2.5%, or ±3.0%, or ±3.5%, or ±4.0%, or ±4.5%, or ±5.0%. The viscosity of the liquid concentrate dispersion 201 of Example 43 may be in the range of about 3,000 cP to about 6,000 cP, for example about 5,000 cP.

TABLE 86
Liquid Concentrate Dispersion according to Example 43

| | Weight Percent of Each |
|---|---|
| | Ingredient in Liquid |
| Ingredient | Concentrate Dispersion |
| MAP | 28.939% |
| DAP | 14.470% |
| DSP | 13.356% |
| Thickening Agent - Polysaccharide Gum 1 | 0.027% |
| Thickening Agent - Polysaccharide Gum 2 | 1.113% |
| Fluorescent Pigment | 1.113% |
| Corrosion Inhibitor (approximately 40% water) | 0.401% |
| Corrosion Inhibitor | 0.089% |
| Inorganic Pigment | 0.089% |
| Surfactant | 0.111% |
| Propylene Glycol | 40.292% |
| Water | 0.000% |
| Total Weight of Liquid Concentrate Dispersion | 100% |

In Example 43, the final diluted product 202 was prepared by mixing approximately 4.8 gallons of water with 1 gallon of the liquid concentrate dispersion. The amounts of the ingredients in the Example 43 final diluted product 202 are listed in Table 87 below. The values in Table 87 can be varied by ±0.01%, or ±0.05%, or ±0.1%, or ±0.5%, or ±1.0%, or ±1.5%, or ±2%, or ±2.5%, or ±3.0%, or ±3.5%, or ±4.0%, or ±4.5%, or ±5.0%. The concentration of salt in the Example 43 final diluted product 202 is about 5% to 20% by weight in water, preferably about 6% to 18%, more preferably about 7% to 16%. For example, the weight percent of salt in the Example 43 final diluted product 202 is about 12.8%±1.0%.

TABLE 87
Final Diluted Product according to Example 43

| | Weight Percent of |
|---|---|
| | Each Ingredient in |
| | Final Diluted |
| Ingredient | Product |
| MAP | 6.500% |
| DAP | 3.250% |
| DSP | 3.000% |
| Thickening Agent - Polysaccharide Gum 1 | 0.006% |
| Thickening Agent - Polysaccharide Gum 2 | 0.25% |
| Fluorescent Pigment | 0.25% |
| Corrosion Inhibitor (approximately 40% water) | 0.09% |
| Corrosion Inhibitor | 0.02% |
| Inorganic Pigment | 0.020% |
| Surfactant | 0.025% |
| Propylene Glycol | 9.050% |
| Water | 77.539% |
| Total Weight of Final Diluted Product | 100% |

The density of the final diluted product 202 of Example 43 may be in the range of about 0.8 g/mL to about 1.5 g/mL, for example about 0.9 g/mL to about 1.4 g/mL. The pH of the final diluted product 202 of Example 43 may be in the range of about 6.0 to about 7.0, for example about 6.3. The N/P molar ratio of the final diluted product 202 of Example 43 may be in the range of about 0.6 to about 2.0, for example about 1.0. The viscosity of the final diluted product 202 of Example 43 may be in the range of about 150 cP to about 300 cP, for example about 205 cP.

### Example 44

In Example 44, a liquid concentrate dispersion was prepared containing the amounts of ingredients listed in Table 88 below. The values in Table 88 can be varied by ±0.01% or ±0.05%, or ±0.1% or ±0.5%,or ±1.0%,or ±1.5%,or ±2%,or ±2.5%, or ±3.0%, or ±3.5%, or ±4.0%, or ±4.5%, or ±5.0%. The viscosity of the liquid concentrate dispersion 201 of Example 44 may be in the range of about 3,000 cP to about 6,000 cP, for example about 5,000 cP.

TABLE 88
Liquid Concentrate Dispersion according to Example 44

| | Weight Percent of Each |
|---|---|
| | Ingredient in Liquid |
| Ingredient | Concentrate Dispersion |
| MAP | 31.768% |
| DAP | 15.884% |
| DSP | 4.887% |
| Thickening Agent - Polysaccharide Gum 1 | 0.029% |
| Thickening Agent - Polysaccharide Gum 2 | 1.222% |
| Fluorescent Pigment | 1.222% |
| Corrosion Inhibitor (approximately 40% water) | 0.440% |
| Corrosion Inhibitor | 0.098% |
| Inorganic Pigment | 0.098% |
| Surfactant | 0.122% |
| Propylene Glycol | 44.230% |
| Water | 0.000% |
| Total Weight of Liquid Concentrate Dispersion | 100% |

In Example 44, the final diluted product 202 was prepared by mixing approximately 5.4 gallons of water with 1 gallon of the liquid concentrate dispersion. The amounts of the ingredients in the Example 44 final diluted product 202 are listed in Table 89 below. The values in Table 89 can be varied by ±0.01%, or ±0.05%, or ±0.1%, or ±0.5%, or ±1.0%, or ±1.5%, or ±2%, or ±2.5%, or ±3.0%, or ±3.5%, or ±4.0%, or ±4.5%, or ±5.0%. The concentration of salt in the Example 44 final diluted product 202 is about 5% to 20% by weight in water, preferably about 6% to 18%, more preferably about 7% to 16%. For example, the weight percent of salt in the Example 44 final diluted product 202 is about 10.8%±1.0%.

TABLE 89
Final Diluted Product according to Example 44

| | Weight Percent of |
|---|---|
| | Each Ingredient in |
| | Final Diluted |
| Ingredient | Product |
| MAP | 6.500% |
| DAP | 3.250% |
| DSP | 1.000% |
| Thickening Agent - Polysaccharide Gum 1 | 0.006% |
| Thickening Agent - Polysaccharide Gum 2 | 0.25% |
| Fluorescent Pigment | 0.25% |
| Corrosion Inhibitor (approximately 40% water) | 0.09% |
| Corrosion Inhibitor | 0.02% |
| Inorganic Pigment | 0.020% |
| Surfactant | 0.025% |
| Propylene Glycol | 9.050% |
| Water | 79.539% |
| Total Weight of Final Diluted Product | 100% |

The density of the final diluted product 202 of Example 44 may be in the range of about 0.8 g/mL to about 1.5 g/mL, for example about 0.9 g/mL to about 1.4 g/mL. The pH of the final diluted product 202 of Example 44 may be in the range of about 5.5 to about 6.5, for example about 6.1. The N/P molar ratio of the final diluted product 202 of Example 44 may be in the range of about 0.6 to about 2.0, for example about 1.2. The viscosity of the final diluted product 202 of Example 44 may be in the range of about 150 cP to about 300 cP, for example about 199 cP.

### Example 45

In Example 45, a liquid concentrate dispersion was prepared containing the amounts of ingredients listed in Table 90 below. The values in Table 90 can be varied by ±0.01% or ±0.05%, or ±0.1% or ±0.5%,or ±1.0%,or ±1.5%,or ±2%,or ±2.5%, or ±3.0%, or ±3.5%, or ±4.0%, or ±4.5%, or ±5.0%. The viscosity of the liquid concentrate dispersion 201 of Example 45 may be in the range of about 2000 cP to about 6000 cP, for example about 4980 cP.

TABLE 90
Liquid Concentrate Dispersion according to Example 45

| | Weight Percent of Each |
|---|---|
| | Ingredient in Liquid |
| Ingredient | Concentrate Dispersion |
| MAP | 42.851% |
| DAP | 5.293% |
| DSP | 2.874% |
| Thickening Agent - Polysaccharide Gum 1 | 0.030% |
| Thickening Agent - Polysaccharide Gum 2 | 1.260% |
| Fluorescent Pigment | 1.260% |
| Corrosion Inhibitor (approximately 40% water) | 0.454% |
| Corrosion Inhibitor | 0.101% |
| Inorganic Pigment | 0.126% |
| Surfactant | 0.126% |
| Propylene Glycol | 45.624% |
| Water | 0.000% |
| Total Weight of Liquid Concentrate Dispersion | 100% |

In Example 45, the final diluted product 202 was prepared by mixing approximately 5.6 gallons of water with 1 gallon of the liquid concentrate dispersion. The amounts of the ingredients in the Example 45 final diluted product 202 are listed in Table 91 below. The values in Table 91 can be varied by ±0.01%, or ±0.05%, or ±0.1%, or ±0.5%, or ±1.0%, or ±1.5%, or ±2%, or ±2.5%, or ±3.0%, or ±3.5%, or ±4.0%, or ±4.5%, or ±5.0%. The concentration of salt in the Example 45 final diluted product 202 is about 5% to 20% by weight in water, preferably about 6% to 18%, more preferably about 7% to 16%. For example, the weight percent of salt in the Example 45 final diluted product 202 is about 10.1%±1.0%.

TABLE 91
Final Diluted Product according to Example 45

| | Weight Percent of |
|---|---|
| | Each Ingredient in |
| | Final Diluted |
| Ingredient | Product |
| MAP | 8.500% |
| DAP | 1.050% |
| DSP | 0.570% |
| Thickening Agent - Polysaccharide Gum 1 | 0.006% |
| Thickening Agent - Polysaccharide Gum 2 | 0.25% |
| Fluorescent Pigment | 0.25% |
| Corrosion Inhibitor (approximately 40% water) | 0.09% |
| Corrosion Inhibitor | 0.02% |
| Inorganic Pigment | 0.025% |
| Surfactant | 0.025% |
| Propylene Glycol | 9.050% |
| Water | 80.164% |
| Total Weight of Final Diluted Product | 100% |

The density of the final diluted product 202 of Example 45 may be in the range of about 0.8 g/mL to about 1.5 g/mL, for example about 0.9 g/mL to about 1.4 g/mL. The pH of the final diluted product 202 of Example 45 may be in the range of about 5.0 to about 6.0, for example about 5.4. The N/P molar ratio of the final diluted product 202 of Example 45 may be in the range of about 0.6 to about 2.0, for example about 1.0. The viscosity of the final diluted product 202 of Example 45 may be in the range of about 150 cP to about 300 cP, for example about 230 cP.

### Example 46

In Example 46, a liquid concentrate dispersion was prepared containing the amounts of ingredients listed in Table 92 below. The values in Table 92 can be varied by ±0.01% or ±0.05%, or ±0.1% or ±0.5%,or ±1.0%,or ±1.5%,or ±2%,or ±2.5%, or ±3.0%, or ±3.5%, or ±4.0%, or ±4.5%, or ±5.0%. The viscosity of the liquid concentrate dispersion 201 of Example 46 may be in the range of about 2000 cP to about 6000 cP, for example about 4160 cP.

TABLE 92
Liquid Concentrate Dispersion according to Example 46

| | Weight Percent of Each |
|---|---|
| | Ingredient in Liquid |
| Ingredient | Concentrate Dispersion |
| MAP | 23.593% |
| DAP | 26.618% |
| MSP | 0.202% |
| Thickening Agent - Polysaccharide Gum 1 | 0.076% |
| Thickening Agent - Polysaccharide Gum 2 | 1.260% |
| Fluorescent Pigment | 1.260% |
| Corrosion Inhibitor (approximately 40% water) | 0.454% |
| Corrosion Inhibitor | 0.101% |
| Inorganic Pigment | 0.126% |
| Surfactant | 0.126% |
| Propylene Glycol | 45.624% |
| Water | 0.000% |
| Total Weight of Liquid Concentrate Dispersion | 100% |

In Example 46, the final diluted product 202 was prepared by mixing approximately 5.6 gallons of water with 1 gallon of the liquid concentrate dispersion. The amounts of the ingredients in the Example 46 final diluted product 202 are listed in Table 93 below. The values in Table 93 can be varied by ±0.01%, or ±0.05%, or ±0.1%, or ±0.5%, or ±1.0%, or ±1.5%, or ±2%, or ±2.5%, or ±3.0%, or ±3.5%, or ±4.0%, or ±4.5%, or ±5.0%. The concentration of salt in the Example 46 final diluted product 202 is about 5% to 20% by weight in water, preferably about 6% to 18%, more preferably about 7% to 16%. For example, the weight percent of salt in the Example 46 final diluted product 202 is about 10.0%±1.0%.

TABLE 93
Final Diluted Product according to Example 46

| | Weight Percent of |
|---|---|
| | Each Ingredient in |
| | Final Diluted |
| Ingredient | Product |
| MAP | 4.680% |
| DAP | 5.280% |
| MSP | 0.040% |
| Thickening Agent - Polysaccharide Gum 1 | 0.015% |
| Thickening Agent - Polysaccharide Gum 2 | 0.25% |
| Fluorescent Pigment | 0.25% |
| Corrosion Inhibitor (approximately 40% water) | 0.09% |
| Corrosion Inhibitor | 0.02% |
| Inorganic Pigment | 0.025% |
| Surfactant | 0.025% |
| Propylene Glycol | 9.050% |
| Water | 80.275% |
| Total Weight of Final Diluted Product | 100% |

The density of the final diluted product 202 of Example 46 may be in the range of about 0.8 g/mL to about 1.5 g/mL, for example about 0.9 g/mL to about 1.4 g/mL. The pH of the final diluted product 202 of Example 46 may be in the range of about 6.0 to about 7.0, for example about 6.3. The N/P molar ratio of the final diluted product 202 of Example 46 may be in the range of about 1.0 to about 2.0, for example about 1.5. The viscosity of the final diluted product 202 of Example 46 may be in the range of about 150 cP to about 300 cP, for example about 205 cP.

### Example 47

In Example 47, a liquid concentrate dispersion was prepared containing the amounts of ingredients listed in Table 94 below. The values in Table 94 can be varied by ±0.01% or ±0.05%, or ±0.1% or ±0.5%,or ±1.0%,or ±1.5%,or ±2%,or ±2.5%, or ±3.0%, or ±3.5%, or ±4.0%, or ±4.5%, or ±5.0%. The viscosity of the liquid concentrate dispersion 201 of Example 47 may be in the range of about 500 to about 2,000 cP, for example about 1,100 cP.

TABLE 94
Liquid Concentrate Dispersion according to Example 47

| | Weight Percent of Each |
|---|---|
| | Ingredient in Liquid |
| Ingredient | Concentrate Dispersion |
| MAP | 43.886% |
| DAP | 5.421% |
| DSP | 2.944% |
| Thickening Agent - Polysaccharide Gum 1 | 0.029% |
| Thickening Agent - Polysaccharide Gum 2 | 1.229% |
| Fluorescent Pigment | 1.229% |
| Corrosion Inhibitor (approximately 40% water) | 0.442% |
| Corrosion Inhibitor | 0.098% |
| Inorganic Pigment | 0.123% |
| Surfactant | 0.123% |
| Propylene Glycol | 44.476% |
| Water | 0.000% |
| Total Weight of Liquid Concentrate Dispersion | 100% |

In Example 47, the final diluted product 202 was prepared by mixing approximately 5.4 gallons of water with 1 gallon of the liquid concentrate dispersion. The amounts of the ingredients in the Example 47 final diluted product 202 are listed in Table 95 below. The values in Table 95 can be varied by ±0.01%, or ±0.05%, or ±0.1%, or ±0.5%, or ±1.0%, or ±1.5%, or ±2%, or ±2.5%, or ±3.0%, or ±3.5%, or ±4.0%, or ±4.5%, or ±5.0%. The concentration of salt in the Example 47 final diluted product 202 is about 5% to 20% by weight in water, preferably about 6% to 18%, more preferably about 7% to 16%. For example, the weight percent of salt in the Example 47 final diluted product 202 is about 10.6%±1.0%.

TABLE 95
Final Diluted Product according to Example 47

| | Weight Percent of |
|---|---|
| | Each Ingredient in |
| | Final Diluted |
| Ingredient | Product |
| MAP | 8.930% |
| DAP | 1.103% |
| DSP | 0.599% |
| Thickening Agent - Polysaccharide Gum 1 | 0.006% |
| Thickening Agent - Polysaccharide Gum 2 | 0.25% |
| Fluorescent Pigment | 0.25% |
| Corrosion Inhibitor (approximately 40% water) | 0.09% |
| Corrosion Inhibitor | 0.02% |
| Inorganic Pigment | 0.025% |
| Surfactant | 0.025% |
| Propylene Glycol | 9.050% |
| Water | 79.652% |
| Total Weight of Final Diluted Product | 100% |

The density of the final diluted product 202 of Example 47 may be in the range of about 0.8 g/mL to about 1.5 g/mL, for example about 0.9 g/mL to about 1.4 g/mL. The pH of the final diluted product 202 of Example 47 may be in the range of about 5.0 to about 6.0, for example about 5.53. The N/P molar ratio of the final diluted product 202 of Example 47 may be in the range of about 0.6 to about 2.0, for example about 1.0. The viscosity of the final diluted product 202 of Example 47 may be in the range of about 150 to 250 cP, for example about 190 cP.

### Example 48

In Example 48, a liquid concentrate dispersion was prepared containing the amounts of ingredients listed in Table 96 below. The values in Table 96 can be varied by ±0.01% or ±0.05%, or ±0.1% or ±0.5%,or ±1.0%,or ±1.5%,or ±2%,or ±2.5%, or ±3.0%, or ±3.5%, or ±4.0%, or ±4.5%, or ±5.0%. The viscosity of the liquid concentrate dispersion 201 of Example 48 may be in the range of about 500 cP to about 2500 cP, for example about 2240 cP. The viscosity of the liquid concentrate dispersion 201 of Example 48 may be adjusted by using different MAP particle sizes as described above. For example, in one embodiment, with a mixture of MAP particle sizes the viscosity of the liquid concentrate dispersion 201 of Example 48 may be in the range of about 700 cP to about 800 cP, for example about 780 cP. In another embodiment, with a MAP particle size of about 0.4 mm (e.g. about 40 mesh) to about 0.25 mm (e.g., about 60 mesh) the viscosity of the liquid concentrate dispersion 201 of Example 48 may be in the range of about 800 cP to about 900 cP, for example about 870 cP. In another embodiment, with a MAP particle size of about 0.25 mm (e.g., about 60 mesh) to about 0.17 mm (e.g., about 80 mesh) the viscosity of the liquid concentrate dispersion 201 of Example 48 may be in the range of about 1400 cP to about 1500 cP, for example about 1430 cP. In yet another embodiment, with a MAP particle size of about 0.15 mm (e.g., about 100 mesh) or less the viscosity of the liquid concentrate dispersion 201 of Example 48 may be in the range of about 2200 cP to about 2300 cP, for example about 2240 cP.

TABLE 96
Liquid Concentrate Dispersion according to Example 48

| | Weight Percent of Each |
|---|---|
| | Ingredient in Liquid |
| Ingredient | Concentrate Dispersion |
| MAP | 43.644% |
| DAP | 5.391% |
| DSP | 2.928% |
| Thickening Agent - Polysaccharide Gum 1 | 0.010% |
| Thickening Agent - Polysaccharide Gum 2 | 1.222% |
| Fluorescent Pigment | 1.222% |
| Corrosion Inhibitor (approximately 40% water) | 0.440% |
| Corrosion Inhibitor | 0.098% |
| Inorganic Pigment | 0.122% |
| Surfactant | 0.122% |
| Propylene Glycol | 44.230% |
| Water | 0.000% |
| Total Weight of Liquid Concentrate Dispersion | 100% |

In Example 48, the final diluted product 202 was prepared by mixing approximately 5.4 gallons of water with 1 gallon of the liquid concentrate dispersion. The amounts of the ingredients in the Example 48 final diluted product 202 are listed in Table 97 below. The values in Table 97 can be varied by ±0.01%, or ±0.05%, or ±0.1%, or ±0.5%, or ±1.0%, or ±1.5%, or ±2%, or ±2.5%, or ±3.0%, or ±3.5%, or ±4.0%, or ±4.5%, or ±5.0%. The concentration of salt in the Example 48 final diluted product 202 is about 5% to 20% by weight in water, preferably about 6% to 18%, more preferably about 7% to 16%. For example, the weight percent of salt in the Example 48 final diluted product 202 is about 10.6%±1.0%.

TABLE 97
Final Diluted Product according to Example 48

| | Weight Percent of |
|---|---|
| | Each Ingredient in |
| | Final Diluted |
| Ingredient | Product |
| MAP | 8.930% |
| DAP | 1.103% |
| DSP | 0.599% |
| Thickening Agent - Polysaccharide Gum 1 | 0.002% |
| Thickening Agent - Polysaccharide Gum 2 | 0.25% |
| Fluorescent Pigment | 0.25% |
| Corrosion Inhibitor (approximately 40% water) | 0.09% |
| Corrosion Inhibitor | 0.02% |
| Inorganic Pigment | 0.025% |
| Surfactant | 0.025% |
| Propylene Glycol | 9.050% |
| Water | 79.656% |
| Total Weight of Final Diluted Product | 100% |

The density of the final diluted product 202 of Example 48 may be in the range of about 0.8 g/mL to about 1.5 g/mL, for example about 0.9 g/mL to about 1.4 g/mL. The pH of the final diluted product 202 of Example 48 may be in the range of about 5.0 to about 6.0, for example about 5.53. The N/P molar ratio of the final diluted product 202 of Example 48 may be in the range of about 0.6 to about 2.0, for example about 1.0. The viscosity of the final diluted product 202 of Example 48 may be in the range of about 150 cP to 250 cP, for example about 190 cP.

### Example 49

In Example 49, a liquid concentrate dispersion was prepared containing the amounts of ingredients listed in Table 98 below. The values in Table 98 can be varied by ±0.01% or ±0.05%, or ±0.1% or ±0.5%,or ±1.0%,or ±1.5%,or ±2%,or ±2.5%, or ±3.0%, or ±3.5%, or ±4.0%, or ±4.5%, or ±5.0%. The viscosity of the liquid concentrate dispersion 201 of Example 49 may be in the range of about 2000 cP to about 2400 cP, for example about 2160 cP.

TABLE 98
Liquid Concentrate Dispersion according to Example 49

| | Weight Percent of Each |
|---|---|
| | Ingredient in Liquid |
| Ingredient | Concentrate Dispersion |
| MAP | 43.644% |
| DAP | 5.391% |
| DSP | 2.928% |
| Thickening Agent - Polysaccharide Gum 1 | 0.005% |
| Thickening Agent - Polysaccharide Gum 2 | 1.222% |
| Fluorescent Pigment | 1.222% |
| Corrosion Inhibitor (approximately 40% water) | 0.440% |
| Corrosion Inhibitor | 0.098% |
| Inorganic Pigment | 0.122% |
| Surfactant | 0.122% |
| Propylene Glycol | 41.542% |
| Water | 0.000% |
| Total Weight of Liquid Concentrate Dispersion | 100% |

In Example 49, the final diluted product 202 was prepared by mixing approximately 5.6 gallons of water with 1 gallon of the liquid concentrate dispersion. The amounts of the ingredients in the Example 49 final diluted product 202 are listed in Table 99 below. The values in Table 99 can be varied by ±0.01%, or ±0.05%, or ±0.1%, or ±0.5%, or ±1.0%, or ±1.5%, or ±2%, or ±2.5%, or ±3.0%, or ±3.5%, or ±4.0%, or ±4.5%, or ±5.0%. The concentration of salt in the Example 49 final diluted product 202 is about 5% to 20% by weight in water, preferably about 6% to 18%, more preferably about 7% to 16%. For example, the weight percent of salt in the Example 49 final diluted product 202 is about 10.6%±1.0%.

TABLE 99
Final Diluted Product according to Example 49

| | Weight Percent of |
|---|---|
| | Each Ingredient in |
| | Final Diluted |
| Ingredient | Product |
| MAP | 8.930% |
| DAP | 1.103% |
| DSP | 0.599% |
| Thickening Agent - Polysaccharide Gum 1 | 0.001% |
| Thickening Agent - Polysaccharide Gum 2 | 0.25% |
| Fluorescent Pigment | 0.25% |
| Corrosion Inhibitor (approximately 40% water) | 0.09% |
| Corrosion Inhibitor | 0.02% |
| Inorganic Pigment | 0.025% |
| Surfactant | 0.025% |
| Propylene Glycol | 8.500% |
| Water | 80.207% |
| Total Weight of Final Diluted Product | 100% |

The density of the final diluted product 202 of Example 49 may be in the range of about 0.8 g/mL to about 1.5 g/mL, for example about 0.9 g/mL to about 1.4 g/mL. The pH of the final diluted product 202 of Example 49 may be in the range of about 5.0 to about 6.0, for example about 5.53. The N/P molar ratio of the final diluted product 202 of Example 49 may be in the range of about 0.6 to about 2.0, for example about 1.0. The viscosity of the final diluted product 202 of Example 49 may be in the range of about 150 cP to 250 cP, for example about 190 cP.

### Example 50

In Example 50, a liquid concentrate dispersion was prepared containing the amounts of ingredients listed in Table 100 below. The values in Table 100 can be varied by ±0.01% or ±0.05%, or ±0.1% or ±0.5%,or ±1.0%,or ±1.5%,or ±2%,or ±2.5%, or ±3.0%, or ±3.5%, or ±4.0%, or ±4.5%, or ±5.0%. The viscosity of the liquid concentrate dispersion 201 of Example 50 may be in the range of about 2000 cP to about 2400 cP, for example about 2240 cP.

TABLE 100
Liquid Concentrate Dispersion according to Example 50

| | Weight Percent of Each |
|---|---|
| | Ingredient in Liquid |
| Ingredient | Concentrate Dispersion |
| MAP | 43.644% |
| DAP | 5.391% |
| DSP | 2.928% |
| Thickening Agent - Polysaccharide Gum 1 | 0.010% |
| Thickening Agent - Polysaccharide Gum 2 | 1.222% |
| Fluorescent Pigment | 1.222% |
| Corrosion Inhibitor (approximately 40% water) | 0.440% |
| Corrosion Inhibitor | 0.098% |
| Inorganic Pigment | 0.122% |
| Surfactant | 0.122% |
| 1,3-Propanediol | 44.230% |
| Water | 0.000% |
| Total Weight of Liquid Concentrate Dispersion | 100% |

In Example 50, the final diluted product 202 was prepared by mixing approximately 5.4 gallons of water with 1 gallon of the liquid concentrate dispersion. The amounts of the ingredients in the Example 50 final diluted product 202 are listed in Table 101 below. The values in Table 101 can be varied by ±0.01%, or ±0.05%, or ±0.1%, or ±0.5%, or ±1.0%, or ±1.5%, or ±2%, or ±2.5%, or ±3.0%, or ±3.5%, or ±4.0%, or ±4.5%, or ±5.0%. The concentration of salt in the Example 50 final diluted product 202 is about 5% to 20% by weight in water, preferably about 6% to 18%, more preferably about 7% to 16%. For example, the weight percent of salt in the Example 50 final diluted product 202 is about 10.6%±1.0%.

TABLE 101
Final Diluted Product according to Example 50

| | Weight Percent of |
|---|---|
| | Each Ingredient in |
| | Final Diluted |
| Ingredient | Product |
| MAP | 8.930% |
| DAP | 1.103% |
| DSP | 0.599% |
| Thickening Agent - Polysaccharide Gum 1 | 0.002% |
| Thickening Agent - Polysaccharide Gum 2 | 0.25% |
| Fluorescent Pigment | 0.25% |
| Corrosion Inhibitor (approximately 40% water) | 0.09% |
| Corrosion Inhibitor | 0.02% |
| Inorganic Pigment | 0.025% |
| Surfactant | 0.025% |
| 1,3-Propanediol | 9.050% |
| Water | 79.656% |
| Total Weight of Final Diluted Product | 100% |

The density of the final diluted product 202 of Example 50 may be in the range of about 0.8 g/mL to about 1.5 g/mL, for example about 0.9 g/mL to about 1.4 g/mL. The pH of the final diluted product 202 of Example 50 may be in the range of about 5.0 to about 6.0, for example about 5.53. The N/P molar ratio of the final diluted product 202 of Example 50 may be in the range of about 0.6 to about 2.0, for example about 1.0. The viscosity of the final diluted product 202 of Example 50 may be in the range of about 150 cP to 250 cP, for example about 190 cP.

### Methods of Use

The forest fire retardant compositions of Examples 1-50 may be used to suppress, retard, or contain a forest fire.

### Direct Attack

In a direct attack, the final diluted composition 202 is applied on the flame front (e.g., to active flames to extinguish them). The final diluted composition 202 is a thickened water retardant which contains water to cool and suppress the fire.

### Indirect Attack

In an indirect attack, the final diluted composition 202 is applied in fire containment lines at a significant distance from the fire line. The indirect fire lines are built, and the fire is allowed to burn into them. The long-term fire retardant must be effective even after the water in the composition has evaporated. In an indirect attack, the final diluted composition 202 is applied to vegetation. As the water in the final diluted composition 202 evaporates, the salt concentration increases until it reaches its saturation level.

### Field Handling and Measurement

The forest fire retardant composition of Examples 1-50 can be delivered to the field either as the liquid concentrate dispersion 201, or as the final diluted composition 202. The final diluted compositions 202 of Examples 1-50 can be tested prior to application in the field to confirm proper salt content and/or proper N/P molar ratio. A refractometer can be used to test the salt content. Density can also be used to determine the salt content.

### Field Mixing Procedures and Ratios

Batch preparation of final diluted composition 202 may be accomplished by slowly feeding the liquid concentrate dispersion into a well-stirred mix tank containing a predetermined amount of water. Mix tank agitation may be provided via an overhead mechanical stirring apparatus or alternatively by a circulation pump sized to provide turbulent mixing. Stir until the concentrate is uniformly mixed into the water. Alternatively, the final diluted composition 202 may be mixed using continuous mixing equipment.

### Aerial Application

The final diluted composition 202 may be deposited via aerial application from an airplane or helicopter. The airplane may be a fixed-wing multi-engine aircraft, a fixed-wing single engine airtanker (SEAT), a large airtanker (LAT), a very large airtanker (VLAT), or an unmanned aircraft system (UAS). The helicopter may be a fixed-tank helicopter (HF) or it may be a helicopter bucket (HB). The final diluted composition 202 may be deposited in an indirect attack to build a retardant line before a forest fire or directly to a forest fire via aerial application.

### Ground Application

The final diluted composition 202 may be deposited via ground application from a truck or ground engine (G). The final diluted composition 202 may be deposited in an indirect attack to build a retardant line before a forest fire or it may be deposited directly to a forest fire via ground application.

### Clean Up Procedure

Dye coloration may be removed from surfaces by treatment with liquid or dry detergent. The final diluted composition 202 can be cleaned with soap or liquid detergent and water. The color of the dye can be neutralized by sodium hypochlorite or washed with liquid detergent.

The liquid concentrate dispersion 201 can be cleaned by flushing with water and capturing the rinse in a tank or disposal container via drains. The liquid concentrate dispersion 201 and the final diluted composition 202 can be cleaned with soap or liquid detergent and water. The color of the dye can be neutralized by a bleaching agent such as sodium hypochlorite or washed with liquid detergent.

### Corrosion Testing

In a preferred embodiment, the liquid concentrate dispersions 201 of Examples 1-50 would meet the corrosion specifications of Specification 5100-304d, Section 3.8.1 (Jan. 7, 2020, amended May 6, 2021) for aluminum, steel, brass, and magnesium. For example, in a preferred embodiment the aluminum corrosion of the liquid concentrate dispersion 201 is less than about 5.0 mils/year, preferably less than about 4.0 mils/year, more preferably less than about 3.0 mils/year, more preferably less than about 2.0 mils/year, more preferably less than about 1.0 mils/year, and more preferably less than 0.5 mils/year. In a preferred embodiment, the steel corrosion of the liquid concentrate dispersion 201 is less than about 5.0 mils/year, preferably less than about 4.0 mils/year, more preferably less than about 3.0 mils/year, more preferably less than about 2.0 mils/year, more preferably less than about 1.0 mils/year, and more preferably less than 0.5 mils/year. In a preferred embodiment, the brass corrosion of the liquid concentrate dispersion 201 is less than about 5.0 mils/year, preferably less than about 4.0 mils/year, more preferably less than about 3.0 mils/year, more preferably less than about 2.0 mils/year, more preferably less than about 1.0 mils/year, and more preferably less than 0.5 mils/year. In a preferred embodiment, the magnesium corrosion is less than about 5.0 mils/year, preferably less than about 4.0 mils/year, more preferably less than about 3.0 mils/year, more preferably less than about 2.0 mils/year, more preferably less than about 1.0 mils/year, and more preferably less than 0.5 mils/year. In a preferred embodiment, the liquid concentrate dispersions 201 of Examples 1-50 may exhibit lower corrosion rates compared to the PHOS-CHEK® traditional long-term retardant liquid concentrates based on salt solutions. A list of the PHOS-CHEK® USFS Qualified liquid concentrate long-term fire retardants is provided below in Table 102. The values in Table 102 are derived from the U.S. Forest Service Wildland Fire Uniform & Intergranular Corrosion Product Performance Data dated Mar. 12, 2024 accessed at https://www.fs.usda.gov/rm/fire/wfcs/qualified_products_long_term.php, incorporated herein by reference in its entirety.

TABLE 102
Concentrate Uniform & Intergranular Corrosion

| | 2024-T3 | | | |
|---|---|---|---|---|
| | Aluminum | 4130 Steel | Yellow Brass | |
| | Total | Total | Partial | Az31B |
| Long Term | immersion at | immersion at | immersion at | Magnesium |
| Retardant Liquid | 120° F. | 120° F. | 120° F. | Total immersion |
| Concentrate Test | (mils-per- | (mils-per- | (mils-per- | at 120° F. |
| Product | year) | year) | year) | (mils-per-year) |
| PHOS-CHEK ® LC- | 0.8 | 0.5 | 1.0 | 23 |
| 95A-R | | | | |
| PHOS-CHEK ® LC- | 0.6 | 0.5 | 0.5 | 24.2 |
| 95A-Fx | | | | |
| PHOS-CHEK ® LC- | 4.5 | 0.5 | 0.6 | 46.6 |
| 95A-F | | | | |
| PHOS-CHEK ® LC- | 0.6 | 0.5 | 0.6 | 53.5 |
| 95-W | | | | |
| PHOS-CHEK ® | 4.8 | 0.1 | 2.2 | 212 |
| LCE20-Fx | | | | |

In a preferred embodiment, the final diluted composition 202 of Examples 1-50 would meet the corrosion specifications of Specification 5100-304d, Section 3.8.1 (Jan. 7, 2020, amended May 6, 2021) for aluminum, steel, brass, and magnesium. For example, in a preferred embodiment the aluminum corrosion of the final diluted composition 202 is less than about 2.0 mils/year, preferably less than about 1.0 mils/year, more preferably less than about 0.5 mils/year, and more preferably less than about 0.2 mils/year. In a preferred embodiment, the steel corrosion of the final diluted composition 202 is less than about 5.0 mils/year, preferably less than about 4.0 mils/year, more preferably less than about 3.0 mils/year, more preferably less than about 2.0 mils/year, more preferably less than about 1.0 mils/year, and more preferably less than 0.5 mils/year. In a preferred embodiment, the brass corrosion of the final diluted composition 202 is less than about 5.0 mils/year, preferably less than about 4.0 mils/year, more preferably less than about 3.0 mils/year, more preferably less than about 2.0 mils/year, and more preferably less than about 1.0 mils/year, and more preferably less than 0.5 mils/year. In a preferred embodiment, the magnesium corrosion of the final diluted composition 202 is less than about 4.0 mils/year, preferably less than about 3.0 mils/year, more preferably less than about 2.0 mils/year, more preferably less than about 1.0 mils/year, and more preferably less than about 0.5 mils/year.

### Toxicity Testing

In a preferred embodiment, the final diluted composition 202 of Examples 1-50 would meet the fish toxicity specifications of Specification 5100-304d Section 4.1.2 (Jan. 7, 2020, amended May 6, 2021) following the procedures outlined in USDA Forest Service Standard Test Procedure STP-1.5 Fish Toxicity (available at https://www.fs.usda.gov/rm/fire/wfcs/documents/FishTox-Retardant_Rev-2021-10.pdf) and the U.S. Environmental Protection Agency, Office of Prevention, Pesticides, and Toxic Substances.

Fish Acute Toxicity Test, Freshwater and Marine; 850.1075, both incorporated herein by reference in their entirety. For example, in a preferred embodiment the LC₅₀ value for the final diluted composition 202 of Example(s) 1-50 is greater than about 500 mg/L, preferably greater than about 1,000 mg/L, preferably greater than about 1,500 mg/L, preferably greater than about 2,000 mg/L, preferably greater than about 2,500 mg/L, preferably greater than 3,000 mg/L, preferably greater than 3,500 mg/L, preferably greater than 4,000 mg/L, preferably greater than 4,500 mg/L, and more preferably greater than 5,000 mg/L.

### Combustion Retarding Effectiveness Testing

In a preferred embodiment, the final diluted composition 202 of Examples 1-50 would meet the required retarding salt concentration specifications of Specification 5100-304d Section 3.6.1 (Jan. 7, 2020, amended May 6, 2021) and would not require a burn test. For example, the diammonium phosphate (DAP) concentration in the final diluted composition 202 is equal to or greater than about 10.6%. For example, the diammonium phosphate (DAP) concentration in the final diluted composition 202 is about 10.6% to about 20%, preferably about 10.7% to about 19%, more preferably about 10.8% to about 18%, more preferably about 11% to about 17%. In a preferred embodiment, the monoammonium phosphate (MAP) concentration in the final diluted composition 202 is equal to or greater than about 9.2%. For example, the monoammonium phosphate (MAP) concentration in the final diluted composition 202 is about 9.2% to about 20%, preferably about 9.3% to about 19%, more preferably about 9.4% to about 18%, more preferably about 9.5% to about 17%. In a preferred embodiment, the diammonium phosphate (DAP) equivalent (i.e., combinations of DAP, MAP, additional ammonium phosphate salts, and/or non-ammonium phosphate salts disclosed herein that have ammonium and phosphate concentrations equal to or greater than DAP) concentration in the final diluted composition 202 is equal to or greater than about 10.6%. For example, the diammonium phosphate (DAP) equivalent concentration in the final diluted composition 202 is about 10.6% to about 20%, preferably about 10.7% to about 19%, more preferably about 10.8% to about 18%, more preferably about 11% to about 17%.

In another embodiment, the final diluted composition 202 of Examples 1-50 would meet the required retarding salt concentration specifications of Specification 5100-304d Section 3.6.2 (Jan. 7, 2020, amended May 6, 2021) in any burn tests. For example, the final diluted composition 202 exhibits a reduction index greater or equal to the reduction index of 10.6% diammonium phosphate (DAP).

### CONCLUSION

All parameters, dimensions, materials, and configurations described herein are meant to be exemplary and the actual parameters, dimensions, materials, and/or configurations will depend upon the specific application or applications for which the inventive teachings is/are used. It is to be understood that the foregoing embodiments are presented primarily by way of example and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein.

In addition, any combination of two or more such features, systems, articles, materials, kits, and/or methods, if such features, systems, articles, materials, kits, and/or methods are not mutually inconsistent, is included within the inventive scope of the present disclosure. Other substitutions, modifications, changes, and omissions may be made in the design, operating conditions and arrangement of respective elements of the exemplary implementations without departing from the scope of the present disclosure. The use of a numerical range does not preclude equivalents that fall outside the range that fulfill the same function, in the same way, to produce the same result.

Also, various inventive concepts may be embodied as one or more methods, of which at least one example has been provided. The acts performed as part of the method may in some instances be ordered in different ways. Accordingly, in some inventive implementations, respective acts of a given method may be performed in an order different than specifically illustrated, which may include performing some acts simultaneously (even if such acts are shown as sequential acts in illustrative embodiments).

All publications, patent applications, patents, and other references mentioned herein are incorporated by reference in their entirety.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/of” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

In the claims, as well as in the specification, any ingredient listed in an open-ended list of ingredients shall not be negated or avoided by the addition of water or other solvent or reactant that might cause a chemical change to such ingredient. Thus, for example, even though it is known that an anhydrous salt becomes hydrated in the presence of water, the inventors hereby act as their own lexicographers, so that any composition “including” or “comprising” an “anhydrous” salt is intended to cover both a dry composition substantially free of water in which the salt has substantially no water of hydration, as well as any wet composition formed by the addition of water which causes the anhydrous salt to become hydrated (or to undergo some other change). Both before and after the addition of water or other ingredient, the composition shall be regarded, for purposes of the specification and claims, as comprising an “anhydrous” salt irrespective of any hydration, solvation, or other change caused by the addition of water or other ingredient. The same applies for any ingredient recited in an open-ended list which might be chemically changed by the addition of water or other ingredient to the open-ended list.

1. A forest fire retardant liquid concentrate dispersion, comprising:
a retardant compound present in the liquid concentrate dispersion in a dispersed phase;
a corrosion inhibitor for at least one of iron, brass, aluminum, or magnesium;
a thickening agent; and
a non-aqueous dispersion medium.

2. The liquid concentrate dispersion of claim 1, wherein the corrosion inhibitor is present in the liquid concentrate dispersion in an amount having a weight percent of about 0.025% to about 4.5% relative to the total weight of the liquid concentrate dispersion.

3. The liquid concentrate dispersion of claim 1, wherein the thickening agent is present in the liquid concentrate dispersion in an amount having a weight percent of about 0.01% to about 5.5% relative to the total weight of the liquid concentrate dispersion.

4. The liquid concentrate dispersion of claim 1, wherein the dispersed phase is less than 25% by weight dissolved in the non-aqueous dispersion medium relative to the total weight of the liquid concentrate dispersion.

5. The liquid concentrate dispersion of claim 1, wherein the dispersed phase is less than 20% by weight dissolved in the non-aqueous dispersion medium relative to the total weight of the liquid concentrate dispersion.

6. The liquid concentrate dispersion of claim 1, wherein the dispersed phase is less than 10% by weight dissolved in the non-aqueous dispersion medium relative to the total weight of the liquid concentrate dispersion.

7. The liquid concentrate dispersion of claim 1, wherein the forest fire retardant liquid concentrate dispersion is in the form of a suspension and/or colloid.

8. The liquid concentrate dispersion of claim 1, wherein the non-aqueous dispersion medium comprises at least one of ethylene glycol, polyethylene glycol (PEG), a low-molecular-weight grade polyethylene glycol (PEG-400), di(propylene glycol) methyl ether (DPG-ME), tripropylene glycol methyl ether (TPG-ME), hexylene glycol, triethylene glycol (TEG), triethylene glycol methyl ether (TEG-ME), diethylene glycol monoethyl ether (DEG-EE), glycerol, propylene glycol (PG), polypropylene glycol, propylene carbonate, 1,3 propanediol, a polyol, or a glycol ether.

9. The liquid concentrate dispersion of claim 1, wherein the retardant compound comprises at least one of a potassium salt, a phosphate salt, a sulfate salt, a calcium salt, a magnesium salt, or a halide salt.

10. The liquid concentrate dispersion of claim 9, wherein the potassium salt comprises at least one of potassium formate (HCO₂K), potassium acetate (CH₃COOK), potassium acetate hydrate (CH₃COOK(H₂O)ₓ) where x is about 1 to about 3, potassium propanoate (C₃H₅KO₂), potassium butanoate (C₄H₇KO₂), potassium lactate (KC₃H₅O₃), potassium oxalate (C₂K₂O₄), potassium oxalate monohydrate (C₂K₂O₄(H₂O)₁), monopotassium malate (C₄H₅KO₅), potassium glutamate (C₅H₅KNO₄), potassium glutamate monohydrate (C₅H₅KNO₄(H₂O)₁), potassium L-glutamate monohydrate (KOOCCH₂CH₂CH(NH₂)COOH(H₂O)₁), monopotassium tartrate (C₄H₅KO₆), potassium urate (C₅H₃KN₄O₃), dipotassium malate (C₄H₄K₂O₅), dipotassium tartrate (C₄H₄K₂O₆), monopotassium citrate (KH₂C₆H₅O₇), potassium gluconate (C₆H₁₁KO₇), dipotassium citrate (C₆H₆K₂O₇), tripotassium citrate (K₃C₆H₅O₇), tripotassium citrate monohydrate (K₃C₆H₅O₇(H₂O)₁), potassium bicarbonate (KHCO₃), potassium carbonate (K₂CO₃), monopotassium phosphate (KH₂PO₄), potassium ammonium phosphate (K₂NH₄PO₄), dipotassium phosphate (K₂HPO₄), dipotassium phosphate hydrate (K₂HPO₄(H₂O)ₓ) where x is about 3 to about 6, tripotassium phosphate (K₃PO₄), tripotassium phosphate hydrate (K₃PO₄(H₂O)ₓ) where x is about 3 to about 9, tetrapotassium pyrophosphate (K₄P₂O₇), potassium bisulfate (KHSO₄), potassium ammonium sulfate (H₄KNO₄S), or potassium sulfate (K₂SO₄).

11. The liquid concentrate dispersion of claim 9, wherein the phosphate salt comprises at least one of diammonium phosphate (DAP), diammonium orthophosphate (DAP), monoammonium phosphate (MAP), monoammonium orthophosphate (MAP), ammonium polyphosphate (APP), monosodium phosphate (MSP), disodium phosphate (DSP), disodium phosphate hydrate (Na₂HPO₄(H₂O)ₓ) where x is about 1 to about 12, sodium ammonium phosphate (SAP), sodium ammonium phosphate hydrate (NaPO₄HNH₄(H₂O)ₓ) where x is about 1 to about 4, sodium ammonium phosphate tetrahydrate (NaPO₄HNH₄(H₂O)₄), sodium tripolyphosphate (STPP), trisodium phosphate (TSP), monocalcium phosphate (MCP), dicalcium phosphate (DCP), tricalcium phosphate (TCP), octacalcium phosphate (OCP), dicalcium diphosphate, calcium triphosphate, hydroxyapatite, apatite, tetracalcium phosphate (TTCP), monopotassium phosphate (KH₂PO₄), potassium ammonium phosphate (K₂NH₄PO₄), dipotassium phosphate (K₂HPO₄), dipotassium phosphate hydrate (K₂HPO₄(H₂O)ₓ where x is about 3 to about 6), tripotassium phosphate (K₃PO₄), tripotassium phosphate hydrate (K₃PO₄(H₂O)ₓ where x=3, 7, or 9), or tetrapotassium pyrophosphate (K₄P₂O₇).

12. The liquid concentrate dispersion of claim 9, wherein the sulfate salt comprises at least one of magnesium sulfate, magnesium sulfate hydrate (MgSO₄(H₂O)ₓ) where x is about 1 to about 11, magnesium sulfate monohydrate, kieserite (MgSO₄(H₂O)₁), hexahydrite (MgSO₄(H₂O)₆), epsomite (MgSO₄(H₂O)₇), potassium sulfate (K₂SO₄), dipotassium sulfate (K₂SO₄), leonite (K₂Mg(SO₄)₂(H₂O)₄), or picromerite (K₂Mg(SO₄)₂(H₂O)₆).

13. The liquid concentrate dispersion of claim 9, wherein the calcium salt comprises at least one of calcium carbonate (CaCO₃), calcium phosphate (Ca₃(PO₄)₂), huntite (Mg₃Ca(CO₃)₄), calcium oxide (CaO), calcium hydroxide (Ca(OH)₂), calcium phosphate hydrate (Ca₃(PO₄)₂(H₂O)₂), monocalcium phosphate (MCP), dicalcium phosphate (DCP), tricalcium phosphate (TCP), octacalcium phosphate (OCP), dicalcium diphosphate.

14. The liquid concentrate dispersion of claim 9, wherein the magnesium salt comprises at least one of magnesium chloride anhydrous (MgCl₂), magnesium chloride hydrate (MgCl₂(H₂O)ₓ) where x is about 1 to about 12, magnesium bromide, magnesium carbonate (MgCO₃), magnesium phosphate (Mg₃(PO₄)₂), magnesium carbonate hydroxide hydrate (Mg₅(CO₃)₄(OH)₂(H₂O)₄), magnesium phosphate hydrate (Mg₃(PO₄)₂(H₂O)s), magnesium oxide (MgO), magnesium hydroxide (Mg(OH)₂), or magnesium ammonium phosphate (Mg(PO₄HNH₄)₂).

15. The liquid concentrate dispersion of claim 9, wherein the halide salt comprises at least one of magnesium chloride anhydrous (MgCl₂), magnesium chloride hydrate (MgCl₂(H₂O)ₓ) where x is about 1 to about 12, magnesium bromide, calcium chloride anhydrous, calcium chloride hydrate (CaCl₂(H₂O)ₓ) where x is about 1 to about 6, or calcium bromide.

16. The liquid concentrate dispersion of claim 1, wherein the retardant compound has a particle size of about 1.0 mm to about 3.5 mm.

17. The liquid concentrate dispersion of claim 16, wherein the retardant compound has a particle size of about 0.25 mm to about 0.4 mm.

18. The liquid concentrate dispersion of claim 17, wherein the retardant compound has a particle size of about 0.17 mm to about 0.25 mm.

19. The liquid concentrate dispersion of claim 18, wherein the retardant compound has a particle size of about 0.15 mm or less.

20. The liquid concentrate dispersion of claim 1, wherein the corrosion inhibitor comprises at least one of:
an alkyl amine;
one or more azoles;
disodium molybdate dihydrate;
iron pyrophosphate;
sodium molybdate;
sodium lauryl sulfate; or
sodium stearate.

21. The liquid concentrate dispersion of claim 1, wherein the thickening agent comprises at least one of a polyurethane, a polyvinyl alcohol, a polyvinylpyrrolidone, an acrylic polymer, a gum, a cellulosic, a sulfonate, a saccharide, a clay, an organosilicone, or a protein.

22. The liquid concentrate dispersion of claim 21, wherein the thickening agent comprises the gum.

23. The liquid concentrate dispersion of claim 22, wherein the gum comprises a polysaccharide gum.

24. The liquid concentrate dispersion of claim 1, wherein the thickening agent comprises a first thickening agent and a second thickening agent.

25. The liquid concentrate dispersion of claim 24, wherein the first thickening agent is present in the liquid concentrate dispersion in the dispersed phase and the second thickening agent is dissolved in the dispersion medium.

26. The liquid concentrate dispersion of claim 24, wherein the first thickening agent and the second thickening agent are present in the liquid concentrate dispersion in the dispersed phase.

27. The liquid concentrate dispersion of claim 24, wherein the first thickening agent comprises a first polysaccharide gum.

28. The liquid concentrate dispersion of claim 24, wherein the second thickening agent comprises at least one of a second polysaccharide gum, a clay, or silica.

29. The liquid concentrate dispersion of claim 1, further comprising a colorant, present in the concentrate in an amount having a weight percent of about 0.04% to about 6.0% relative to the total weight of the liquid concentrate dispersion.

30. The liquid concentrate dispersion of claim 29, wherein the colorant comprises at least one of at least one a red dye, an orange dye, a purple dye, a pink dye, Iron Oxide, Iron Oxide Black, or a fluorescent pigment.

31. The liquid concentrate dispersion of claim 1, further comprising at least one of a spoilage inhibitor, an anti-caking agent, a flow conditioner, an anti-foaming agent, a foaming agent, a stability additive, a biocide, a second thickening agent, a surfactant, an adjuvant, a second corrosion inhibitor, an opacifier, a second colorant, or a liquid carrier.

32. A final diluted forest fire retardant, comprising:
a retardant compound present in a liquid concentrate dispersion in a dispersed phase;
a corrosion inhibitor for at least one of iron, brass, aluminum, or magnesium;
a thickening agent;
a non-aqueous dispersion medium; and
an amount of water, wherein the amount of the retardant compound is in a weight percent of about 4% to about 30% relative to the total weight of the final diluted forest fire retardant.

33. The final diluted product of claim 32, wherein:
the final diluted forest fire retardant is a long-term fire retardant;
the long-term fire retardant has a viscosity between 150 cP and 1500 cP; and
the long-term fire retardant does not exceed a corrosion rate of 2.0 mils-per-year for aluminum, 5.0 mils-per-year for iron, and 5.0 mils-per-year for brass.

34. The final diluted forest fire retardant of claim 33, wherein the long-term fire retardant does not exceed a corrosion rate of 4.0 mils-per-year for magnesium.

35. The final diluted forest fire retardant of claim 33, wherein the viscosity is between 150 cP and 400 cP.

36. The final diluted forest fire retardant of claim 33, wherein the viscosity is between 401 cP and 800 cP.

37. The final diluted forest fire retardant of claim 33, wherein the viscosity is between 801 cP and 1500 cP.
